(19) United States
(12) Patent Application Publication
(10) Pub. No.: US 2005/0188087 A1
(43) Pub. Date: Aug. 25, 2005

(54) Parallel processing system

(75) Inventor: Kazunari Iyoda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: DAI NIPPON PRINTING CO., LTD., Tokyo (JP)

(21) Appl. No.: 10/513,089

(22) PCT Filed: May 26, 2003
(86) PCT No.: PCT/JP03/06551

(30) Foreign Application Priority Data
May 28, 2002 (JP) 2002-153475
Jul. 30, 2002 (JP) 2002-221272
Jul. 30, 2002 (JP) 2002-221297
Jul. 30, 2002 (JP) 2002-221317
Jul. 30, 2002 (JP) 2002-221337
Jul. 30, 2002 (JP) 2002-221476
Jul. 30, 2002 (JP) 2002-222125
Jul. 30, 2002 (JP) 2002-221506

(51) Int. Cl. G06F 15/173

(52) U.S. Cl. 709/226; 709/208

(57) ABSTRACT

Upon accepting a request for processing from a terminal unit 5 of a requester 4, a master 2 solicits, by means of broadcast communication, the entire slave group 6 to participate in parallel processing. Each slave 7 determines, on the basis of its operating state, whether sufficient resources remain to participate in the parallel processing. When the slave 7 participates in the parallel processing, the slave 7 responds to the master 2 so as to apply for participation. The master 2 allocates processes to the slaves 7 having applied for participation, and transmits the allocated processes to the slaves 7. The slaves 7 execute the processes received from the master 2. Upon completion of execution of the processes, the servers 7 transmit the execution results to the master 2 or the terminal unit 5 of the requester 4.

### TECHNICAL FIELD

The present invention relates to a parallel processing system, etc. which process a single process while distributing the process to a plurality of processing terminal units. More particularly, the present invention relates to a parallel processing system, etc. which solicit processing terminal units to participate in parallel processing.

### BACKGROUND ART

Conventionally, a general parallel processing system includes a plurality of processing terminal units dedicated for parallel processing, and causes the processing terminal units to perform parallel processing. Further, there exist several processing systems (e.g., a biological computer) of a volunteer terminal unit participation type which utilizes otherwise unused time of terminal units such as a personal computer used for general OA (office automation).

However, such a system employs a mechanism such that each processing terminal unit fetches to-be-processed data from a calculation resource which is basically huge, and returns a processing result. The processing is performed without regard to the status, processing capacity, etc. of each processing terminal unit, and the system cannot determine when the result of an instructed process will be returned from each processing terminal unit. Therefore, the system has a problem in that it cannot perform a process on which a deadline is imposed. Moreover, such a system can execute only a predetermined process and cannot easily execute parallel processing whose execution is requested from the outside.

Moreover, conventionally, there have existed only parallel processing systems for CPUs having the same processing scheme and computing scheme, and there has not existed parallel processing means for apparatuses including computation units having mutually different processing schemes and computing schemes, such as control equipment, cellular phones, and digital consumer electronics.

Furthermore, although the system having processing terminal units dedicated for parallel processing can effect data exchange within the same system, the processing-terminal-unit-participation-type parallel processing system has problems in that each processing terminal unit encounters difficulty in referring to the results of computation of other processing terminal units and in that the system encounters difficulty in coping with an inquiry from the outside in relation to the processing status of each processing terminal unit.

The present invention has been accomplished in view of the above-described problems, and an object of the invention is to provide a parallel processing system, etc. which can cause each processing terminal unit to execute a process regarding parallel processing, in accordance with the operating status, processing capacity, etc., of the processing terminal unit; which can refer to the results of computation and processing status, etc., of each processing terminal unit; and which can improve the efficiency and speed of parallel processing.

### DISCLOSURE OF THE INVENTION

In order to achieve the above-described object, the first invention is a parallel processing system which comprises a plurality of processing terminal units, a plurality of requester-side terminal units, and at least one server, all of which are connected together via a network and in which a process requested by a requester-side terminal unit is performed through parallel processing. The server comprises: process accepting means for receiving the requested process from the requester-side terminal unit; participation soliciting means for soliciting the processing terminal units to participate in the parallel processing; process allocation means for generating to-be-allocated processes from the requested process, optionally through dividing the requested process, and for allocating and transmitting the to-be-allocated processes to processing terminal units having applied for participation in response to the solicitation; and requested-process-execution-result transmission means for aggregating results of execution of the allocated processes transmitted from the processing terminal units to obtain an execution result of the requested process and for transmitting the execution result of the requested process to the requester-side terminal unit. Each processing terminal unit comprises: participation application means, operable when the solicitation for participation in the parallel processing is transmitted from the sever, for responding to apply for the participation when, on the basis of its own operating state, the processing terminal unit is judged able to participate in the parallel processing; allocated-process executing means for executing the corresponding allocated process transmitted from the server; and allocated-process-execution-result transmission means for transmitting a result of execution of the allocated process to the server.

The second invention is a parallel processing system which comprises a plurality of processing terminal units and at least one server, all of which are connected together via a network and in which a requested process input to the server is performed through parallel processing. The server comprises: participation soliciting means for soliciting the processing terminal units to participate in the parallel processing; process allocation means for generating to-be-allocated processes from the requested process, optionally through dividing the requested process, and for allocating and transmitting the to-be-allocated processes to processing terminal units having applied for participation in response to the solicitation; and requested-process-execution-result aggregation means for aggregating results of execution of the allocated processes transmitted from the processing terminal units to obtain an execution result of the requested process. Each processing terminal unit comprises: participation application means, operable when the solicitation for participation in the parallel processing is transmitted from the sever, for responding to apply for the participation when, on the basis of its own operating state, the processing terminal unit is judged able to participate in the parallel processing; allocated-process executing means for executing the corresponding allocated process transmitted from the server; and allocated-process-execution-result transmission means for transmitting a result of execution of the allocated process to the server.

Preferably, the participation soliciting means or the participation application means performs the solicitation for participation or the application for participation by means of broadcast communication.

Preferably, the server includes a plurality of sub-servers which form a hierarchical structure, and the plurality of processing terminal units are connected to the sub-servers.

Preferably, the server or each processing terminal unit includes instruction conversion means for converting instruction codes of the allocated process to instruction codes executable on the processing terminal unit.

Preferably, each processing terminal unit includes an external memory for storing information and means necessary for the parallel processing.

In the first and second inventions, upon receipt of a requested process transmitted from a requester-side terminal unit (the first invention) or directly input to the server (the second embodiment), the server solicits the plurality of processing terminal units to participate in the parallel processing for the requested process. When the solicitation for the parallel processing is transmitted from the server to the processing terminal units, each processing terminal unit replies to the solicitation so as to apply for the participation when, on the basis of its own operating state, the processing terminal unit is judged able to participate in the parallel processing. The server generates to-be-allocated processes from the requested process by dividing the requested process when necessary, and allocates and transmits the to-be-allocated processes to processing terminal units having applied for participation. Each of the processing terminal units having applied executes the allocated process, and transmits a result of execution of the process to the server or the requester-side terminal unit. The server aggregates results of execution of the allocated processes to obtain an execution result of the requested process, and transmits the execution result to the requester-side terminal unit.

Although in the first embodiment the requested process is transmitted from the requester-side terminal unit to the server via the network (“process accepting means”), in the second embodiment the requested process is input directly to the server.

The “process accepting means” is a WEB (Word Wide Web) server function, for example. In this case, information regarding the requested process is entered in a WEB page from the terminal apparatus, and is sent to the server via the network.

The “server” is a server computer or the like, and functions as a “master,” which controls a slave; i.e., the processing terminal unit. The server generates “to-be-allocated processes” from a process (“requested process”) which is requested from a requester-side terminal unit to the server or is input directly to the server, allocates them to the processing terminal units, and causes the processing terminal units to execute the processes. Notably, when the server generates the to-be-allocated processes, the server divides the requested process when necessary.

The “processing terminal unit” is a terminal unit, such as a computer dedicated for parallel processing, or a volunteer terminal unit which participates in parallel processing when it has available resources during, for example, unused periods. Examples of the volunteer terminal unit are personal computers used for general office automation or other purposes. The processing terminal unit has a function for monitoring the operating state, state of use, or the like, of itself, and participates in parallel processing depending on the operating state, etc. thereof. The processing terminal unit serves as a “slave,” which is controlled by a master; i.e., the server. The processing terminal unit performs a process or the like allocated thereto by means of the server.

The processing terminal unit may be an information apparatus such as a computer, a portable information terminal (Personal Digital Assistant), a cellular phone, a digital consumer electronic device, or the like. Any device which includes a computation unit such as a CPU and which can be connected to a network can be used. An external memory such as a memory key, which will be described later, may be provided in the processing terminal unit.

The “requester-side terminal unit” is an information apparatus such as a computer, a portable information terminal (Personal Digital Assistant), a cellular phone, or the like, and transmits a requested process to the server via the network.

The “network” is a network such as the Internet or LAN (local area network), which may be of wired or wireless.

The “process” (“requested process” or “allocated process”) include a process request, processing program, processing data, and the like.

The “information and means necessary for parallel processing” are a processing program in relation to the requested process or allocated process, processing data, participation apply means, allocated process execution means, communication setting means for performing communication setting, instruction conversion means for converting instruction codes to those executable on the processing terminal unit, and other means.

In the first and second inventions, the server solicits each processing terminal unit to participate in parallel processing, and the processing terminal unit participates in parallel processing depending on its operating state. Accordingly, the server does not need to manage the operating state of each processing terminal unit, and can realize efficient, high-speed parallel processing by allocating to-be-allocated process to processing terminal units having applied for participation.

Since distribution or multiplying of the server is easy, failure resistance is improved.

The second invention facilitates execution of a plurality of parallel processings in relation to requested processes from the outside (the terminal unit of a requester) rather than from a predetermined system dedicated for processing.

The server can solicit, by means of broadcast communication, the entirety of the plurality of processing terminal units to participate in parallel processing. When the server is formed by a plurality of distributed servers, each of the processing terminal units can send, by means of broadcast communication, a response to the entirety of the plurality of distributed servers so as to participate in parallel processing. In this case, the states of individual processing terminal units are not required to be managed, and each of the server (distributed server) and the processing terminal units can send an instruction, response, or the like, without being conscious of its counterpart.

The server may be formed by a plurality of sub-servers which constitute a hierarchical structure. The processing terminal units are connected to sub-servers at the lowest level. Since processes (response, etc.) in relation to communications with the processing terminal units do not concentrate on a single server, the speed of parallel processing can be increased, and communication load can be reduced, whereby operation stability can be improved.

An instruction conversion function for converting instruction codes to those executable on the processing terminal units may be provided in the processing terminal units, the server, external memory, or the like. This configuration enables parallel processing to be performed in a state in which not only ordinary personal computers, but also equipment, such as digital consumer electronics devices, each including a computing device (CPU or the like) having a different processing system and computing system, and cellular phones, are used as processing terminal units, whereby further speedup of parallel processing becomes possible.

The requested process and the allocated process include a process request, processing program, processing data, etc. The processing program, the processing data, the participation application function, the instruction conversion function, etc. may be stored in an external memory, such as a USB (Universal Serial Bus) memory key or the like, provided in the processing terminal units.

The third invention is a server which is connected to a plurality of processing terminal units and a plurality of requester-side terminal units via a network and which performs a process requested by a requester-side terminal unit through parallel processing. Thee server comprises: process accepting means for receiving the requested process from the requester-side terminal unit; participation soliciting means for soliciting the processing terminal units to participate in the parallel processing; process allocation means for generating to-be-allocated processes from the requested process, optionally through dividing the requested process, and for allocating and transmitting the to-be-allocated processes to processing terminal units having applied for participation in response to the solicitation; and requested-process-execution-result transmission means for aggregating results of execution of the allocated processes transmitted from the processing terminal units to obtain an execution result of the requested process and for transmitting the execution result of the requested process to the requester-side terminal unit.

The fourth invention is a server which is connected to a plurality of processing terminal units via a network and which performs an input, requested process parallel processing. The server comprises: participation soliciting means for soliciting the processing terminal units to participate in the parallel processing; process allocation means for generating to-be-allocated processes from the requested process, optionally through dividing the requested process, and for allocating and transmitting the to-be-allocated processes to processing terminal units having applied for participation in response to the solicitation; and requested-process-execution-result aggregation means for aggregating results of execution of the allocated processes transmitted from the processing terminal units to obtain an execution result of the requested process.

The third and fourth inventions are directed to servers which are used in the parallel processing systems of the first and second inventions, respectively.

The fifth invention is a processing terminal unit which is connected to at least one server via a network and which is used in a parallel processing system for performing a requested process input to the server through parallel processing. The processing terminal unit comprises: participation application means, operable when the solicitation for participation in the parallel processing is transmitted from the sever, for responding to apply for the participation when, on the basis of its own operating state, the processing terminal unit is judged able to participate in the parallel processing; allocated-process executing means for executing the corresponding allocated process transmitted from the server; and allocated-process-execution-result transmission means for transmitting a result of execution of the allocated process to the server.

The fifth invention is directed to a processing terminal unit used in the parallel processing system of the first or second invention.

The sixth invention is a parallel processing method performed in a parallel processing system which comprises a plurality of processing terminal units, a plurality of requester-side terminal units, and at least one server, all of which are connected together via a network and in which a process requested by a requester-side terminal unit is performed through parallel processing. The server comprises: a process accepting step of receiving the requested process from the requester-side terminal unit; a participation soliciting step of soliciting the processing terminal units to participate in the parallel processing; a process allocation step of generating to-be-allocated processes from the requested process, optionally through dividing the requested process, and allocating and transmitting the to-be-allocated processes to processing terminal units having applied for participation in response to the solicitation; and a requested-process-execution-result transmission step of aggregating results of execution of the allocated processes transmitted from the processing terminal units to obtain an execution result of the requested process, and transmitting the execution result of the requested process to the requester-side terminal unit. Each processing terminal unit comprises: a participation application step of replying to the solicitation from the server in relation to participation in the parallel processing, so as to apply for the participation when, on the basis of its own operating state, the processing terminal unit is judged able to participate in the parallel processing; an allocated-process executing step of executing the corresponding allocated process transmitted from the server; and an allocated-process-execution-result transmission step of transmitting a result of execution of the allocated process to the server.

The seventh invention is a parallel processing method performed in a parallel processing system which comprises a plurality of processing terminal units and at least one server, all of which are connected together via a network and in which a requested process input to the server is performed through parallel processing. The server comprises: a participation soliciting step of soliciting the processing terminal units to participate in the parallel processing; a process allocation step of generating to-be-allocated processes from the requested process, optionally through dividing the requested process, and allocating and transmitting the to-be-allocated processes to processing terminal units having applied for participation in response to the solicitation; and a requested-process-execution-result aggregation step of aggregating results of execution of the allocated processes transmitted from the processing terminal units to obtain an execution result of the requested process. Each processing terminal unit comprises: a participation application step of replying to the solicitation from the server in relation to participation in the parallel processing, so as to apply for the participation when, on the basis of its own operating state, the processing terminal unit is judged able to participate in the parallel processing; an allocated-process executing step of executing the corresponding allocated process transmitted from the server; and an allocated-process-execution-result transmission step of transmitting a result of execution of the allocated process to the server.

The sixth and seventh inventions are directed to parallel processing methods performed by the servers and the processing terminal units of the parallel processing systems of the first and second inventions, respectively.

The eighth invention is a program which causes a computer to function as the server of the first or fourth invention.

The ninth invention is a recording medium on which is recorded a program which causes a computer to function as the server of the first or fourth invention.

The tenth invention is a program which causes a computer to function as the processing terminal unit of the fifth invention.

The eleventh invention is a recording medium on which is recorded a program which causes a computer to function as the processing terminal unit of the fifth invention.

The above-described programs may be stored on a recording medium such as a CD-ROM for distribution, or may be transmitted and received via a communication line.

The twelfth invention is a parallel processing system which comprises a plurality of processing terminal units and at least one server, all of which are connected together via a network and in which a requested process input to the server is performed through parallel processing. The server comprises: process allocation means for generating to-be-allocated processes from the requested process, optionally through dividing the requested process, for allocating and transmitting the to-be-allocated processes to the processing terminal units, and for causing the processing terminal units to execute the processes; and re-allocation means, operable when any one of the processing terminal units does not return a result of execution of the corresponding allocated process within a predetermined time limit, for allocating and transmitting the allocated process to a different processing terminal unit, and for causing the different processing terminal unit to execute the process. Each processing terminal unit comprises: allocated-process executing means for executing the corresponding allocated process transmitted from the server; and allocated-process-execution-result transmission means for transmitting a result of execution of the allocated process to the server.

Preferably, the server further comprises time limit setting means for setting the time limit according to the processing capacity of each processing terminal unit.

Preferably, the server further comprises holding means for holding a process history of each processing terminal unit, and processing capacity calculation means for calculating the processing capacity of each processing terminal unit on the basis of the corresponding process history.

Preferably, the server uses broadcast communication to solicit the processing terminal units to participate in parallel processing, to allocate and transmit the to-be-allocated processes to the processing terminal units having applied for participation in response to the solicitation, and to cause the processing terminal units to perform the allocated processes.

In the twelfth invention, when a requested process is input to the server directly or via the network, the server generates to-be-allocated processes from the requested process by dividing the requested process when necessary. Subsequently, the server allocates and transmits the to-be-allocated processes to the processing terminal units, and causes the processing terminal units to execute the processes. When any one of the processing terminal units does not return a result of execution of the corresponding allocated process within a predetermined time limit, the server allocates and transmits the allocated process to a different processing terminal unit, and causes the processing terminal unit to execute the process.

Each of the processing terminal units executes the allocated process, and transmits a result of execution of the process to the server. The server aggregates results of execution of the allocated processes to obtain an execution result of the requested process.

The “time limit” is a process limit time (timeout time) which the server sets when the server allocates a to-be-allocated process to each processing terminal unit and causes the processing terminal unit to execute the process.

The “process history” is a process record, process time, average process time, etc. of each processing terminal unit. The server holds the process history of each processing terminal unit in a database in the form of, for example, a process history table. The server can calculate the above-described time limit on the basis of the process history.

In the twelfth invention, when any one of the processing terminal units does not return a result of execution of the corresponding allocated process within a predetermined time limit, the server allocates and transmits the allocated process to a different processing terminal unit, and causes the processing terminal unit to execute the process. Therefore, even when one of the processing terminal units becomes unusable in the middle of a process or when one of the processing terminal units becomes unable to execute the process because of a failure or the like, parallel processing can be continued, whereby failure resistance is improved. Further, the state of processing, the states of individual processing terminal units, etc. are not required to be managed.

Moreover, the server sets the time limit for each processing terminal unit on the basis of the processing capacity (CPU capacity, etc.) of the processing terminal unit previously investigated and recorded, or the processing capacity (CPU capacity, etc.) of the processing terminal unit calculated from the process history. That is, since the server sets the process limit time (timeout time) for each processing terminal unit in accordance with the processing capacity thereof, wasteful waiting time can be shortened as compared with the case where a constant process limit time (timeout time) is set for all the processing terminal units, and thus the overall speed of the parallel processing can be increased.

The thirteenth invention is a parallel processing system which comprises a plurality of processing terminal units and at least one server, all of which are connected together via a network and in which a requested process input to the server is performed through parallel processing. The server comprises: process allocation means for generating to-be-allocated processes from the requested process, optionally through dividing the requested process, for allocating and transmitting the to-be-allocated processes to the processing terminal units, and for causing the processing terminal units to execute the processes; and grain-size control means for controlling a process grain size on the basis of the processing capacity of each processing terminal unit, the process grain size representing a quantity of process allocated to each processing terminal unit at a time. Each processing terminal unit comprises: allocated-process executing means for executing the corresponding allocated process transmitted from the server; and allocated-process-execution-result transmission means for transmitting a result of execution of the allocated process to the server.

Preferably, the server further comprises holding means for holding a process history of each processing terminal unit, and processing capacity calculation means for calculating the processing capacity of each processing terminal unit on the basis of the corresponding process history.

Preferably, the server further comprises first process control means for monitoring communication load of the network, and for forcedly increasing the process grain size when the communication load is higher than a predetermined level.

Preferably, the server further comprises second process control means for monitoring communication load of the network, and for temporarily stopping the allocation of processes to the processing terminal units when the communication load is higher than a predetermined level, until the communication load decreases to the predetermined level.

In the thirteenth invention, when a requested process is input to the server directly or via the network, the server generates to-be-allocated processes from the requested process by dividing the requested process when necessary. Subsequently, the server allocates and transmits the to-be-allocated processes to the processing terminal units, and causes the processing terminal units to execute the processes.

The server controls the process grain size on the basis of the processing capacity of each processing terminal unit, the process grain size representing a quantity of process allocated to each processing terminal unit at a time.

Each of the processing terminal units executes the allocated process, and transmits a result of execution of the process to the server. The server aggregates results of execution of the allocated processes to obtain an execution result of the requested process.

The “processing capacity” is a CPU capacity which the server sets when the server allocates a to-be-allocated process to each processing terminal unit and causes the processing terminal unit to execute the process.

The “process grain size” is a quantity of process allocated to each processing terminal unit at a time.

The “communication load” is a communication load ratio which is calculated on the basis of the communication load of the network measured by use of a measuring device.

Since the server controls the process grain size—which is a quantity of process allocated to each processing terminal unit at a time—on the basis of the processing capacity, even a single processing terminal unit concurrently executes in parallel a single or a plurality of allocated processes, whereby the overall speed of parallel processing can be increased.

Moreover, the server controls the process grain size—which is a quantity of process allocated to each processing terminal unit at a time—on the basis of the processing capacity (CPU capacity, etc.) of the processing terminal unit previously investigated and recorded, or the processing capacity (CPU capacity, etc.) of the processing terminal unit calculated from the process history. That is, since the server sets the process grain size for each processing terminal unit in accordance with the processing capacity thereof, the overall speed of the parallel processing can be increased, as compared with the case where a constant process grain size is set for all the processing terminal units.

The fourteenth invention is a parallel processing system which comprises a plurality of processing terminal units and at least one server, all of which are connected together via a network and in which a requested process input to the server is performed through parallel processing. The server comprises: process allocation means for generating to-be-allocated processes from the requested process, optionally through dividing the requested process, for allocating and transmitting the to-be-allocated processes to the processing terminal units on the basis of priority orders of the to-be-allocated processes in such a manner that a to-be-allocated process having a higher priority level is preferentially transmitted to a processing terminal unit having an earlier predicted end time regarding the to-be-allocated process, and for causing the processing terminal units to execute the processes. Each processing terminal unit comprises: allocated-process executing means for executing the corresponding allocated process transmitted from the server; and allocated-process-execution-result transmission means for transmitting a result of execution of the allocated process to the server.

Preferably, the server further comprises process time setting means for setting a process time of the to-be-allocated process on the basis of the processing capacity of each processing terminal unit, and predicted-end-time calculation means for calculating the predicted end time of the to-be-allocated process from the sum of the process time and the remaining process time of a process currently executed.

Preferably, the server further comprises holding means for holding a process history of each processing terminal unit, and processing capacity calculation means for calculating the processing capacity of each processing terminal unit on the basis of the corresponding process history.

Preferably, the server uses broadcast communication to solicit the processing terminal units to participate in parallel processing, to allocate and transmit the to-be-allocated processes to the processing terminal units having applied for participation in response to the solicitation, and to cause the processing terminal units to execute the allocated processes.

In the fourteenth invention, when a requested process is input to the server directly or via the network, the server generates to-be-allocated processes from the requested process by dividing the requested process when necessary. Subsequently, the server allocates and transmits the to-be-allocated processes to the processing terminal units on the basis of priority orders of the to-be-allocated processes in such a manner that a to-be-allocated process having a higher priority level is preferentially transmitted to a processing terminal unit having an earlier predicted end time regarding the to-be-allocated process. Subsequently, the server causes the processing terminal units to execute the processes.

Each of the processing terminal units executes the allocated process, and transmits a result of execution of the process to the server. The server aggregates results of execution of the allocated processes to obtain an execution result of the requested process.

The “priority order” is one of a plurality of levels of priority, and is set for each allocated process.

The “process time” is an average process time of a single allocated process.

The “predicted end time” is a predicted end time at which execution of an allocated process will end.

In the fourteenth invention, the server allocates and transmits the to-be-allocated processes to the processing terminal units on the basis of priority orders of the to-be-allocated processes in such a manner that a to-be-allocated process having a higher priority level is preferentially transmitted to a processing terminal unit having an earlier predicted end time regarding the to-be-allocated process. Thus, a to-be-allocated process having a higher priority level is preferentially scheduled, whereby the processing speed can be increased.

The fifteenth invention is a parallel processing system which comprises a plurality of processing terminal units and at least one server, all of which are connected together via a network and in which a requested process input to the server is performed through parallel processing. The server comprises: participation soliciting means for soliciting the processing terminal units to participate in the parallel processing; and process allocation means for generating to-be-allocated processes from the requested process, optionally through dividing the requested process, for allocating and transmitting the to-be-allocated processes to processing terminal units having applied for participation in response to the solicitation, and for causing the processing terminal units to execute the allocated processes. Each processing terminal unit comprises: determination means for monitoring its own load and for determining on the basis of the load whether the processing terminal unit can participate in the parallel processing; allocated-process execution means for executing the allocated process transmitted from the server and for transmitting a result of execution of the allocated process to the server; participation application means for replying the participation solicitation transmitted from the server in order to participate in the parallel processing when the processing terminal unit can participate the parallel processing.

Preferably, the load is a CPU load ratio, and the determination means determines that the processing terminal unit can participate in the parallel processing when the CPU load ratio is not greater than a predetermined level.

The participation solicitation means or the participation application means perform the solicitation for participation or the application for participation by means of broadcast communication.

In the fifteenth invention, when a requested process is input to the server directly or via the network, the server generate to-be-allocated processes by dividing the requested process when necessary. Subsequently, the server allocates and transmits the to-be-allocated processes to the processing terminal units, and causes the processing terminal units to execute the processes.

The processing terminal unit monitors the load thereof. When a solicitation in relation to participation in the parallel processing (process request) is transmitted from the server, the processing terminal unit determines the basis of the load whether the processing terminal unit can participate in the parallel processing. When the processing terminal unit can participate in the parallel processing, the processing terminal unit responds to apply for participation (to accept the request). The processing terminal unit executes the allocated process transmitted from the server, and transmits a result of execution of the allocated process to the server.

The “load” represents the operating state, sate of use, etc. of the processing terminal unit, and example of the load is a CPU load ratio. The processing terminal unit monitors its own CPU load ratio at all times or at predetermined timing, and determines that its can participate in parallel processing when the CPU load ratio is not higher than a predetermined level.

Notably, the predetermined level is a CPU load ratio under which the processing terminal unit can participate in parallel processing (participatable maximum CPU load ratio), or the like, which may be uniformly determined for all the processing terminal units or may be determined for each processing terminal unit in accordance with processing capacity thereof.

In the fifteenth invention, the severs solicits the processing terminal units to participate parallel processing when necessary, and each of the processing terminal units participates in the parallel processing in accordance with its own load, operating state, etc. Therefore, the server is not required to manage the load, operating state, etc. of each processing terminal unit, and can realize efficient, high-speed parallel processing by allocating to-be-allocated process to the processing terminal units having applied for participation. Accordingly, each of the processing terminal units can participate in the parallel processing in the middle of the processing.

Moreover, since each processing terminal unit participates in the parallel processing in accordance with its own load such as CPU load ratio, even a single processing terminal unit can concurrently execute in parallel a plurality of processes allocated by a single or a plurality of master (multi-task).

The sixteenth invention is a parallel processing system which comprises a plurality of processing terminal units and at least one server, all of which are connected together via a network and in which a requested process input to the server is performed through parallel processing. The server comprises: process allocation means for generating to-be-allocated processes from the requested process, optionally through dividing the requested process, for allocating and transmitting the to-be-allocated processes to processing terminal units having applied for participation in response to the solicitation, and for causing the processing terminal units to execute the allocated processes. Each processing terminal unit comprises: allocated-process execution means for executing the allocated process transmitted from the server; shared data transmission means for transmitting updated shared data to other processing terminal units by means of broadcast communication; shared data reception means for updating the shared data received from the other processing terminal units by means of broadcast communication; and allocated-process-execution-result transmission means for transmitting a result of execution of the allocated process to the server.

The “shared data” includes processing data or a result of calculation of a processing program of each allocated process.

In the sixteenth invention, when a processing terminal unit updates or creates the shared data, which includes processing data or a result of calculation of a processing program of the parallel processing, the processing terminal unit sends out the shared data to other slaves by means of broadcast communication. Further, the processing terminal unit updates or creates the shared data received from the other slaves. Thus, data sharing among the processing terminal units becomes possible. Further, by virtue of broadcast communication, data transmission can be performed through communication of a single time, whereby high-speed parallel processing can be realized.

The seventeenth invention is a parallel processing system which comprises a plurality of processing terminal units and at least one server, all of which are connected together via a network and in which a requested process input to the server is performed through parallel processing. The sever comprises: process allocation means for generating to-be-allocated processes from the requested process, optionally through dividing the requested process, for allocating and transmitting the to-be-allocated processes to processing terminal units having applied for participation in response to the solicitation, and for causing the processing terminal units to execute the allocated processes; holding means for holding a process table which stores information in relation to the requested process and the allocated process; and inquiry response means, operable when the server receives an inquiry from a processing terminal unit regarding the allocated processes in other processing terminal units, for replying the inquiry with reference to the process table. Each processing terminal unit comprises: allocated-process execution means for executing the allocated process transmitted from the server and for transmitting a result of execution of the allocated process to the server; and inquiry means for inquiring the server about the allocated processes in other processing terminal units.

Preferably, upon receipt of an inquiry regarding the allocated processes from one or a plurality of terminal units which transmit the requested process to the server via the network, the inquiry response means replies the inquiry with reference to the process table.

Preferably, the inquiry response means extracts from the process table information corresponding to the inquiry, and returns the information.

Preferably, the inquiry response means performs on the extracted information a calculation process corresponding to the inquiry, and returns a result of the calculation process.

Preferably, the information corresponding to the inquiry is the processing status or the result of execution of the requested process or the allocated process.

The communication process via the network is performed by use of broadcast communication.

Preferably, the sever comprises participation solicitation means for soliciting the processing terminal units to participate the parallel processing, and each of the processing terminal units comprises participation application means for replying the participation solicitation transmitted from the server in order to participate in the parallel processing when the processing terminal unit can participate the parallel.

In the seventeenth invention, when a requester-side terminal or a processing terminal unit requires an execution result of an allocated process, a calculation result, data, a processing status, etc. in a certain processing terminal unit, the requester-side terminal or the processing terminal unit inquires of the server about the execution result, calculation result, data, processing status, etc. The servers extracts corresponding information with reference to or by searching the process table, and returns the information, or returns a result of calculation process performed on the extracted information in accordance with the inquiry.

The “calculation process in accordance with the inquiry” is information processing which is performed on the information (execution result, processing status, etc.) extracted from the process table as information corresponding to the inquiry. Example of the calculation process includes processes for calculating a sum, average, maximum value, etc., a sorting process, and other processes.

In the seventeenth invention, since each processing terminal unit can obtain, via the sever, execution results, calculation results, data, etc. in other processing terminal units, each processing terminal unit can refer to execution results, etc. in other processing terminal units, even when these terminal units are not processing terminal units dedicated for parallel processing in the same system, but are processing terminal units which belong to different systems and which participate the parallel processing.

Since each requester-side terminal unit can obtain the processing status, etc. of the requested process via the server, each requester-side processing terminal unit can grasp the processing progress of the requested process, and can stop the process depending on the processing status.

As described above, each processing terminal unit or each requester-side terminal unit can obtain, via the sever, execution results, processing statuses of requested processes, etc. in other processing terminal units, the efficiency and speed of parallel processing can be increased.

Notably, since communications between the server and the processing terminal units and between the servers and the requester-side terminal units in relation to inquiry, inquiry response, etc. can be performed by use of broadcast communication, the inquiry response means (first and second inquiry response means) of the server can be provided outside the server or provided in distributed servers forming the server in a distributed manner.

### BRIEF DESCRIPTION OF DRAWINGS

FIG. 1 is a diagram schematically showing the configuration of a parallel processing system 100 according to a first embodiment.

FIG. 2 is a diagram schematically showing the processing for process acceptance, participation soliciting, participation application, process allocation, etc.

FIG. 3 is a diagram schematically showing the processing for process execution, execution-result acquisition, etc.

FIG. 4 is a flowchart showing the steps of the processing for process acceptance, participation soliciting, participation application, process allocation, etc.

FIG. 5 is a flowchart showing the steps of the processing for process execution, execution-result acquisition, etc.

FIG. 6 is an explanatory diagram regarding the functions of an external memory 8 of a slave 7.

FIG. 7 is a diagram schematically showing the configuration of a parallel processing system 200 according to a second embodiment.

FIG. 8 is a diagram schematically showing the configuration of a parallel processing system 300 according to a third embodiment.

FIG. 9 is a diagram showing the flow of processing in the parallel processing system 300 according to the third embodiment.

FIG. 10 is a diagram schematically showing communication processes by means of broadcast communication.

FIG. 11 is a diagram schematically showing the configuration of a parallel processing system 100 according to a fourth embodiment.

FIG. 12 is a diagram schematically showing the processing for process acceptance, participation soliciting, participation application, process allocation, process-history management, etc.

FIG. 13 is a diagram schematically showing the processing for process execution, execution-result acquisition, process-history management, etc.

FIG. 14 is a flowchart showing the steps of the processing for process acceptance, participation soliciting, participation application, process allocation, process-history management, etc.

FIG. 15 is a flowchart showing the steps of the processing for process execution, execution-result acquisition, process-history management, etc.

FIG. 16 is a diagram schematically showing the configuration of a parallel processing system 100 according to a fifth embodiment.

FIG. 17 is a diagram schematically showing the processing for process acceptance, participation soliciting, participation application, process allocation, process-history management, communication-load monitoring, etc.

FIG. 18 is a diagram schematically showing the processing for process execution, execution-result acquisition, process-history management, etc.

FIG. 19 is a flowchart showing the steps of the processing for process acceptance, participation soliciting, participation application, process allocation, process-history management, communication-load monitoring, etc.

FIG. 20 is a flowchart showing the steps of the processing for process execution, execution-result acquisition, process-history management, etc.

FIG. 21 is a diagram schematically showing the configuration of a parallel processing system 100 according to a sixth embodiment.

FIG. 22 is a diagram schematically showing the processing for process acceptance, participation soliciting, participation application, process allocation, process-history management, communication-load monitoring, etc.

FIG. 23 is a diagram schematically showing the processing for a process allocation function, a process-history management function, a priority schedule function, etc.

FIG. 24 is a diagram schematically showing the processing for process execution, execution-result acquisition, process-history management, etc.

FIG. 25 is a flowchart showing the steps of the processing for process acceptance, participation soliciting, participation application, process allocation, process-history management, communication-load monitoring, etc.

FIG. 26 is a flowchart showing the steps of the processing for the priority schedule function, etc.

FIG. 27 is a flowchart showing the steps of the processing for process execution, execution-result acquisition, process-history management, etc.

FIG. 28 is a diagram schematically showing the configuration of a parallel processing system 100 according to a seventh embodiment.

FIG. 29 is a diagram schematically showing the processing for process acceptance, participation soliciting, participation application, process allocation, load monitoring, etc.

FIG. 30 is a diagram schematically showing the processing for process execution, execution-result acquisition, etc.

FIG. 31 is a flowchart showing the steps of the processing for process acceptance, participation soliciting, participation application, process allocation, load monitoring, etc.

FIG. 32 is a flowchart showing the steps of the processing for process execution, execution-result acquisition, etc.

FIG. 33 is a diagram schematically showing the configuration of a parallel processing system 100 according to an eighth embodiment.

FIG. 34 is a diagram schematically showing the processing for process acceptance, participation soliciting, participation application, process allocation, etc.

FIG. 35 is a diagram schematically showing the processing for process execution, execution-result acquisition, etc.

FIG. 36 is a flowchart showing the steps of the processing for process acceptance, participation soliciting, participation application, process allocation, etc.

FIG. 37 is a flowchart showing the steps of the processing for process execution, execution-result acquisition, etc.

FIG. 38 is a diagram schematically showing the processing for a process execution function 12, a data sharing function 23, etc.

FIG. 39 is a flowchart showing the steps of the processing for the process execution function 12, the data sharing function 23, etc.

FIG. 40 is a diagram schematically showing the configuration of a parallel processing system 100 according to a ninth embodiment.

FIG. 41 is a diagram schematically showing the processing for process acceptance, participation soliciting, participation application, process allocation, etc.

FIG. 42 is a diagram schematically showing the processing for process execution, execution-result acquisition, etc.

FIG. 43 is a flowchart showing the steps of the processing for process acceptance, participation soliciting, participation application, process allocation, etc.

FIG. 44 is a flowchart showing the steps of the processing for process execution, execution-result acquisition, etc.

FIG. 45 is a diagram schematically showing the processing for an inquiry response function, an inquiry function, etc.

FIG. 46 is a flowchart showing the steps of the processing for the inquiry response function, the inquiry function, etc.

FIG. 47 is a flowchart showing the steps of the processing for the inquiry response function, the inquiry function, etc.

### BEST MODE FOR CARRYING OUT THE INVENTION

Preferred embodiments of the parallel processing system according to the present invention will next be described in detail with reference to the accompanying drawings. In the following description and the accompanying drawings, structural elements having substantially the same function and structure are denoted by identical reference numerals, to thereby omit repeated descriptions.

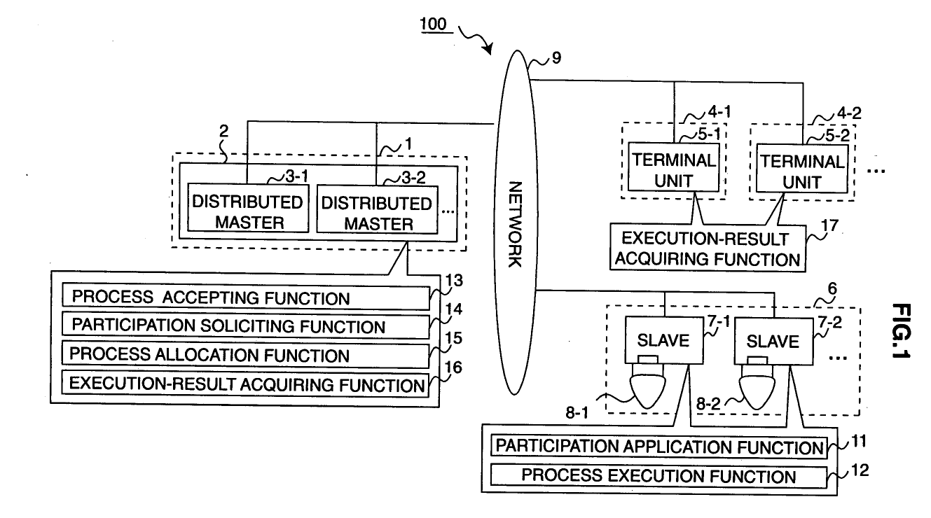

FIG. 1 is a diagram schematically showing the configuration of a parallel processing system 100 according to a first embodiment of the present invention.

As shown in FIG. 1, the parallel processing system 100 includes a master 2 of an administrator 1, terminal units 5-1, 5-2, etc., of a plurality of requesters 4-1, 4-2, etc., and a slave group 6, all of which are connected together via a network 9.

The network 9 may be the Internet, a local area network (LAN), or an enterprise LAN, which may be of a wired type or a wireless type.

The administrator 1 administrates the parallel processing system 100 by use of the master 2. The master 2 is a server computer or the like, which serves as a “server,” and has a process accepting function 13, a participation soliciting function 14, a process allocation function 15, an execution-result acquiring function 16, etc. The master 2 may consist of a plurality of distributed masters 3-1, 3-2, etc.

The process accepting function 13 accepts process requests from the terminal units 5-1, 5-2, etc. of the requesters 4-1, 4-2, etc. For example, the process accepting function 13 functions as a WEB (World Wide Web) server, and accepts, as a requested process, a process entered from a terminal unit 5 onto a WEB page. The process accepting function 13 can accept, as a requested process, not only a process which is sent from a terminal unit 5 via a WEB page or the like and the network 9, but also a process which is entered directly to the master 2.

The participation soliciting function 14 solicits slaves 7-1, 7-2, etc. of the slave group 6 to participate in the parallel processing. The process allocation function 15 generates to-be-allocated processes from a requested process, and allocates them to the slaves 7-1, 7-2, etc. The execution-result acquiring function 16 acquires the results of execution of the allocated processes from the slaves 7-1, 7-2, etc.

The requestors 4-1, 4-2, etc. request processes and have the corresponding terminal units 5-1, 5-2, etc. Each of the terminal units 5-1, 5-2, etc. has an execution-result acquiring function 17 for requesting, via the network 9, the master 2 to execute a process, and for receiving and acquiring the results of execution of the process from the slave group 6. Each of the terminal units 5-1, 5-2, etc. is a personal computer, a portable information terminal (Personal Digital Assistant), or the like.

The slave group 6 includes the slaves 7-1, 7-2, etc., which serve as a plurality of “processing terminal units.” Each of the slaves 7-1, 7-2, etc. is a terminal unit, such as a computer dedicated for parallel processing, or a volunteer terminal unit, such as a personal computer which participates in parallel processing when it has available resources during, for example, unused periods. Each of the slaves 7-1, 7-2, etc. is a personal computer, a portable information terminal (Personal Digital Assistant), a cellular phone, a piece of equipment including a computing unit, or the like.

The slaves 7-1, 7-2, etc. have external memories 8-1, 8-2, etc., such as USB (Universal Serial Bus) memory keys. Each of the slaves 7-1, 7-2, etc. (or the external memories 8-1, 8-2, etc.) includes a participation application function 11 and a process executing functions 12, among others.

Notably, each slave 7 may have an external memory 8 including the participation application function 11, the process executing functions 12, etc. Alternatively, the participation application function 11, the process executing function 12, etc., may be provided in each slave 7 without use of the external memory 8.

In response to a solicitation from the master 2 to participate in parallel processing, the participation application function 11 determines, on the basis of its operating state, whether sufficient resources remain to participate in the parallel processing. When the slave 7 participates in the parallel processing, the slave 7 responds to the master 2 so as to apply for the participation. Notably, the slave 7 may always monitor its operating state and state of use.

The process executing function 12 executes a predetermined process in accordance with a processing program received from the master 2.

The slave 7 may hold, as resident programs, programs regarding the participation application function 11, the process executing function 12, the operating state monitoring, the state-of-use monitoring, etc. Alternatively, the slave 7 may hold the programs regarding the participation application function 11, the process executing function 12, the operating state monitoring, etc., as a part of a screen saver, and may start these programs upon startup of the screen saver.

In this case, when the slave 7 is idol, the screen saver starts, and thus, the programs regarding the participation application function 11 and the process executing function 12 also start, whereby the slave 7 can apply for participation in parallel processing so as to participate in the parallel processing. Further, since the program regarding the operating state monitoring also starts upon startup of the screen saver, even when the slave 7 is executing a process for certain parallel processing, the slave 7 can apply for participation in another parallel processing so as to participate in the parallel processing, depending on its operating state. That is, the slave 7 can concurrently execute a plurality of processes in relation to parallel processing.

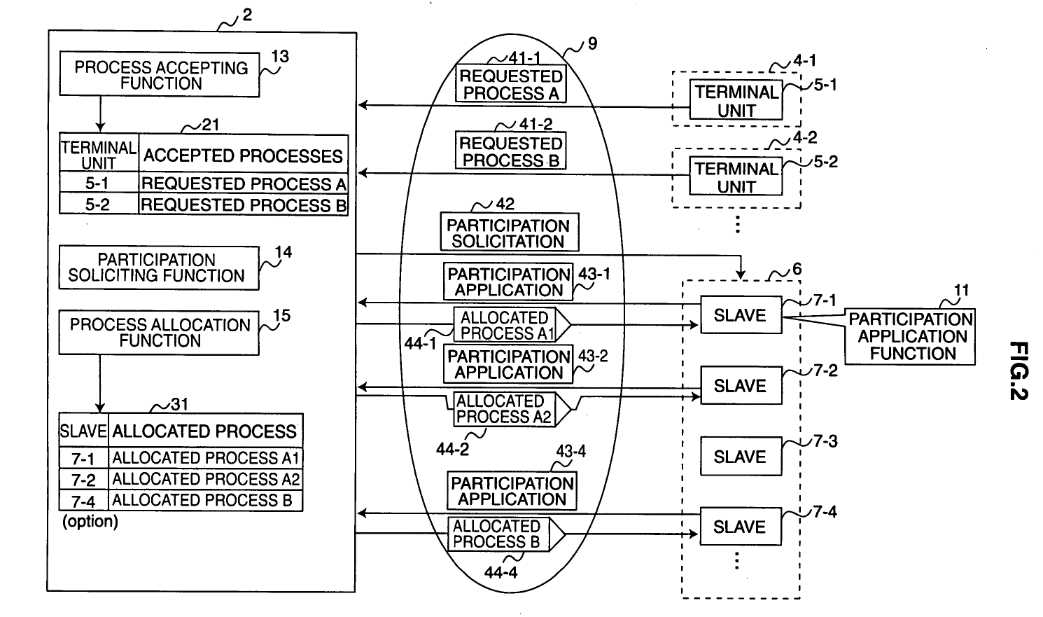

Next, the processing steps of the parallel processing system 100 will be described with reference to FIGS. 2 to 5.

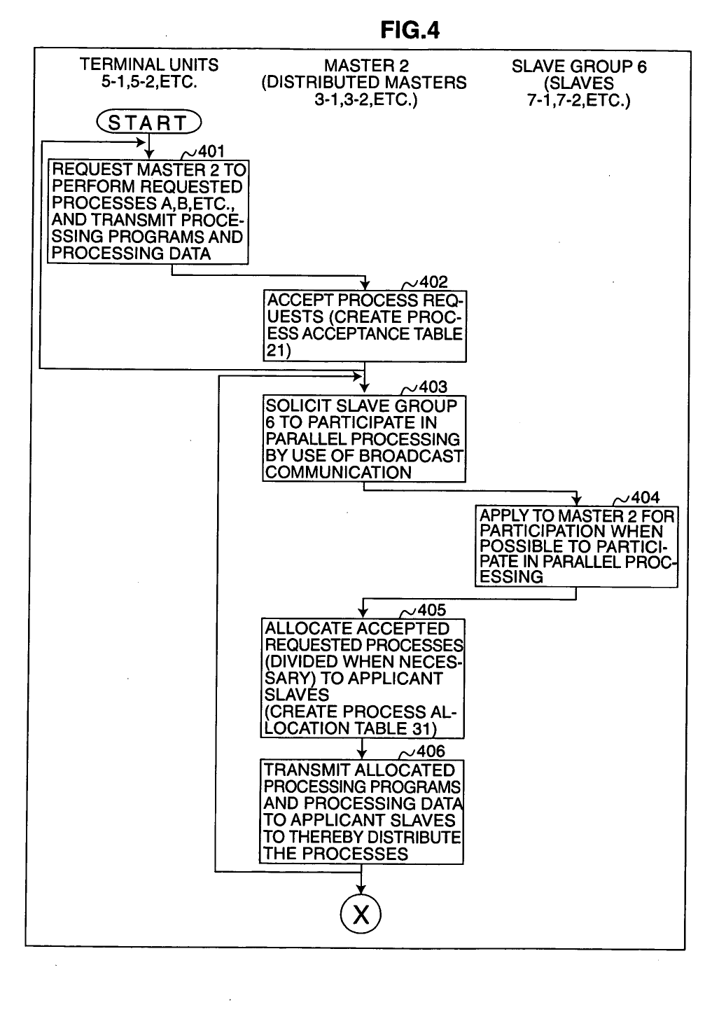

First, the processing executed by the process accepting function 13, the participation soliciting function 14, and the process allocation function 15 of the master 2, and that executed by the participation application function 11, etc. of the slaves 7-1, 7-2, etc. will be described with reference to FIGS. 2 and 4.

Notably, in order to distinguish processes, if necessary, a process requested by the terminal units 5-1, 5-2, etc. is called a “requested process,” and a process distributed or allocated to the slaves 7-1, 7-2, etc. is called an “allocated process.”

FIG. 2 is a diagram schematically showing the processing in relation to the process accepting function 13, the participation soliciting function 14, the process allocation function 15, the participation application function 11, etc.

FIG. 4 is a flowchart showing the steps of the processing in relation to the process accepting function 13, the participation soliciting function 14, the process allocation function 15, the participation application function 11, etc.

As shown in FIG. 2, the terminal units 5-1, 5-2, etc. of the requestors 4-1, 4-2, etc. request the master 2 to process requested processes A, B, etc., and transmit to the master 2 a processing program(s) and processing data for the requested processes A, B, etc. (step 401).

Notably, the slave 7 (or its external memory 8) may store a processing program and processing data in relation to the process executing function 12, along with the participation application function 11, etc. In this case, the terminal units 5-1, 5-2, etc. merely request the master 2 to execute requested processes A, B, etc. without transmitting the processing program and processing data. Alternatively, the slave 7 (or its external memory 8) may store portions of a processing program and processing data in relation to the process executing function 12, along with the participation application function 11. In this case, the terminal units 5-1, 5-2, etc. transmit the remaining portions of the processing program and processing data to the master 2 when the terminal units 5-1, 5-2, etc. request the master 2 to process requested processes A, B, etc.

The master 2 receives and accepts requested processes from the terminal unites 5-1, 5-2, etc. of the requesters 4-1, 4-2, etc. (step 402).

In the example shown in FIG. 2, the master 2 accepts a requested process A from the terminal unit 5-1 of the requester 4-1 (step 41-1) and a requested process B from the terminal unit 5-2 of the requestor 4-2 (step 41-2), and creates a process acceptance table 21. The process acceptance table 21 stores the correspondence between the terminal units and the requested processes.

The process accepting function 13 may have a function for serving as a WEB server. In this case, the master 2 can accept, as a requested process, a process entered on a WEB page from the terminal unit 5.

Notably, the system may be modified in such a manner that the processes in steps 401 and 402 are performed on an as-needed basis.

The master 2 solicits, by means of broadcast communications, all the slaves 7-1, 7-2, etc. of the slave group 6 to participate in parallel processing (step 403).

Each of the slaves 7-1, 7-2, etc. determines, on the basis of its operating state, whether sufficient resources remain to participate in the parallel processing. When the slave 7 can participate in the parallel processing, the slave 7 responds to the master 2 so as to apply for the participation (step 404).

In the example shown in FIG. 2, in response to an inquiry from the master 2 regarding participation (step 42), the slaves 7-1, 7-2, and 7-4 apply for participation (the slave 7-3 does not apply) (steps 43-1, 43-2, and 43-4).

The master 2 generates to-be-allocated processes from the requested process transmitted from the terminal units 5-1, 5-2, etc., and allocates the same to some of the slaves 7-1, 7-2, etc. which have responded to apply for participation (step 405). Notably, if necessary, the master 2 divides a requested process so as to generate to-be-allocated processes.

In the example shown in FIG. 2, the master 2 divides the requested process A into to-be-allocated processes A1 and A2, and handles the requested process B as a to-be-allocated process B. Subsequently, the master 2 allocates the to-be-allocated processes A1, A2, and B to the slaves 7-1, 7-2, and 7-4 having applied for participation (the slave 7-3 did not apply), and then creates a process allocation table 31. The process allocation table 31 stores allocated processes. Also it can stores running slaves, but it is not necessarily required.

The master 2 transmits processing programs and processing data in relation to the allocated processes to the corresponding slaves 7-1, 7-2, etc., to thereby distribute the requested processes (step 406).

In the example shown in FIG. 2, the master 2 transmits to the slave 7-1 a processing program, processing data, etc., in relation to the allocated process A1; transmits to the slave 7-2 a processing program, processing data, etc., in relation to the allocated process A2, and transmits to the slave 7-4 a processing program, processing data, etc., in relation to the allocated process B (steps 44-1, 44-2, and 44-4).

Notably, the system may be modified in such a manner that the processes in steps 403 to 406 are performed as needed in accordance with the state of acceptance of requested processes from the terminal units 5-1, 5-2, etc.

Notably, since broadcast communication enables transmission of information to all the nodes within the same data link (equipment, such as computers, connected to a network), the master 2 can solicit, by means of broadcast communication, the entire slave group 6 within the same data link to participate in parallel processing, whereas the slave 7 can respond, by means of broadcast communication, to the entire master 2 (distributed masters 3) within the same data link so as to apply for participation.

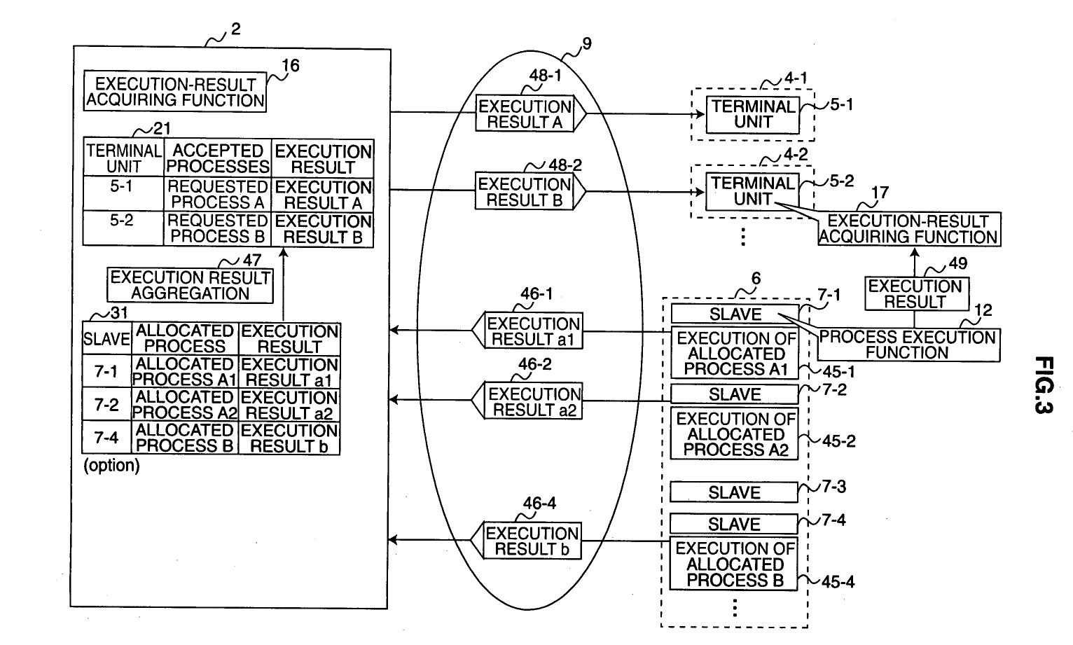

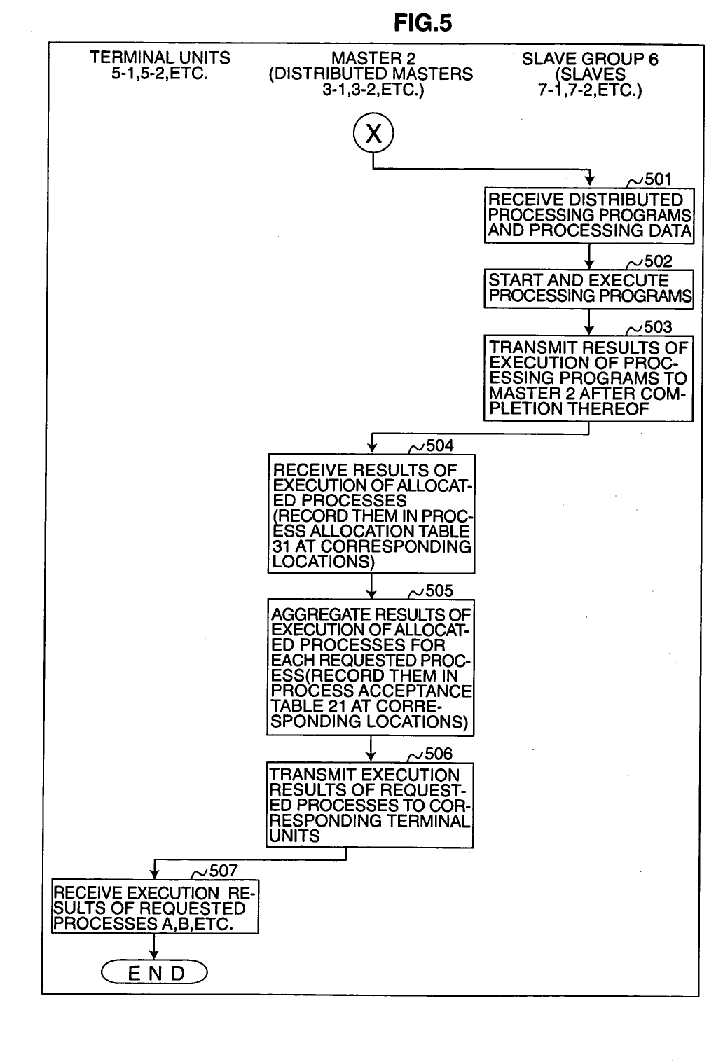

Next, the processes performed by the process executing function 12 of the slaves 7-1, 7-2, etc., the execution-result acquiring function 16 of the master 2, and the execution-result acquiring function 17 of the terminal units 5-1, 5-2, etc. will be described with reference to FIGS. 3 and 5.

FIG. 3 is a diagram schematically showing the processing in relation to the process executing function 12, the execution-result acquiring function 16, the execution-result acquiring function 17, etc.

FIG. 5 is a flowchart showing the steps of the processing in relation to the process executing function 12, the execution-result acquiring function 16, the execution-result acquiring function 17, etc.

The corresponding slaves 7-1, 7-2, etc. receive from the master 2 the processing programs and processing data in relation to the allocated processes (step 501).

In the example shown in FIG. 2, the slaves 7-1, 7-2, and 7-4 receive the processing programs, processing data, etc., in relation to the allocated processes A1, A2, and B (steps 44-1, 44-2, and 44-4).

Notably, when necessary processing programs and processing data are already stored in the slaves 7-1, 7-2, etc. or the external memory 8-1, etc., the slaves 7-1, 7-2, etc. receive only process execution requests from the master 2.

The slaves 7-1, 7-2, etc. start the received processing programs so as to execute the allocated processes (step 502).

In an example shown in FIG. 3, the slaves 7-1, 7-2, and 7-4 start processing programs A1, A2, and B in relation to the allocated processes, to thereby execute the allocated processes A1, A2, and B (steps 45-1, 45-2, and 45-4).

Upon completion of the processing programs, the slaves 7-1, 7-2, etc. transmit to the master 2 the results of execution of the processing programs (results of execution of the allocated processes) (step 503).

In the example shown in FIG. 3, the slaves 7-1, 7-2, and 7-4 transmit execution results a1, a2, and b (results of execution of the allocated processes) to the master 2 (steps 46-1, 46-2, and 46-4).

The master 2 receives the results of execution of the allocated processes from the slaves 7-1, 7-2, etc., and stores them in the process allocation table 31. (step 504).

The master 2 aggregates the results of execution of the allocated processes for each requested process, and stores them in the process acceptance table 21 at corresponding locations (step 505).

In the example shown in FIG. 3, the master 2 aggregates the execution results a1, a2, and b for the allocated processes so as to obtain execution results A and B for the requested processes (step 47).

The master 2 transmits the execution results for the requested processes to the terminal units 5-1, 5-2, etc. of the corresponding requesters 4-1, 4-2, etc. (step 506). The terminal units 5-1, 5-2, etc. receive the execution results for the requested processes (step 507).

In the example shown in FIG. 3, the master 2 transmits the execution result A for the requested process A to the terminal unit 5-1 (step 48-1), and the execution result B for the requested process B to the terminal unit 5-2 (step 48-2).

When the master 2 fails to receive within a predetermined period (e.g., within one day after start of execution of the process) any execution result from a certain slave which is executing an allocated process, or when the certain slave which is executing the allocated process is determined not to operate properly, the master 2 solicits the slave group 6 to participate in the parallel processing, allocates the same process to a different slave 7-1, 7-2, etc. having applied for participation, and causes the slave to execute the allocated process (steps 403 to 406).

As shown in FIG. 3, the slaves 7-1, 7-2, etc. may transmit the execution results directly to the terminal units 5-1, 5-2, etc. of the requestors 4-1, 4-2, etc. without sending the execution results to the master 2 (step 49). Moreover, the system may be modified in such a manner that the slaves 7-1, 7-2, etc. transmit execution results to the network 9 by means of broadcast communication, and the master 2 (distributed masters 3) or the terminal unit 5 receives the execution results as needed.

When the master 2 ends the parallel processing, the master 2 sends an end instruction to the slaves 7-1, 7-2, etc. having applied for participation. Upon receipt of the end instruction, the slaves 7-1, 7-2, etc. end the application for participation, execution of the allocated process, etc.

Notably, the processes in the above-described steps 401 to 406 and the processes in the above-described steps 501 to 507 may be independently performed in parallel for each requested process and for each allocated process. For example, in the case where the master 2 has received all the execution results of allocated processes in relation to the requested process A at a certain point in time during the process in step 504, the master 2 can perform the processes in step 505 and subsequent steps for the requested process A even when the master 2 has not yet received all the execution results of allocated processes in relation to the requested process B.

Next, there will be described a case in which the terminal units 5-1, 5-2, etc. and the slaves 7-1, 7-2, etc. include computing units (CPU, etc.) having different processing systems.

When digital consumer electronics, cellular phones, or the like are used as the slaves 7-1, 7-2, etc., because of differences in processing system among CPUs, the slaves may fail to execute processing programs or the like which are received from the terminal unit of a requester via a network or an external memory.

In such a case, a function (CPU instruction conversion function) for converting operation codes of the processing program or the like received from the requester to those executable in the processing system of the slaves is provided in the slaves 7-1, 7-2, etc. or the master 2. This configuration enables the processing program or the like to be executed on the slaves.

Next, there will be descried a case where the above-described participation application function 11, process executing function 12, CPU instruction conversion function, etc. are incorporated in the slaves 7-1, 7-2, etc. (e.g., incorporated in the external memories 8-1, 8-2, etc., such as USB memory keys).

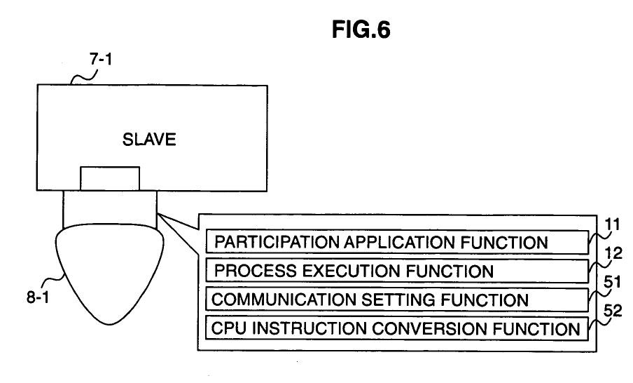

FIG. 6 is an explanatory diagram regarding the functions incorporated in the external memory 8-1 of the slave 7-1.

As shown in FIG. 6, the slaves 7-1, 7-2, etc. carry on the external memories 8-1, 8-2, etc. a communication setting (e.g., setting of ports) function 51, a CPU instruction conversion function 52, etc., in addition to the above-described participation application function 11 of the slaves and the process executing function 12, which is a processing program, etc. for a requested process. When necessary, each slave 7 executes the processing program after converting it to executable instruction codes by use of the CPU instruction conversion function 52. This CPU instruction conversion function has a so-called emulation function.

When the slave participates in parallel processing via the above-described external memory, functions, information, etc. regarding the parallel processing are not required to be previously recorded or set on a storage unit (hard disk drive, non-volatile memory, or the like) on the slave. Moreover, the setting and the like having established on the slave side before participation to parallel processing is maintained even after participation in the parallel processing. Furthermore, traces or the like of the parallel processing do not remain on the storage unit (hard disk drive, non-volatile memory, or the like) on the slave.

As described above, according to the first embodiment of the present invention, in response to a request for processing (requested process) from the terminal unit 5 of each requester 4, the master 2 solicits, by means of broadcast communication, the entire slave group 6 to participate in parallel processing. Each slave 7 determines, on the basis of its operating state, whether it has sufficient remaining resources to participate in the parallel processing. When the slave 7 can participate in the parallel processing, the slave 7 responds to the master 2 so as to apply for the participation. The master 2 allocates the process to the slaves 7 having applied for participation, and transmits the allocated processes thereto. The slaves 7 execute the allocated processes received from the master 2. After completion of execution of the processes, the slaves 7 send the execution results to the master 2 or the terminal unit 5 of the requester 4. The master 2 or the terminal unit 5 receives the execution results.

The master 2 or the slaves 7 have a function (CPU instruction conversion function) for converting operation codes, instruction codes, or the like of the processing program or the like to those executable in the processing system of the slaves 7; and when necessary, the master 2 or the slaves 7 convert the operation codes, instruction codes, or the like of the processing program or the like.

As described above, when necessary the master 2 (server) solicits participation in parallel processing, and the slave 7 (processing terminal unit) participates in the parallel processing in accordance with its operating state and the like. Therefore, the master 2 does not need to manage the operating states and the like of the slaves 7, and can realize efficient, high-speed parallel processing by allocating the process to the slaves 7 having applied for participation. Accordingly, the slaves 7 can participate in parallel processing in the middle of the parallel processing.

The master 2 may be formed by a plurality of distributed masters 3-1, 3-2, etc. Multiprocessing can be easily realized, by processing the same instruction or reply with early arrival priority.

The master 2 solicits, by means of broadcast communication, the entire slave group 6 to participate in parallel processing, and allocates processes to the slaves 7 having applied for participation. Therefore, the master 2 does not need to manage the operating states of the slaves 7. Meanwhile, when the master 2 is formed by a plurality of distributed masters 3-1, 3-2, etc., the slaves 7 may send a response by means of broadcast communication.

In this case, the master 2 (distributed masters 3-1, 3-2, etc.) and the slaves 7 may be modified to receive necessary information through only, for example, port setting. Accordingly, both the master 2 (distributed masters 3) and the slaves 7 can send an instruction, response, or the like, without considering the counterpart.

Notably, since broadcast communication enables transmission of data to all the nodes within the same data link (equipment, such as computers, connected to a network), the master 2 can solicit, by means of broadcast communication, the entire slave group 6 within the same data link to participate in parallel processing, whereas the slave 7 can respond, by means of broadcast communication, to the entire master 2 (distributed masters 3) within the same data link so as to apply for participation.

In a conventional parallel processing system, IP addresses or the like must be managed in order to specify transmission destinations or locations of processing terminal units on a network, which units execute parallel processing. In contrast, in the parallel processing system shown in the present embodiment, since communication processes over a network is effected by means of broadcast communication, IP addresses or the like are not required to be managed.

In the present embodiment, processing programs and processing data are first transmitted from the terminal unit 5 of the requester 4 to the master 2, and then transmitted to the slaves 7. However, the embodiment may be modified in such a manner that the same processing program is stored in the external memories 8-1, 8-2, etc. of the slaves 7-1, 7-2, etc. along with the participation application function 11 and the like, in accordance with a process application (e.g., a process of generating an image on the basis of input image data), and in response to a processing request, different processing data are transmitted to the slaves 7-1, 7-2, etc. so as to execute the application.

Moreover, when a slave 7 becomes unusable or fails to return the result of execution of an instructed process within a predetermined period of time, the same process is allocated to a different slave 7 having applied for participation in the parallel processing, whereby a process on which a deadline is imposed can be executed. In addition, a plurality of parallel processings from external equipment (the terminal unit 5 of the requester 4) rather than a predetermined system dedicated for processing can be executed easily.

Furthermore, volunteer terminal units (i.e., personal computers or the like used for general office automation) are used as processing terminal units, and during unused periods free resources of such computers are utilized. Therefore, parallel processing for, for example, a process which requires a huge amount of calculation can be realized. In such a case, at a site, such as a company, where a large number of personal computers exist, a high-speed computer environment can be obtained inexpensively. In addition, since the computer environment is automatically updated every time the volunteer terminal units (slaves) are updated, speedup can be attained without construction of a new computation environment.

Further, a memory having an instruction conversion function is provided on the slave 7 side or the master 2 side. This configuration enables parallel processing to be performed by use of not only ordinary personal computers, but also equipment, such as a digital consumer electronics device, which includes a computing device (CPU or the like) having a different processing system and computing system, and cellular phones, thereby enabling further speedup of parallel processing.

The programs for performing the processes shown in FIGS. 4, 5, etc. may be stored on a recording medium such as a CD-ROM for distribution, or may be transmitted and received via a communication line.

Next, a second embodiment of the present invention will be described.

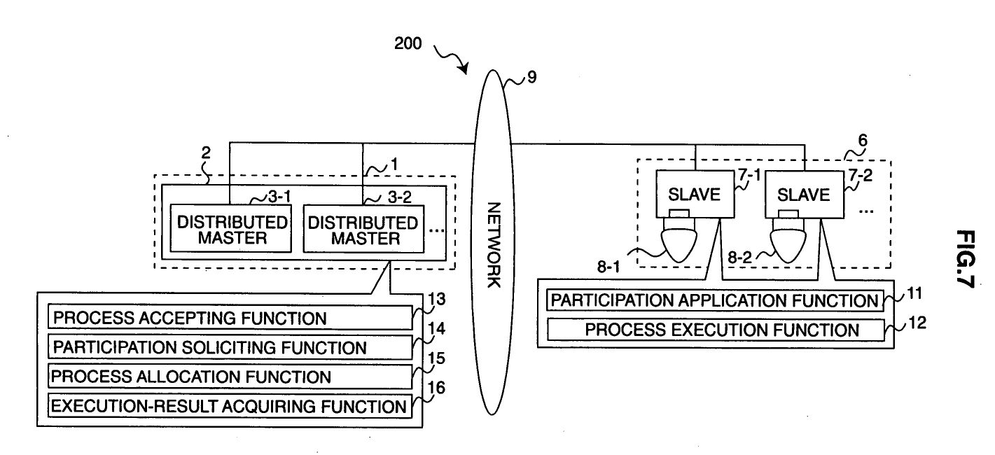

FIG. 7 is a diagram schematically showing the configuration of a parallel processing system 200 according to the second embodiment of the present invention.

In the above-described first embodiment, the master 2 accepts, via the network 9, a request for process (requested process) from each terminal unit 5 and executes the requested process through parallel processing. In contrast, in the second embodiment, such a requested process is input directly to the master 2. Specifically, the process accepting function 13 of the master 2 accepts, as a requested process, not only a process transmitted via the network 9 by means of, for example, a WEB page, but also a process input directly to the master 2.

In the case of the first embodiment, since a user can request the master 2 to perform parallel processing from each terminal unit 5 via the network 9, the user can request the parallel processing and obtain the result of execution of the process at a remote site. For example, a large number of computers dedicated for parallel processing are installed in a center, and these computers are operated from a remote site.

In contrast, in the case of the second embodiment, although allocated processes and results of execution of the allocated processes are transmitted through the network 9, the entirety of a requested process and results of execution of the requested process are not transmitted through the network 9. Therefore, safety and confidentiality can be improved.

Next, a third embodiment of the present invention will be described.

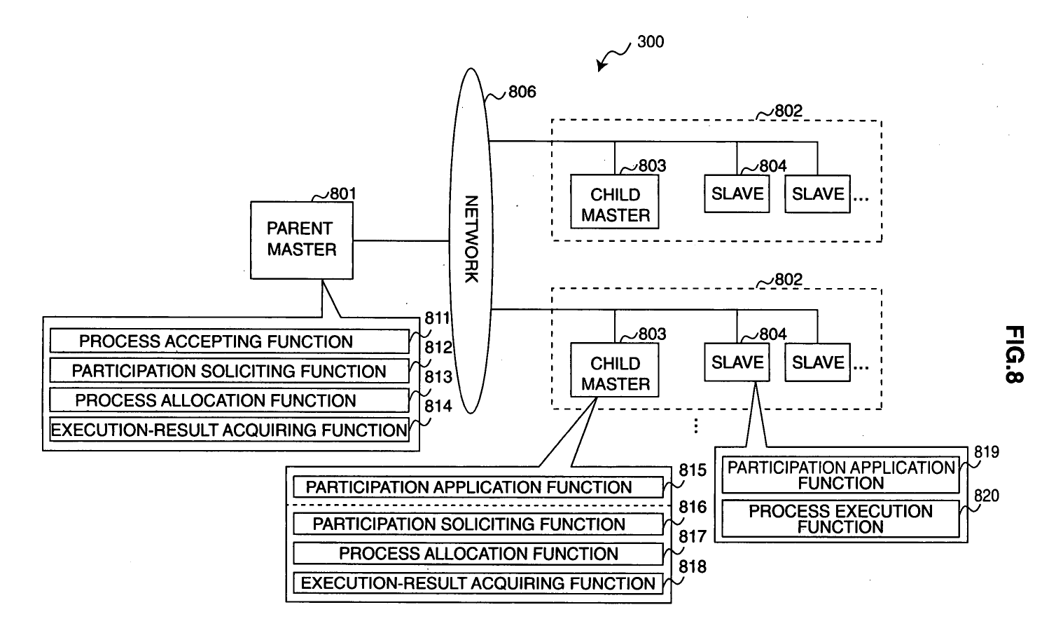

FIG. 8 is a diagram schematically showing the configuration of a parallel processing system 300 according to the third embodiment of the present invention.

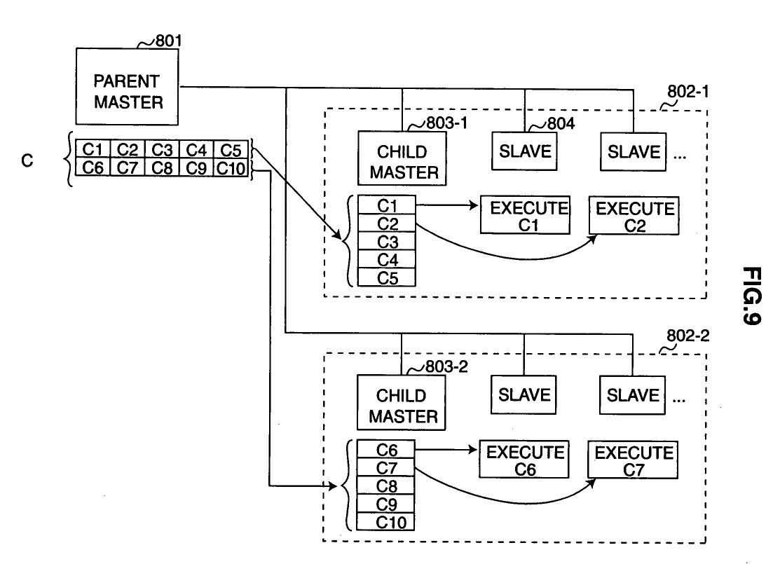

FIG. 9 is a diagram showing the flow of processing in the parallel processing system 300 according to the third embodiment of the present invention.

The parallel processing system 300 includes a parent master 801, a plurality of child masters 803 associated with the parent master, and a plurality of slaves 804 associated with each of the respective child masters 803, all of which are connected together via a network 806. That is, the master is configured to form a hierarchical structure.

Each child master 803 and a plurality of slaves 804 associated therewith form a virtual group 802.

Each of the parent master 801 and the child masters 803 is a server computer serving as a “sub-server.” The parent master 801 and the child masters 803 correspond, as a whole, to the master 2, which serves as a “server” in the first and second embodiments.

Like the master 2 in the first embodiment, the parent master 801 includes a process accepting function 811, a participation soliciting function 812, a process allocation function 813, and an execution-result acquiring function 814.

Each of the child masters 803 includes a participation application function 815, as in the case of the slave 7 in the first embodiment; and further includes a participation soliciting function 816, a process allocation function 817, and an execution-result acquiring function 818, as in the case of the master 2t.

Each of the slaves 804 includes a participation application function 819 and a process executing function 820, as in the case of the slave 7 in the first embodiment.

As shown in FIG. 9, when the parent master 801 receives a transmitted or entered, requested process C, the parent master 801 solicits, by use of broadcast communication, all the child masters 803 to participate in the parallel processing.

When a child master 803 is to participate in the parallel processing, the child master 803 responds to the parent master 801 so as to apply for participation.

The parent master 801 generates to-be-allocated processes C1 to C10 from the requested process C, and transmits them to the child masters 803 having applied for participation.

Notably, the parent master 801 successively transmits, for example, the to-be-allocated processes C1 to C5 to the child mater 803-1, and the to-be-allocated processes C6 to C10 to the child master 803-2, in accordance with the processing capacity of each group 802 (processing capacity of the slaves 804 associated with each child master 803).

Each of the child masters 803 solicits, by use of broadcast communication, all the slaves 804 within the corresponding group 802 to participate in the parallel processing.

When a slave 804 is to participate in the parallel processing, the slave 804 responds to the child master 803 so as to apply for participation.

The child master 803 distributes to some of the slaves 804 having applied for participation the plurality of allocated processes received from the parent master 801.

In the example shown in FIG. 9, the child master 803-1 transmits the allocated processes C1, C2, . . . , C5 to the slaves 804 having applied for participation, whereas the child master 803-2 transmits the allocated processes C6, C7, . . . , C10 to the slaves 804 having applied for participation.

Each of the slaves 804 executes the allocated process, and the result of execution of the process is transmitted to the parent master 801 via the corresponding child master 803.

The parent master 801 aggregates the results of execution of the allocated processes to thereby produce a result of execution of the requested process.

As described above, each of the child masters 803 successively receives allocated processes (processing data, processing programs, etc.) from the parent master 801, distributes them to the slaves 804 associated therewith (the slaves 804 in the same group 802), and causes the slaves 804 to execute them. Therefore, the speed of parallel processing can be increased.

In the case where the above-described hierarchization is not performed as in the first and second embodiments, all the slaves 7 transmit responses or the like to the single master 2 to apply for participation, whereby the communication load of the master 2 increases, possibly resulting in generation of a communication bottleneck.

In the above-described third embodiment, the master has a hierarchical structure, and each slave 804 transmits responses or the like to the child master 803. Therefore, the communication load of the parallel processing system 300 can be reduced, and operation stability is improved.

In FIGS. 8 and 9, the maser has a two-level hierarchical structure; however, the master may have a hierarchical structure of three or more levels. In such a case, each slave transmits a response or the like to a corresponding master within the same group (a master associated with the slave), and the lower-level master transmits a response or the like to a corresponding master at the immediately higher hierarchical level. Therefore, the speed of parallel processing can be increased, the communication load of the parallel processing system can be reduced, and operation stability can be improved.

The processing procedures (participation solicitation, participation application, process allocation, transmission of execution results, acquisition of execution results, etc.) between the master and the masters at the immediately lower hierarchical level are similar to those between the master 2 and the slaves 7 in the first and second embodiments. Accordingly, modification of the system configuration in relation to, for example, hierarchization of the master, is easy, and development or preparation of a special management application or the like is not required.

For example, as shown in FIG. 8, each of the child masters 803, which are provided for hierarchization of the master, is merely required to have a participation application function which is the same as that of the slave 7, and a participation soliciting function, a process allocation function, an execution-result acquiring function, and the like, which are the same as those of the master 2, which means that development or preparation of a special management application or like is not required.

Notably, the hierarchization of the master shown in the third embodiment can be realized in either of the first and second embodiments.

Next, communication processes by means of broadcast communication in the parallel processing systems will be described in detail.

In the parallel processing systems of the first through third embodiments, in relation to communications among the master, the slaves, the terminal units, etc., and communication processes through networks, exchange of communication data and information (participation solicitation, participation application, process allocation, transmission of execution results, acquisition of execution results, etc.) is effected by use of broadcast communication.

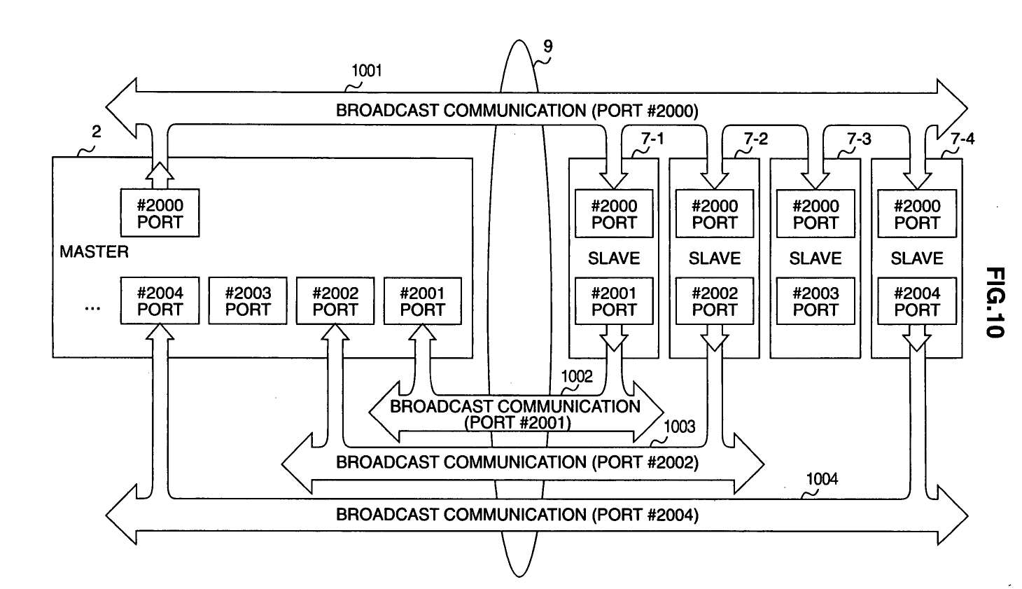

FIG. 10 is a diagram schematically showing communication processes at the master 2 and the slaves 7 effected by means of broadcast communication.

Notably, respective port numbers of transmission sources and destinations in relation to a predetermined communication process may differ in some cases. However, in order to simplify the description, a port number is assumed to be set for each type of communication process, and the transmission source and destination are assumed to have the same port number.

As shown in FIG. 10, a #2000 port, a #2001 port, a #2002 port, a #2003 port, a #2004 port, etc. are set in the master 2; a #2000 port and a #2001 port are set in the slave 7-1; a #2000 port and a #2002 port are set in the slave 7-2; a #2000 port and a #2003 port are set in the slave 7-3; and a #2000 port and a #2004 port are set in the slave 7-4.

The #2000 port is a communication port to be used for communication (e.g., participation solicitation) between the master 2 and all the slaves 7.

The #2001 port is a communication port to be used for communication (e.g., participation application) between the master 2 and the slave 7-1.

The #2002 port is a communication port to be used for communication (e.g., participation application) between the master 2 and the slave 7-2.

The #2003 port is a communication port to be used for communication (e.g., participation application) between the master 2 and the slave 7-3.

The #2004 port is a communication port to be used for communication (e.g., participation application) between the master 2 and the slave 7-4.

When the master 2 transmits communication data to all the slaves 7 (e.g., solicits the slaves to participate in parallel processing), the master 2 adds a transmission destination port number 2000 to the communication data, and sends the communication data to the network 9 by means of broadcast communication. Since a port whose port number is 2000 is set in each of the slaves 7-1, 7-2, 7-3, 7-4, etc., the slaves 7-1, 7-2, 7-3, 7-4, etc. receive the communication data (transmission destination port number: 2000) (step 1001).

When the slave 7-1 transmits communication data to the master 2 (e.g., applies for participation in parallel processing), the slave 7-1 adds a transmission destination port number 2001 to the communication data, and sends the communication data to the network 9 by means of broadcast communication. Since a port whose port number is 2001 is set in the master 2, the master 2 receives the communication data (transmission destination port number: 2001) (step 1002).

Similarly, when the slave 7-2 (7-4) transmits communication data to the master 2, the slave 7-2 (7-4) adds a transmission destination port number 2002 (2004) to the communication data, and sends the communication data to the network 9 by means of broadcast communication. Since a port whose port number is 2002 (2004) is set in the master 2, the master 2 receives the communication data (transmission destination port number: 2002 (2004)) (step 1003 (1004)).

In the above description, communication processes in relation to participation solicitation and participation application are taken as an example. However, communication processes in relation to transmission/reception of allocated processes and transmission/reception of results of execution of allocated processes can be performed in the same manner, wherein, in accordance with necessity, a port number is set in the master 2, the slaves 7, and the terminal units 5 for each type of communication process, and communication data having the port number attached thereto are sent to the network 9 by means of broadcast communication, whereby communication data are exchanged between the master 2, the slaves 7, and the terminal units 5 so as to realize parallel processing.

In the case where the master 2 has a distributed configuration or multi-configuration, even the same instruction or reply is processed with early arrival priority.

Next, a fourth embodiment of the present invention will be described. In the following descriptions for respective embodiments, portions differing from those of the first embodiment will be mainly described, and repeated descriptions are omitted.

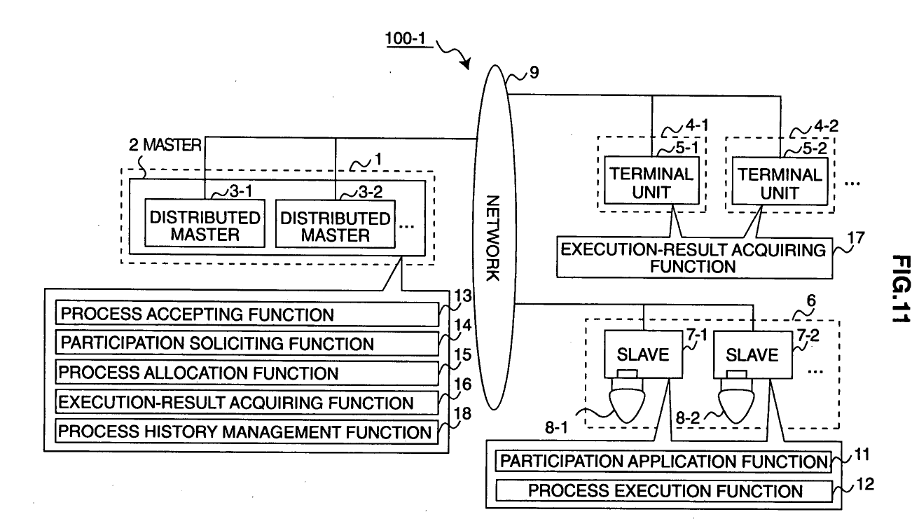

FIG. 11 is a diagram schematically showing the configuration of a parallel processing system 100-1 according to the fourth embodiment of the present invention.

In the parallel processing system 100-1, the master 2 has a process accepting function 13, a participation soliciting function 14, a process allocation function 15, a execution-result acquiring function 16, a process history management function 18, etc.

The process history management function 18 holds a process history table which includes a history of process allocation, a history of processes performed in the slaves 7-1, 7-2, etc. of the slave group 6 (type of allocated process, process start date/time, process end date/time, etc.), and information (process record, process time, average process time, etc.) derived from the process history.

Next, the processing steps of the parallel processing system 100-1 will be described.

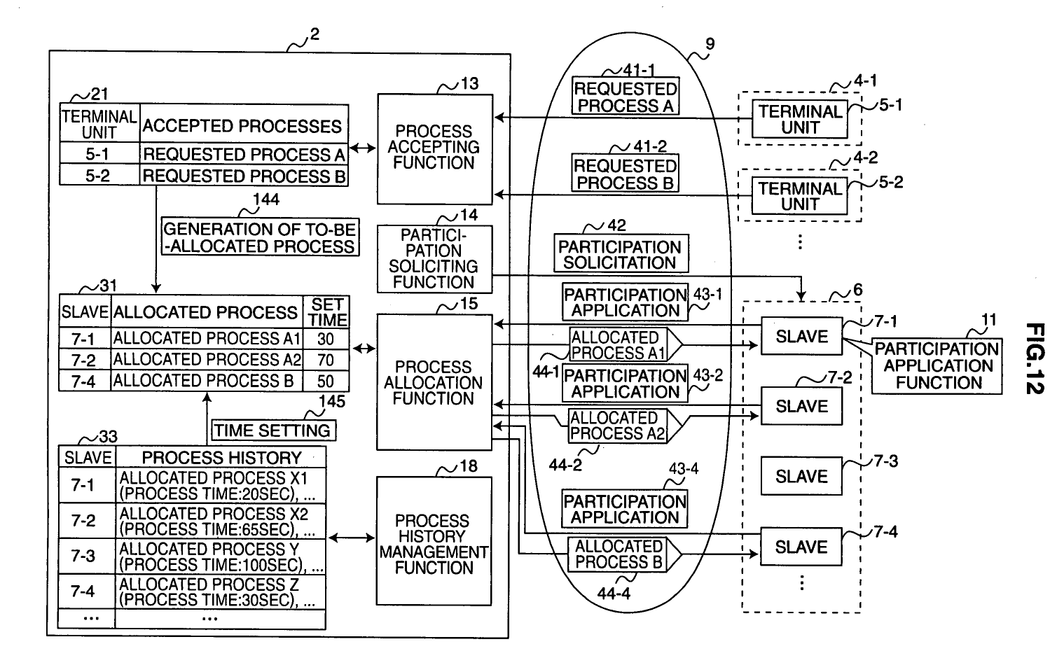

FIG. 12 is a diagram schematically showing the processing in relation to the process accepting function 13, the participation soliciting function 14, the process allocation function 15, the process history management function 18, the participation application function 11, etc.

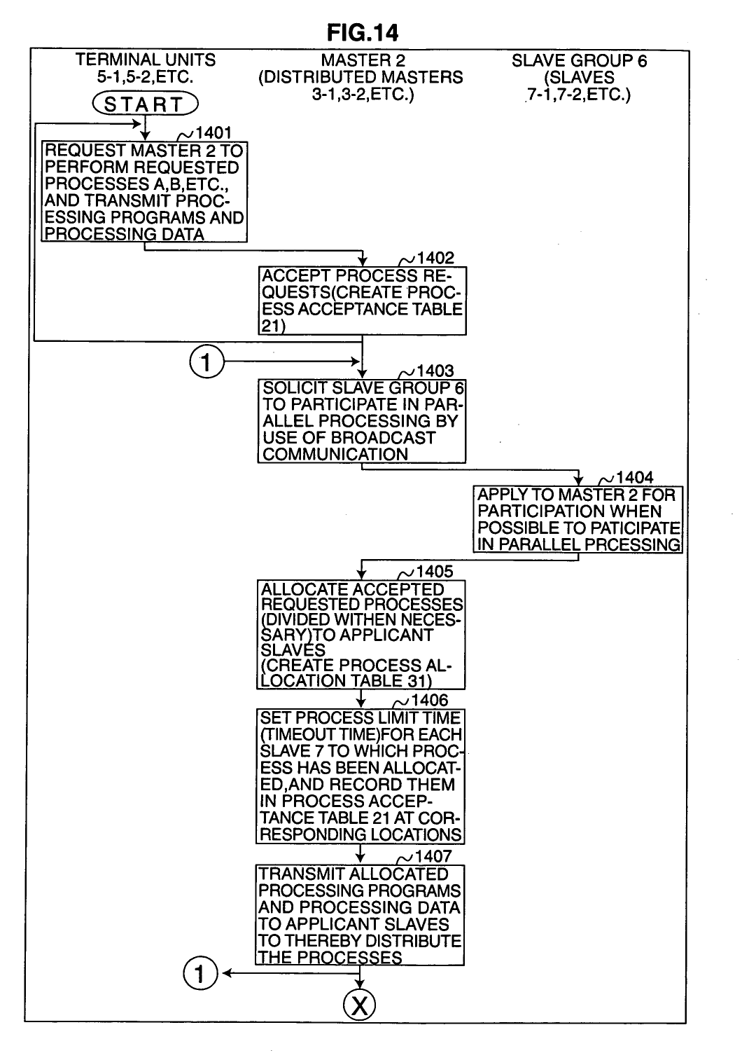

FIG. 14 is a flowchart showing the steps of the processing in relation to the process accepting function 13, the participation soliciting function 14, the process allocation function 15, the process history management function 18, the participation application function 11, etc.

The flowchart shown in FIG. 14 differs from that shown in FIG. 4 in that the process in step 1406 is added. Mainly this point of difference will be described.

The processes in steps 1401 to 1405 are the same as those in steps 401 to 405 (FIG. 4) of the first embodiment.

The master 2 sets a process limit time (timeout time) for each of the slaves 7 to which processes have been allocated (step 1406).

As shown in FIG. 12, the master 2 determines a process limit time with reference to the process history table 33 (process record, process time, average process time, etc. for each slave 7), or on the basis of the processing capacity (CPU capacity, etc.) of each slave 7, which has been entered on the basis of results of a previous investigation. Subsequently, the master 2 records the thus-determined process limit time in the process allocation table 31 at a corresponding location (step 45).

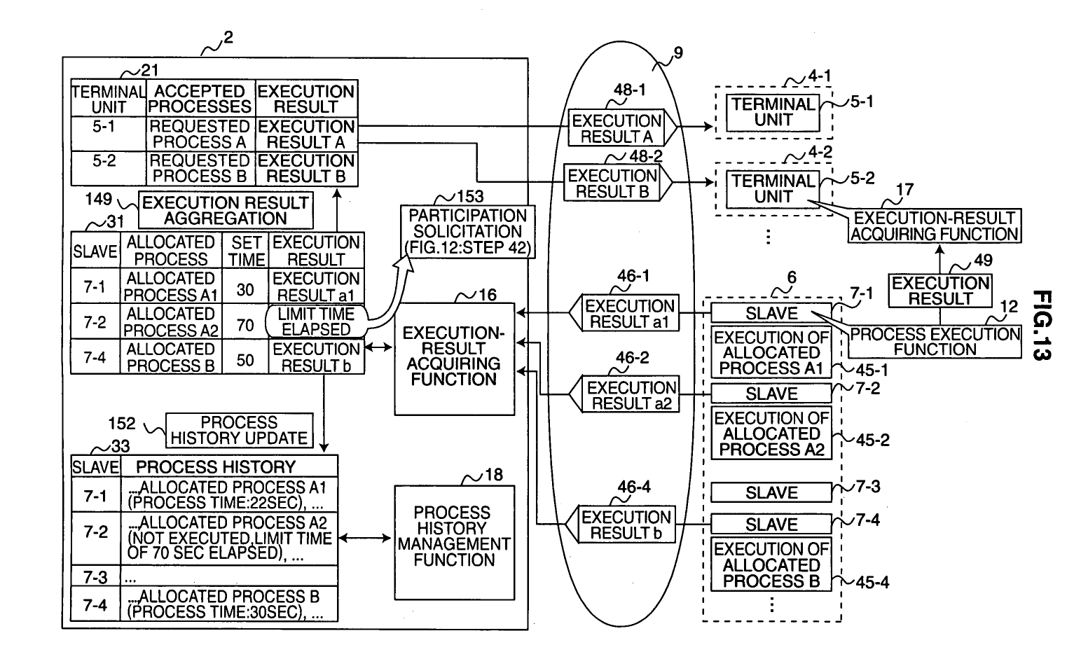

FIG. 13 is a diagram schematically showing the processing in relation to the process executing function 12, the execution-result acquiring function 16, the execution-result acquiring function 17, the process history management function 18, etc.

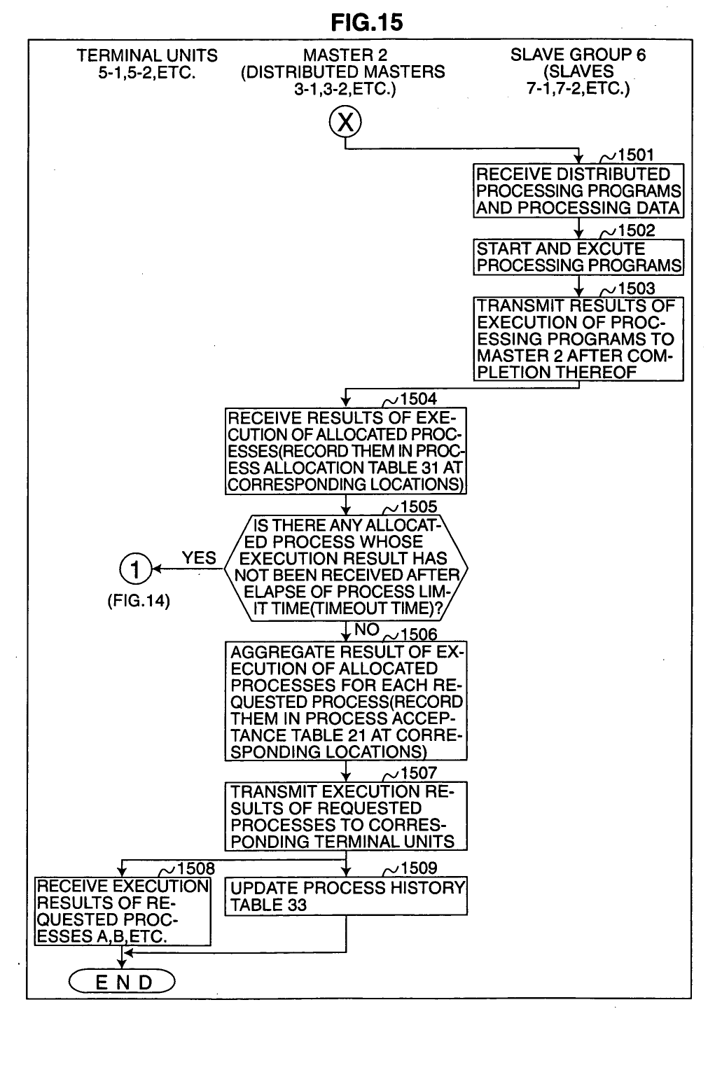

FIG. 15 is a flowchart showing the steps of the processing in relation to the process executing function 12, the execution-result acquiring function 16, the execution-result acquiring function 17, the process history management function 18, etc.

The processes in steps 1501 to 1504 are the same as those in steps 501 to 504.

The master 2 determines for each requested process whether any allocated process is present for which the master 2 has not yet received an execution result after elapse of the corresponding process limit time (timeout time) (step 1505). When such an allocated process is present (Yes in step 1505), the master 2 solicits the slave group 6 to participate in the parallel processing, allocates the same process to a different slave 7-1, 7-2, etc. having applied for participation, and causes the slave to execute the allocated process (steps 1403 to 1407).

In the example shown in FIG. 13, when the master 2 does not receive an execution result of the process A2 allocated to the slave 7-2 upon elapse of a process limit time (timeout time) of 70 sec, the master 2 solicits the slave group 6 to participate in the parallel processing (step 153).

Notably, examples of the case where the process limit time (timeout time) has elapsed before the master 2 receives an execution result from the corresponding slave 7 include the case where the master 2 does not receive an execution result from the corresponding slave which is executing the allocated process, before a predetermined time limit (e.g., elapse of one day, 30 sec., 70 sec., or 50 sec. after start of execution of the process), the case where the slave which is executing the allocated process is considered not to operate properly, and the case where the slave enters an usable state.

The master 2 determines for each requested process whether any allocated process is present for which the master 2 has not yet received an execution result after elapse of the corresponding process limit time (timeout time) (step 1505). When such an allocated process is not present (No in step 1505), the master 2 aggregates the results of execution of the allocated processes for each requested process, and stores them in the process acceptance table 21 at corresponding locations (step 1506).

In the example shown in FIG. 13, the master 2 aggregates the execution results a1, a2, and b for the allocated processes so as to obtain execution results A and B for the requested processes (step 149).

Subsequently, after performance of the processing in step 1507, the master 2 updates the process history table 33—which includes a history of process allocation, a history of processes performed in the slaves 7-1, 7-2, etc. of the slave group 6 (type of allocated process, process start date/time, process end date/time, etc.), and information (process record, process time, average process time, etc.) derived from the process history (step 1509).

In the example shown in FIG. 13, when the master 2 receives the execution results from the slaves 7-1 and 7-4, the master 2 updates the process histories corresponding to these slaves in the process history table 33 (step 152).

When the master 2 ends the parallel processing, the master 2 sends an end instruction to the slaves 7-1, 7-2, etc. having applied for participation. Upon receipt of the end instruction, the slaves 7-1, 7-2, etc. end the application for participation, execution of the allocated process, etc.

As described above, according to the fourth embodiment, the master 2 sets a process limit time (timeout time) for each slave 7 when it allocates a process to the slave; and when a result of execution of the allocated process is not transmitted to the master 2 within the process limit time, the master 2 allocates the process to another slave 7 and causes the same to execute the process.

Accordingly, even when a relevant slave 7 becomes unusable in the middle of a process or when the slave 7 becomes unable to execute the process because of a failure or the like, parallel processing can be continued, whereby failure resistance is improved. That is, the master 2 can cause a slave to disengage the process in the middle of the process.

When the process allocated to a slave 7 having failed to transmit an execution result within the process limit time (hereinafter referred to as a “previously allocated sleeve 7”) is allocated to another slave 7 (hereinafter referred to as a “subsequently allocated sleeve 7”), the master 2 may instruct the previously allocated sleeve 7 to end the execution of the allocated process. Alternatively, the master 2 may allow the previously allocated sleeve 7 to continue the execution of the allocated process, receive an execution result from one of the previously allocated sleeve 7 and the subsequently allocated sleeve 7, whichever transmits an execution result first, and discard an execution result subsequently transmitted from the remaining slave 7. In this case, the master 2 does not need to manage the states of the slaves 7 or the status of the process.

Moreover, the master 2 holds a process history, etc. for each slave 7, and sets the process limit time (timeout time) for each slave 7 with reference to the process history, etc., or in accordance with the previously input data regarding the processing capacity (CPU capacity, etc.) of each slave 7.

Since the master 2 sets the process limit time (timeout time) for each slave 7 in accordance with the processing capacity of the slave 7, wasteful waiting time can be shortened, as compared with the case where a constant process limit time (timeout time) is set.

Here, an example case is assumed where a slave including a high-performance CPU takes 10 seconds to complete a certain allocated process, a slave including a low-performance CPU takes 60 seconds to complete the allocated process, and a constant process limit time (timeout time) of 70 seconds is set for these slaves. In such a case, if the slave including a high-performance CPU becomes unable to perform the process upon elapse of 15 seconds after start of the process, the master 2 allocates the process to another slave only after elapse of a waiting time of 55 seconds.

In contrast, in the case where a process limit time (timeout time) of 15 seconds is set for the slave including a high-performance CPU, and a process limit time (timeout time) of 70 seconds is set for the slave including a low-performance CPU, the wasteful waiting time can be shortened, and thus the overall speed of the parallel processing can be increased.

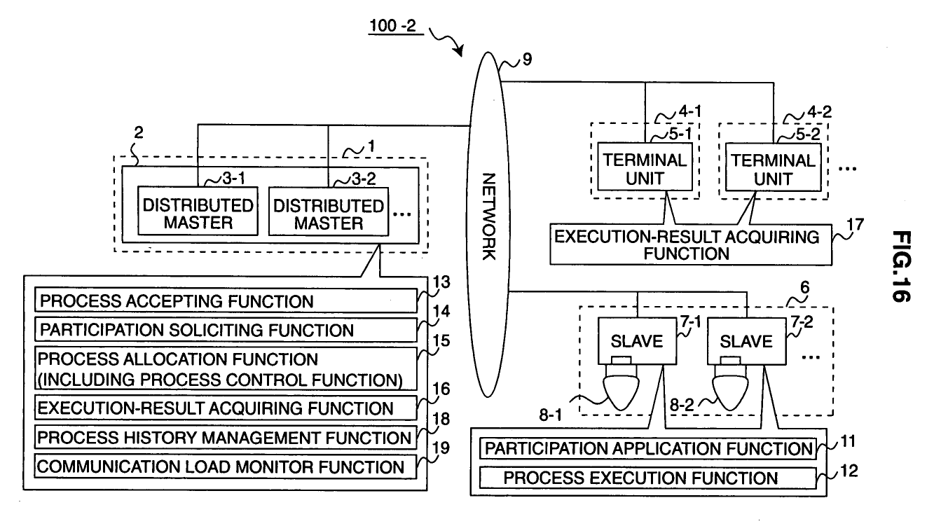

Next, a fifth embodiment of the present invention will be described. FIG. 16 is a diagram schematically showing the configuration of a parallel processing system 100-2 according to the fifth embodiment of the present invention.

As shown in FIG. 16, in the fifth embodiment, the master 2 has a process accepting function 13, a participation soliciting function 14, a process allocation function 15, a execution-result acquiring function 16, a process history management function 18, a communication load monitor function 19, etc.

The process allocation function 15 generates to-be-allocated processes from a requested process, and allocates one or more to-be-allocated processes to each of the slaves 7-1, 7-2, etc., in accordance with a process quantity (grain size) determined on the basis of processing capacity. The communication load monitor function 19 measures the communication load ratio of the network 9 so as to monitor communication load and control the process quantity in relation to the allocated processes.

Next, the processing steps of the parallel processing system 100-2 will be described.

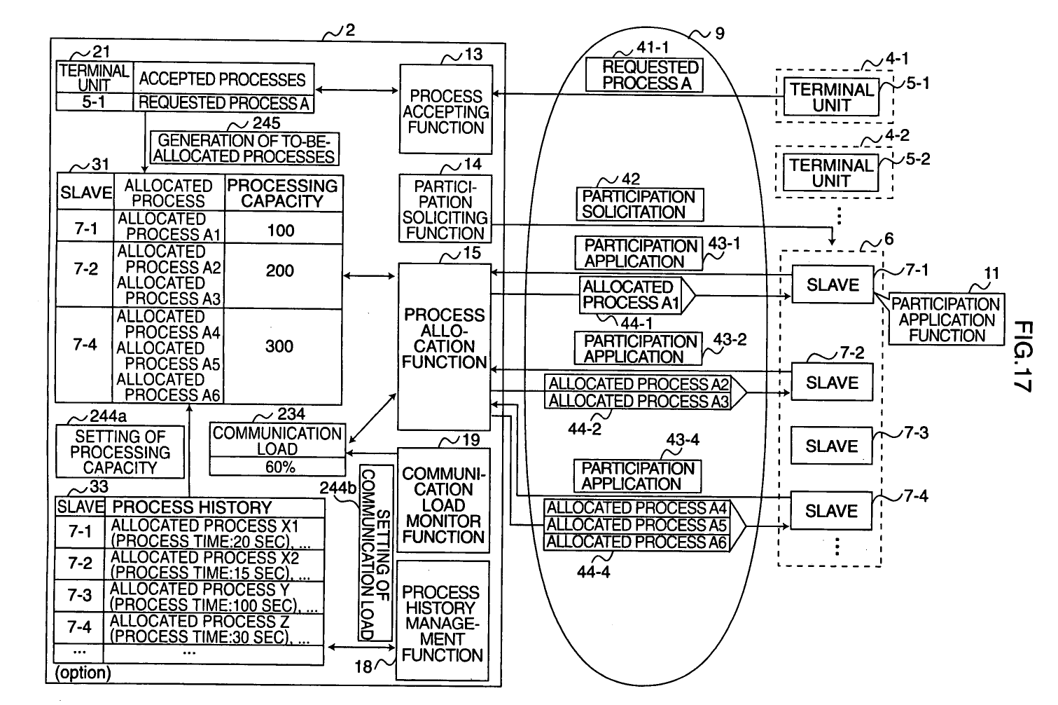

FIG. 17 is a diagram schematically showing the processing in relation to the process accepting function 13, the participation soliciting function 14, the process allocation function 15, the process history management function 18, the communication load monitor function 19, the participation application function 11, etc.

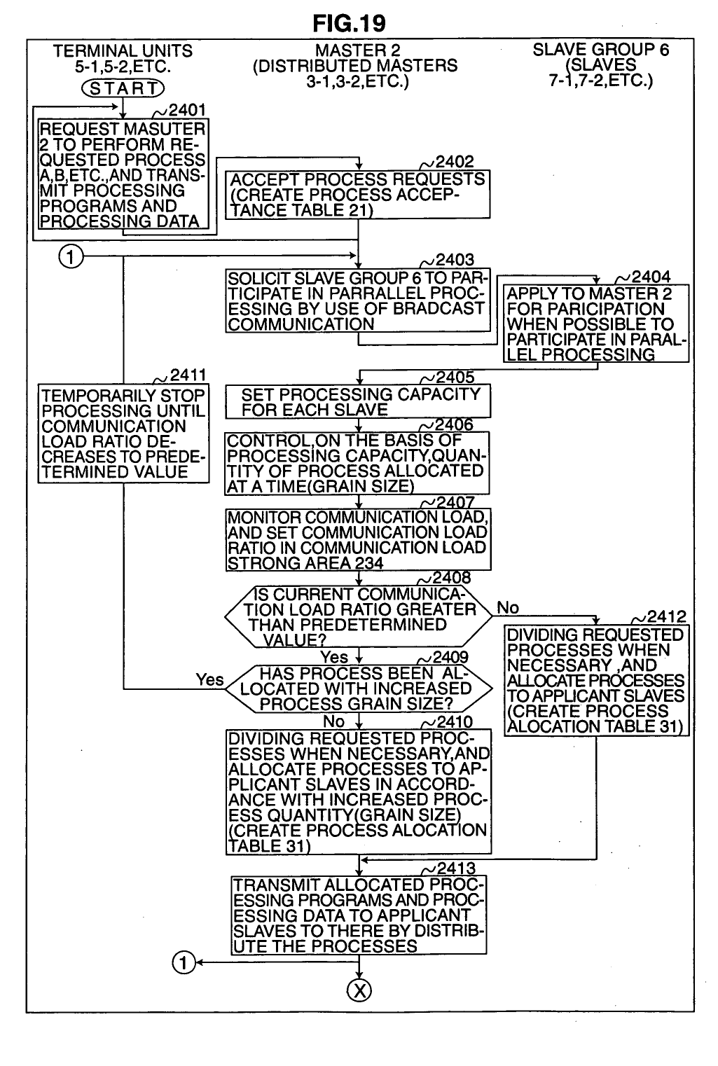

FIG. 19 is a flowchart showing the steps of the processing in relation to the process accepting function 13, the participation soliciting function 14, the process allocation function 15, the process history management function 18, the communication load monitor function 19, the participation application function 11, etc.

The processes in steps 2401 to 2404 are the same as those in steps 401 to 404 of the first embodiment.

The master 2 sets a processing capacity (CPU capacity) for each of slaves 7 having applied for participation (step 2405).

As shown in FIG. 17, the master 2 determines a processing capacity with reference to the process history table 33 (process record, process time, average process time, etc. for each slave 7), or on the basis of the CPU capacity, memory quantity, etc. of each slave 7, which have been entered on the basis of results of a previous investigation. Subsequently, the master 2 records the thus-determined processing capacity in the process allocation table 32 at a corresponding location (step 244a).

For each slave, the master 2 controls and sets the quantity of process to be allocated at a time (process grain size), on the basis of the processing capacity thereof (step 2406).

For example, the master 2 sets the process grain size for the slave 7-1 whose processing capacity is “100” to “1” (one allocated process), sets the process grain size for the slave 7-2 whose processing capacity is “200” to “2” (two allocated processes), and sets the process grain size for the slave 7-4 whose processing capacity is “300” to “3” (three allocated processes).

The master 2 always monitors the communication load of the network 9, and sets a communication load ratio in a communication load storage area 234 (step 2407). The master 2 measures the traffic of data moving on the network 9 by use of a measurement device, and determines and calculates a communication load ratio.

In the example shown in FIG. 17, the master 2 sets in the communication load storage area 234 a current communication load ratio “60%” having been measured and calculated (step 244b).

The master 2 determines whether the current communication load ratio is equal to or higher than a predetermined value (step 2408). When the current communication load ratio is not equal to or higher than the predetermined value (No in step 2408), the master 2 generates to-be-allocated processes from a requested process transmitted from one of the terminal units 5-1, 5-2, etc. Subsequently, in accordance with a process grain size determined for each slave on the basis of processing capacity thereof (in step 2406), the master 2 allocates them to some of the slaves 7-1, 7-2, etc. having responded to apply for participation (step 2412). That is, the master 2 allocates the to-be-allocated processes to each slave in accordance with a process grain size determined for each slave on the basis of processing capacity thereof (step 2406). Notably, if necessary, the master 2 divides the requested process to generate to-be-allocated processes.

As shown in the example shown in FIG. 17, when the communication load ratio stored in the communication load storage area 234 is 30%, which is lower than a predetermined level (e.g., 50%), in accordance with the process grain sizes set for each slave on the basis of the processing capacity thereof (in step 2406), the master 2 allocates one to-be-allocated process (to-be-allocated process A1) to the slave 7-1, two to-be-allocated processes (to-be-allocated processes A2 and A3) to the slave 7-2, and three to-be-allocated processes (to-be-allocated processes A4, A5, and A6) to the slave 7-4. Subsequently, the master 2 creates a process allocation table 31 which stores the correspondence between these to-be-allocated processes and the slaves (step 2412).

The master 2 determines whether the current communication load ratio is equal to or higher than a predetermined value (step 2408). When the current communication load ratio is equal to or higher than the predetermined value (Yes in step 2408) and the process grain size set in step 2406 has not been increased (No in step 2409), the master 2 generates to-be-allocated processes from a requested process transmitted from one of the terminal units 5-1, 5-2, etc., and increases the process grain size, which has been set for each slave on the basis of processing capacity thereof (in step 2406), to thereby change the set grain sizes. Subsequently, in accordance with the increased grain sizes, the master 2 allocates them to the slaves having responded to apply for participation (step 2410). That is, the master 2 allocates the to-be-allocated processes to the slaves 7 after increasing the process grain sizes set in step 2406. Notably, if necessary, the master 2 divides the requested process to generate to-be-allocated processes.

As shown in the example in FIG. 17, when the communication load ratio stored in the communication load storage area 234 is 60%, which is higher than the predetermined level (e.g., 50%), the master 2 increases the process grain size, which has been set for each slave on the basis of processing capacity thereof (step 2406); e.g., the master 2 increases the process grain size for the slave 7-1 from “1” to “2” (two allocated processes), the process grain size for the slave 7-2 from “2” to “3” (three allocated processes), and the process grain size for the slave 7-4 from “3” to “5” (five allocated processes). In this case, the master 2 allocates two to-be-allocated processes to the slave 7-1, three to-be-allocated processes to the slave 7-2, and five to-be-allocated processes to the slave 7-4. Subsequently, the master 2 creates the process allocation table 31 which stores the correspondence between these to-be-allocated processes and the slaves (step 2410). That is, the master 2 allocates to-be-allocated processes to the slaves on the basis of the increased process grain sizes, and then creates the process allocation table 31.

When the communication load ratio is equal to or higher than the predetermined value (Yes in step 2408) and the process allocation with increased process grain sizes has been performed (Yes in step 2409), the master 2 temporarily stops the processing until the communication load ratio decreases (step 2411), and then proceeds to step 2403.

The master 2 transmits processing programs, processing data, etc. in relation to the allocated processes to the slaves 7-1, 7-2, etc. to which the to-be-allocated processes have been allocated, to thereby distribute the processes (step 2413).

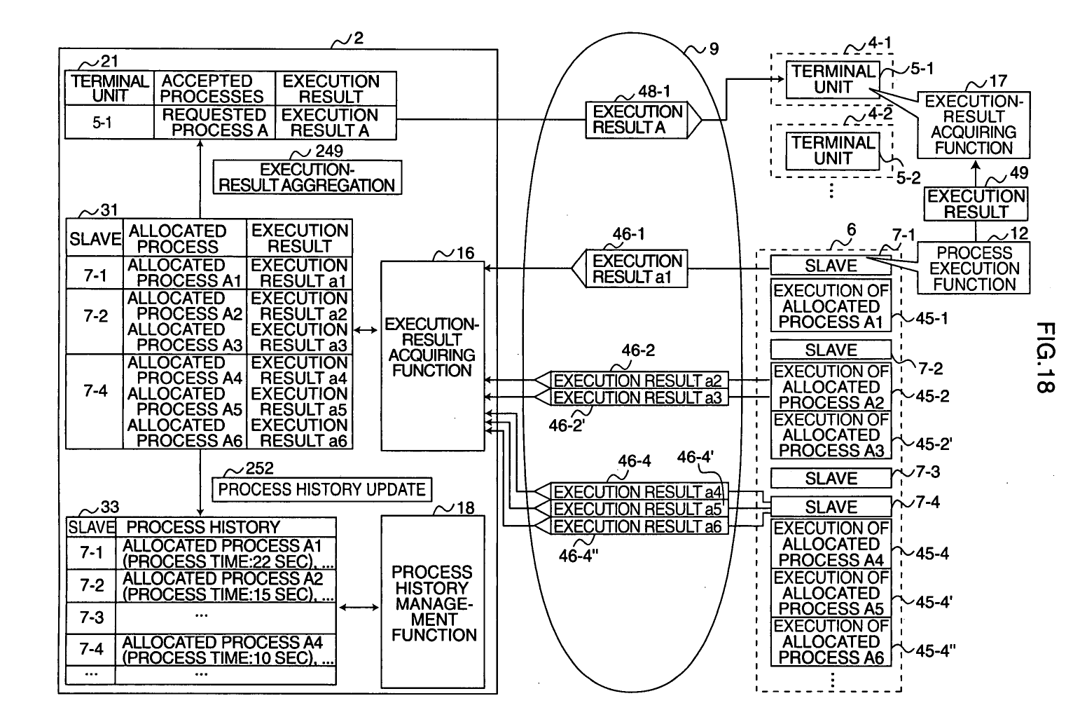

FIG. 18 is a diagram schematically showing the processing in relation to the process executing function 12, the execution-result acquiring function 16, the execution-result acquiring function 17, the process history management function 18, etc.

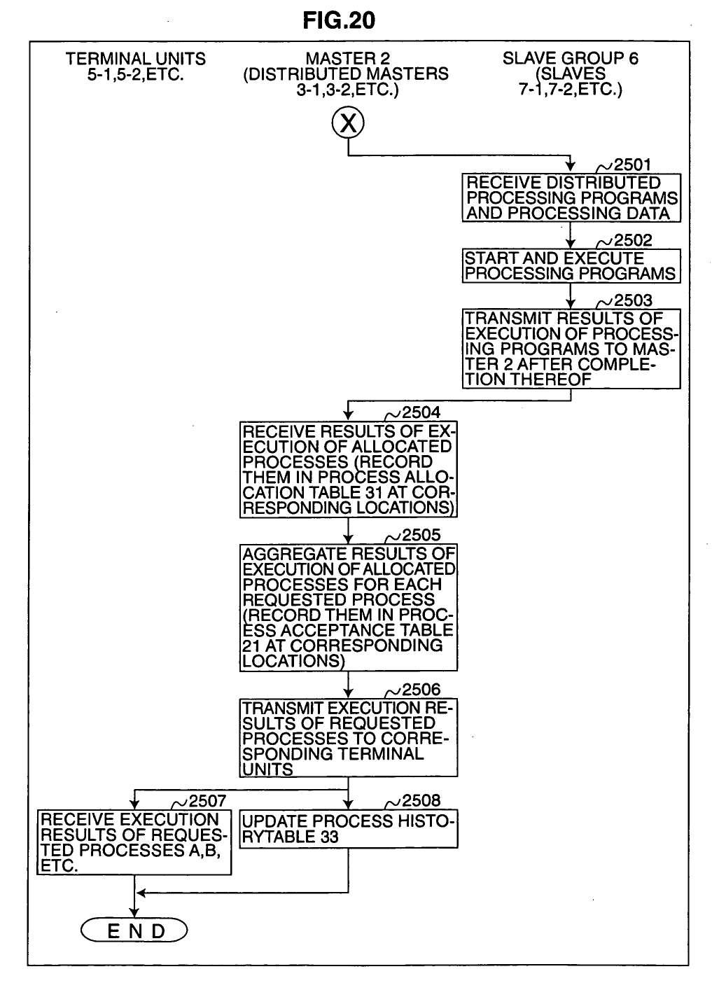

FIG. 20 is a flowchart showing the steps of the processing in relation to the process executing function 12, the execution-result acquiring function 16, the execution-result acquiring function 17, the process history management function 18, etc.

After completion of the process in step 2501, the slaves 7-1, 7-2, etc. start one or a plurality of received processing programs so as to execute one or a plurality of allocated processes (step 2502).

In an example shown in FIG. 18, the slaves 7-1 starts a processing program A1 in relation to the allocated process, to thereby execute the allocated process A1 (step 45-1). The slave 7-2 starts processing programs A2 and A3 in relation to the allocated processes, to thereby execute the allocated processes A2 and A3 (steps 45-2 and 45-2′). The slave 7-4 starts processing programs A4, A5, and A6 in relation to the allocated processes, to thereby execute the allocated processes A4, A5, and A6 (steps 45-4, 45-4′, and 45-4″).

The slaves 7 (processing terminal units) concurrently execute in parallel one or a plurality of allocated processes, in accordance with the processing capacities (CPU capacities) of the slaves 7 themselves as determined by the master 2.

Upon completion of the processing programs, the slaves 7-1, 7-2, etc. transmit to the master 2 the results of execution of the processing programs (results of execution of the allocated processes) (step 2503).

The master 2 receives the results of execution of the allocated processes from the slaves 7-1, 7-2, etc., and stores them in the process allocation table 31 at corresponding locations (step 2504).

The master 2 aggregates the results of execution of the allocated processes for each requested process, and stores them in the process acceptance table 21 at corresponding locations (step 2505).

In the example shown in FIG. 18, the master 2 aggregates the execution results a1, a2, a3, a4, a5, and a6 for the allocated processes so as to obtain execution result A for the requested process (step 249).

The master 2 transmits the execution result for the requested process to the terminal unit 5-1, 5-2, etc. of the corresponding requestor 4-1, 4-2, etc. (step 2506). The terminal unit 5-1, 5-2, etc. receives the execution result for the requested process (step 2507).

Subsequently, the master 2 updates the process history table 33—which includes a history of process allocation, a history of processes performed in the slaves 7-1, 7-2, etc. of the slave group 6 (type of allocated process, process start date/time, process end date/time, etc.), and information (process record, process time, average process time, etc.) derived from the process history (step 2508).

In the example shown in FIG. 18, when the master 2 receives the execution results from the slaves 7-1, 7-2, and 7-4, the master 2 updates the process histories corresponding to these slaves in the process history table 33 (step 252).

As described above, according to the fifth embodiment, the master 2 sets a processing capacity for each slave 7, sets a quantity of process to be allocated at a time (process grain size), on the basis of the processing capacity, and allocates one or a plurality of to-be-allocated processes to the slave 7. Notably, the master 2 holds a process history, etc. of each slave 7, and sets a processing capacity for each slave 7 with reference to the process history, etc. Alternatively, the master 2 sets a processing capacity for each slave 7 in accordance with previously input information regarding the CPU capacity, memory quantity, etc. of each slave 7.

Accordingly, as compared with the case where a constant allocated process quantity is set, CPU operating ratios can be increased, and the number of communications operations can be decreased, whereby communication load is reduced, and the communication environment can be stabilized. Thus, the overall speed and stability of parallel processing can be improved.

Moreover, the master 2 monitors the communication load of the network 9, and when the communication load ratio becomes equal to or higher than a predetermined level, the master 2 forcedly increases the process grain sizes, and allocates to-be-allocated processes to the slaves in accordance with the increased process grain sizes, to thereby reduce the number of communications operations, or temporarily restricts the processing, to thereby reduce the communication load of the network 9. Accordingly, the communication environment can be stabilized, whereby the overall speed and stability of parallel processing can be improved.

In the present embodiment, the master 2 monitors the communication load, and when the communication load becomes equal to or higher than a predetermined level, the master 2 increases the process grain size for each slave 7, allocates one or a plurality of to-be-allocated processes to the slave in accordance with the process quantity based on the processing capacity, and causes the slave to execute the allocated processes. However, the embodiment may be modified in such a manner that, irrespective of communication load, the master 2 allocates one or a plurality of to-be-allocated processes to the slave 7 in accordance with the process quantity based on the processing capacity, and causes the slave to execute the allocated processes.

Next, a sixth embodiment of the present invention will be described.

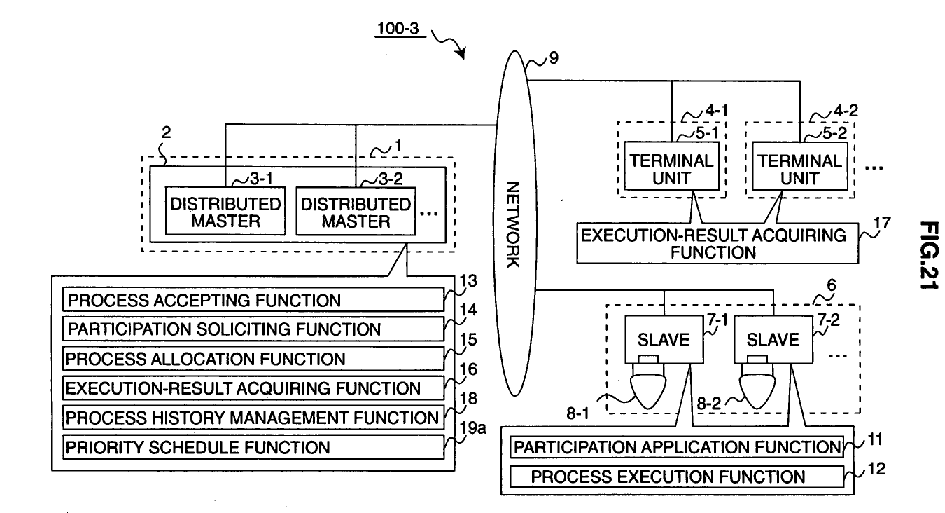

FIG. 21 is a diagram schematically showing the configuration of a parallel processing system 100-3 according to the sixth embodiment of the present invention.

In the present embodiment, the master 2 has a process accepting function 13, a participation soliciting function 14, a process allocation function (including a process control function) 15, a execution-result acquiring function 16, a process history management function 18, a priority schedule function 19a, etc.

The process allocation function 15 generates to-be-allocated processes from a requested process, and allocates a to-be-allocated process having a high priority level to the slaves 7-1, 7-2, etc. on the basis of the priority levels of the to-be-allocated processes. The priority schedule function 19a calculates predicted end times of the to-be-allocated processes, sets process request orders in an ascending order with respect to predicted end time, and preferentially schedules a to-be-allocated process(es) having high priority, on the basis of a priority order table 34 for the to-be-allocated processes.

Next, the processing steps of the parallel processing system 100-3 will be described.

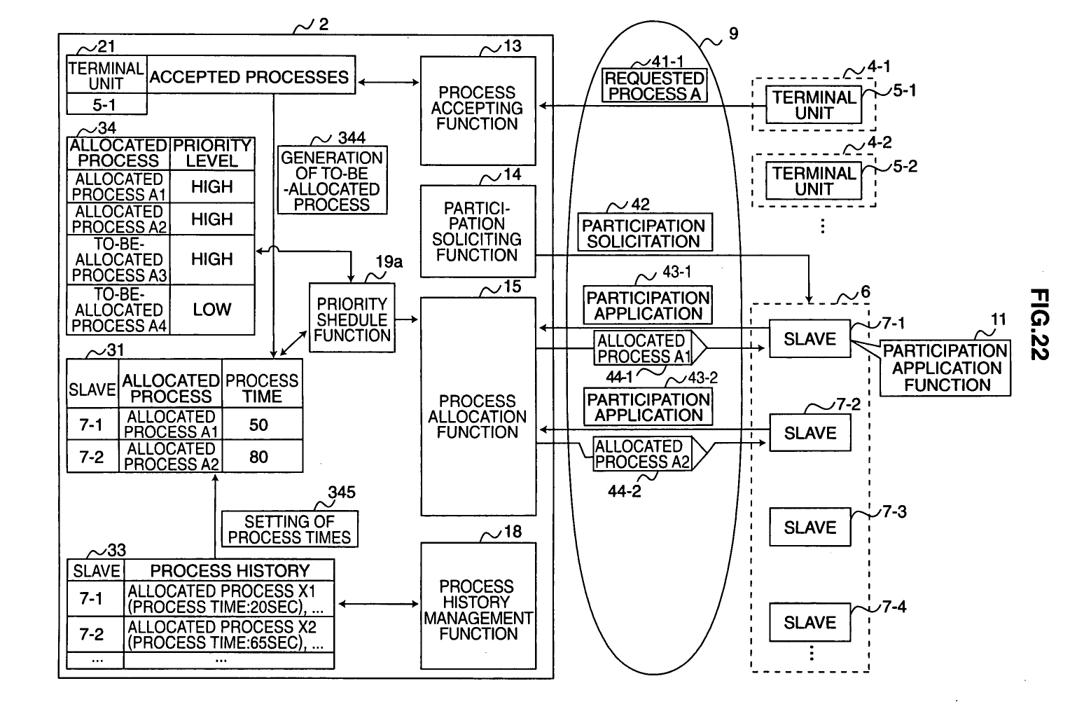

FIG. 22 is a diagram schematically showing the processing in relation to the process accepting function 13, the participation soliciting function 14, the process allocation function 15, the process history management function 18, the priority schedule function 19a, the participation application function 11, etc.

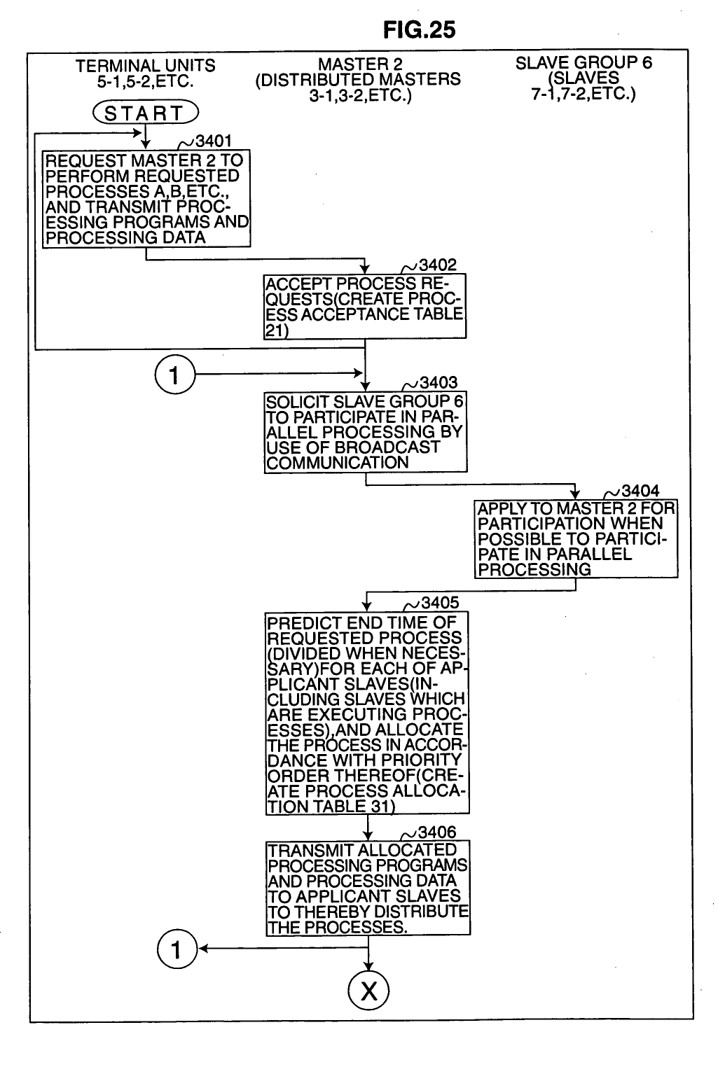

FIG. 25 is a flowchart showing the steps of the processing in relation to the process accepting function 13, the participation soliciting function 14, the process allocation function 15, the process history management function 18, the priority schedule function 19a, the participation application function 11, etc.

In FIG. 25, the processes in steps 3401 to 3404 are the same as those in steps 401 to 404 of FIG. 4.

After completion of the process in step 3404, the master 2 generates to-be-allocated processes from a requested process transmitted from one of the terminal units 5-1, 5-2, etc., predicts, for each of slaves 7 having applied for participation (including slaves which are executing processes), the end time of the to-be-allocated process, and allocates the to-be-allocated processes to the slaves 7 in accordance with the process priority levels contained in the priority order table 34 (step 3405). Notably, if necessary, the master 2 divides the requested process to generate to-be-allocated processes.

In the example shown in FIG. 22, the master 2 divides a requested process A into to-be-allocated processes A1, A2, A3, and A4. Subsequently, the master 2 allocates the processes A1 and A2, whose priority levels are “High,” to the slaves 7-1 and 7-2 having applied for participation (the slaves 7-3 and 7-4 have not applied for participation) in accordance with the priority levels of the allocated processes contained in the priority order table 34, and then creates the process allocation table 31 (step 344). The process allocation table 31 stores the correspondence between the slaves and the allocated processes. In the priority order table 34, the to-be-allocated processes and priority levels for the to-be-allocated processes are previously set (e.g., “High” and “Low”).

The master 2 transmits processing programs, processing data, etc. in relation to the allocated processes to the slaves 7-1, 7-2, etc. to which the to-be-allocated processes have been allocated, to thereby distribute the processes (steps 3406).

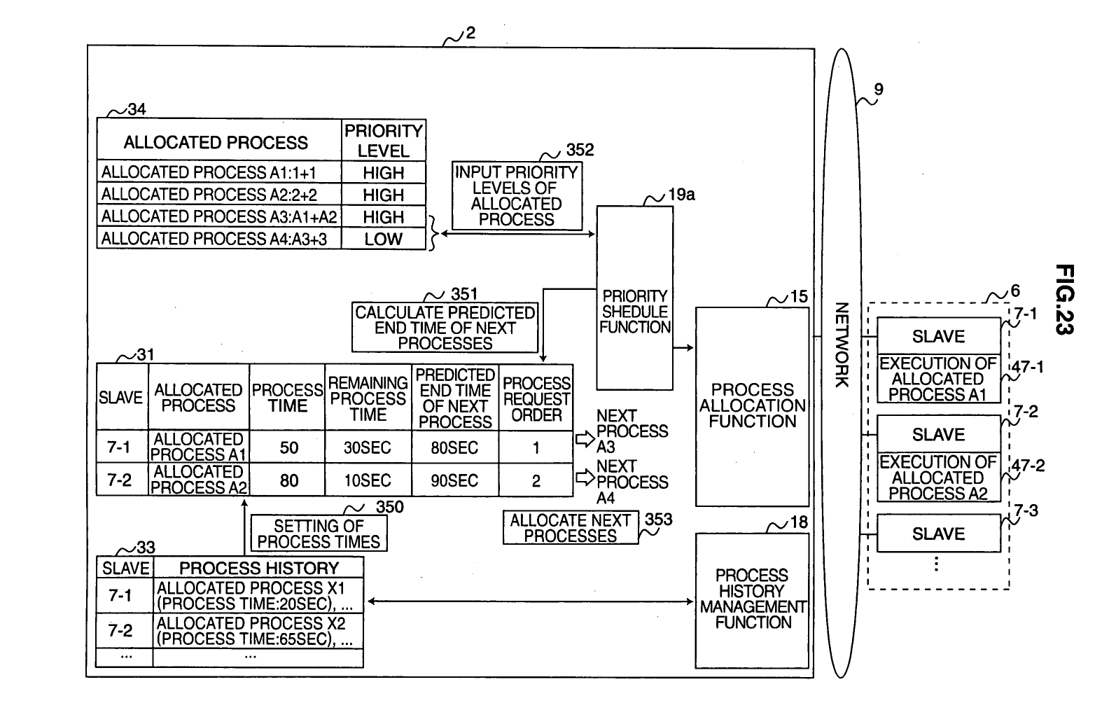

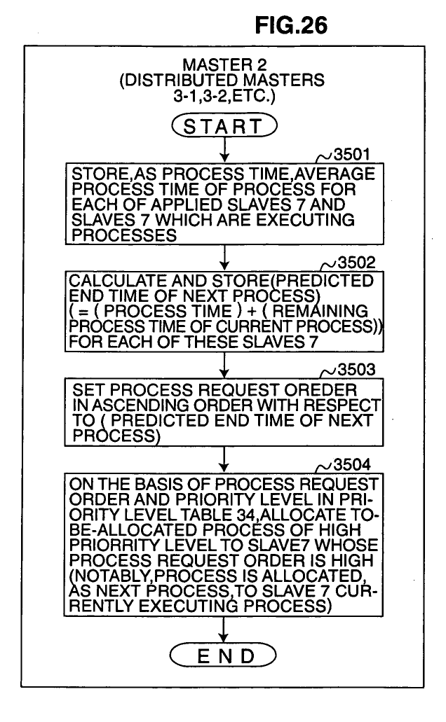

Next, the processing in relation to the priority schedule function 19a in step 3405 will be described in detail with reference to FIGS. 23 and 26.

FIG. 23 is a diagram schematically showing the processing in relation to the process allocation function 15, the process history management function 18, the priority schedule function 19a, etc.

FIG. 26 is a flowchart showing the steps of the processing in relation to the priority schedule function 19a.

For each of the slaves 7 having applied for participation and the slaves 7 executing processes, the master 2 stores, as a process time, the average process time of the corresponding process (step 3501).

As shown in FIG. 23, for each of the slaves 7 having applied for participation, including the slaves 7-1 and 7-2 currently executing processes, the master 2 determines a processing capacity, for example, with reference to a process history table 33 (process record, process time, average process time, etc. for each slave 7), or on the basis of the CPU capacity, memory quantity, etc. of each slave 7, which have been entered on the basis of results of a previous investigation. Subsequently, the master 2 determines a average process time, and records it, as a process time, in the process allocation table 31 at a corresponding location (step 350).

For each slave 7, the master 2 calculates and stores a predicted end time of a next process (the predicted end time=(the process time)+(the remaining process time of the current process)) (step 3502).

In the example shown in FIG. 23, a predicted end time of the next process of the slave 7-1, which is executing the allocated process A1, is calculated to be 80 seconds (=50 seconds (the process time)+30 seconds (the remaining process time of the current process)) (step 351). That is, the slave 7-1 will end the current process (allocated process A1) after 30 seconds, and will end the next process after 80 seconds if such a next process is allocated to the slave. Similarly, a predicted end time of the next process of the slave 7-2, which is executing the allocated process A2 is calculated to be 90 seconds (=80 seconds (the process time)+10 seconds (the remaining process time of the current process)) (step 351). That is, the slave 7-2 will end the current process (allocated process A2) after 10 seconds, and will end the next process after 90 seconds if such a next process is allocated to the slave.

On the basis of the predicted end times of the next process, the master 2 sets process request orders in ascending order with respect to the predicted end times of the next processes (step 3503).

In the example of FIG. 23, the predicted end time of the next process of the slave 7-1 is 80 seconds in the future, and the predicted end time of the next process of the slave 7-2 is 90 seconds in the future. Therefore, a process request order #1 is set for the slave 7-1, and a process request order #2 is set for the slave 7-2.

On the basis of the process request orders, and the priority levels of the allocated processes stored in the priority order table 34, the master 2 allocates a to-be-allocated process of a higher priority level to a slave 7 having a higher process request order (step 3504). Notably, for a slave 7 which is executing a process, the to-be-allocated process is allocated as a next process.

As shown in FIG. 23, priority levels of the priority order table 34 are previously input (step 352). Subsequently, in accordance with the process request orders and the priority levels, a to-be-allocated process A3 (priority level: High) is allocated, as a next process, to the slave 7-1 (process request order: #1), and a to-be-allocated process A4 (priority level: Low) is allocated, as a next process, to the slave 7-2 (process request order: #2) (step 353).

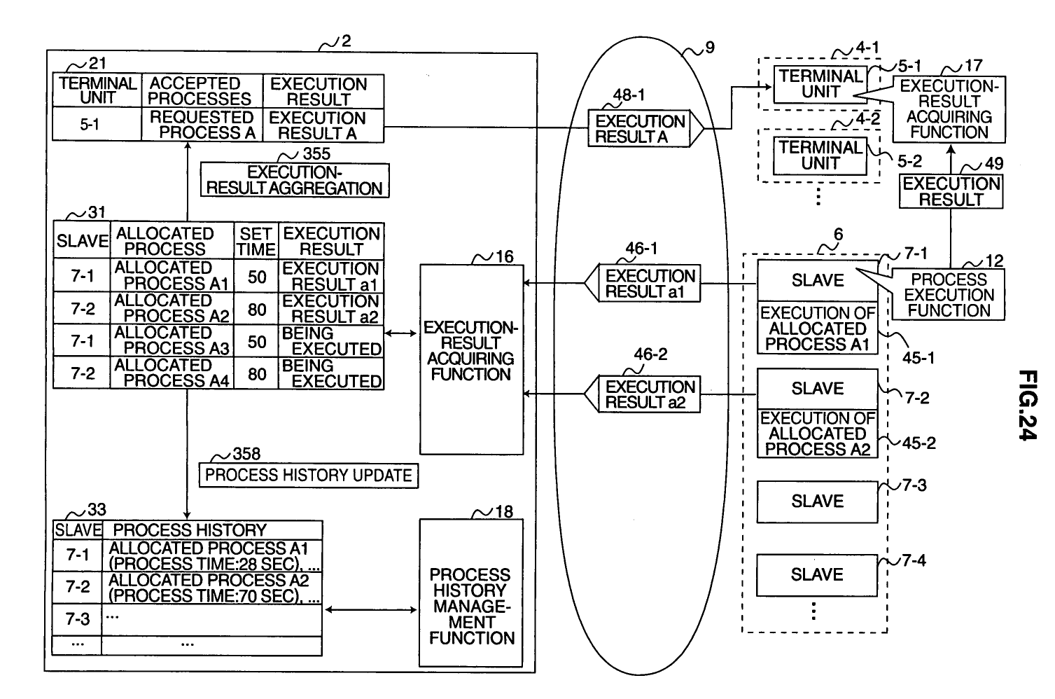

FIG. 24 is a diagram schematically showing the processing in relation to the process executing function 12, the execution-result acquiring function 16, the execution-result acquiring function 17, the process history management function 18, etc.

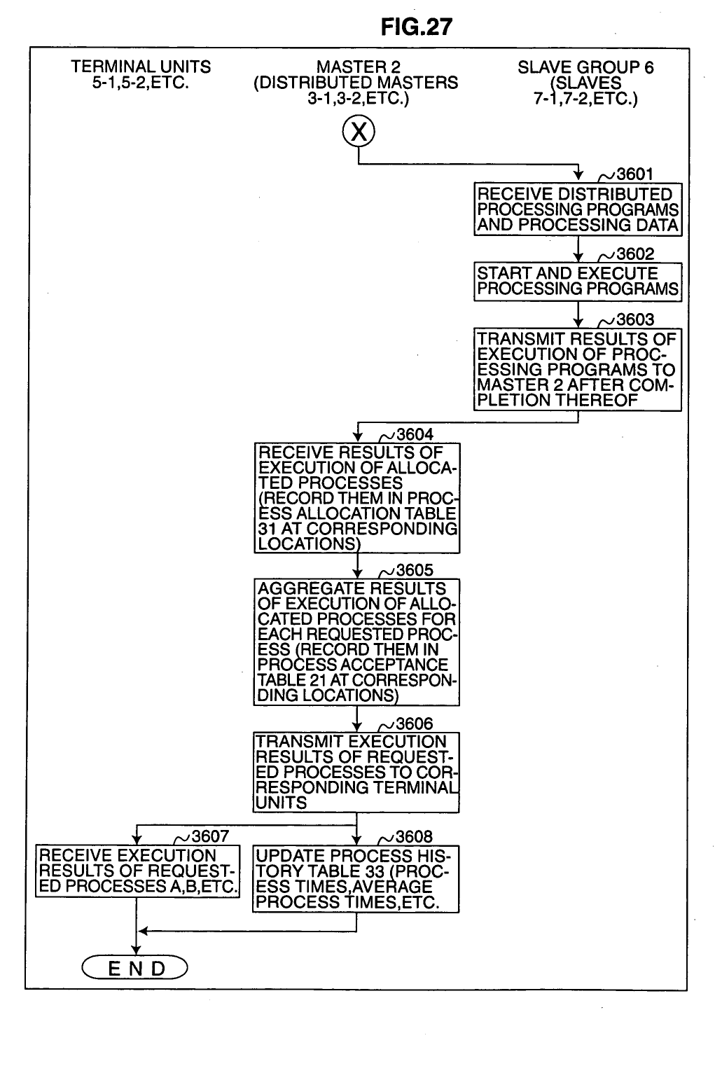

FIG. 27 is a flowchart showing the steps of the processing in relation to the process executing function 12, the execution-result acquiring function 16, the execution-result acquiring function 17, the process history management function 18, etc.

In FIG. 27, the processes in steps 3601 to 3606 are the same as those in steps 501 to 506 of FIG. 5.

The master 2 updates the process history table 33 which includes a history of process allocation, a history of processes performed in the slaves 7-1, 7-2, etc. of the slave group 6 (type of allocated process, process start date/time, process end date/time, etc.), and information (process record, process time, average process time, etc.) derived from the process history (step 3608).

In the example shown in FIG. 24, when the master 2 receives the execution results from the slaves 7-1, 7-2, and 7-4, the master 2 updates the process histories corresponding to these slaves in the process history table 33 (step 358).

When the master 2 ends the parallel processing, the master 2 sends an end instruction to the slaves 7-1, 7-2, etc. having applied for participation. Upon receipt of the end instruction, the slaves 7-1, 7-2, etc. end the application for participation, execution of the allocated process, etc.

As described above, according to the sixth embodiment, on the basis of the priority order table 34, which contains priority levels to be assigned to processes, the master 2 preferentially allocates and transmits a process of a higher priority level to a processing terminal unit whose predicted end time of the process is earlier than that of the other terminal unit(s), and causes the processing terminal unit to execute the process. Moreover, the master 2 holds a process history, etc. of each slave 7, and determines a processing capacity for each slave 7 with reference to the process history, etc. Alternatively, the master 2 determines a processing capacity for each slave 7 in accordance with previously input information regarding the CPU capacity, memory quantity, etc. of each slave 7. Subsequently, the maser 2 sets a process time in accordance with the processing capacity.

Accordingly, a process of high priority level can be preferentially scheduled to a slave 7 (processing terminal unit), whereby the processing speed can be increased.

Next, a seventh embodiment of the present invention will be described.

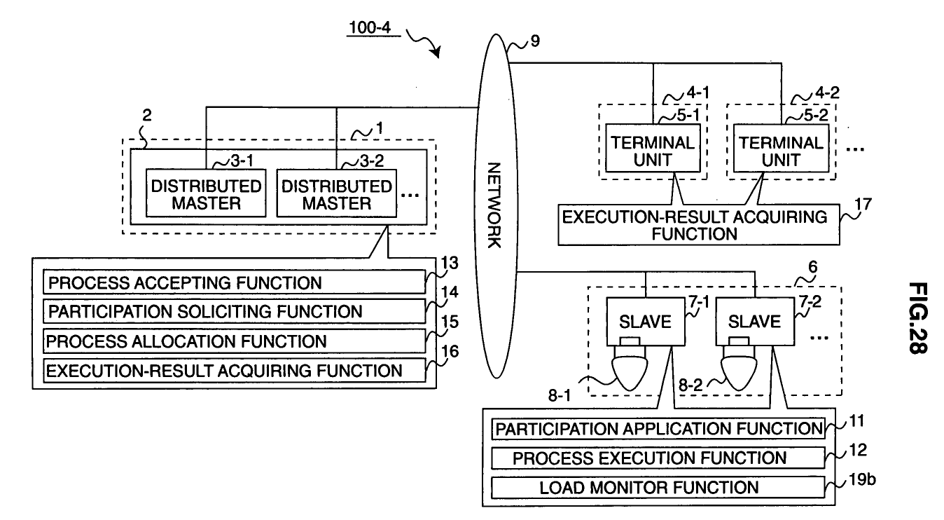

FIG. 28 is a diagram schematically showing the configuration of a parallel processing system 100-4 according to the seventh embodiment of the present invention.

In the present embodiment, each of the slaves 7-1, 7-2, etc. (or external memories) includes a participation application function 11, a process executing function 12, and a load monitor function 19b.

The load monitor function 19b monitors the current load (e.g., the load ratio of the CPU) of the corresponding slave 7, and determines whether the slave 7 can participate in parallel processing.

Next, the processing steps of the parallel processing system 100-4 will be described.

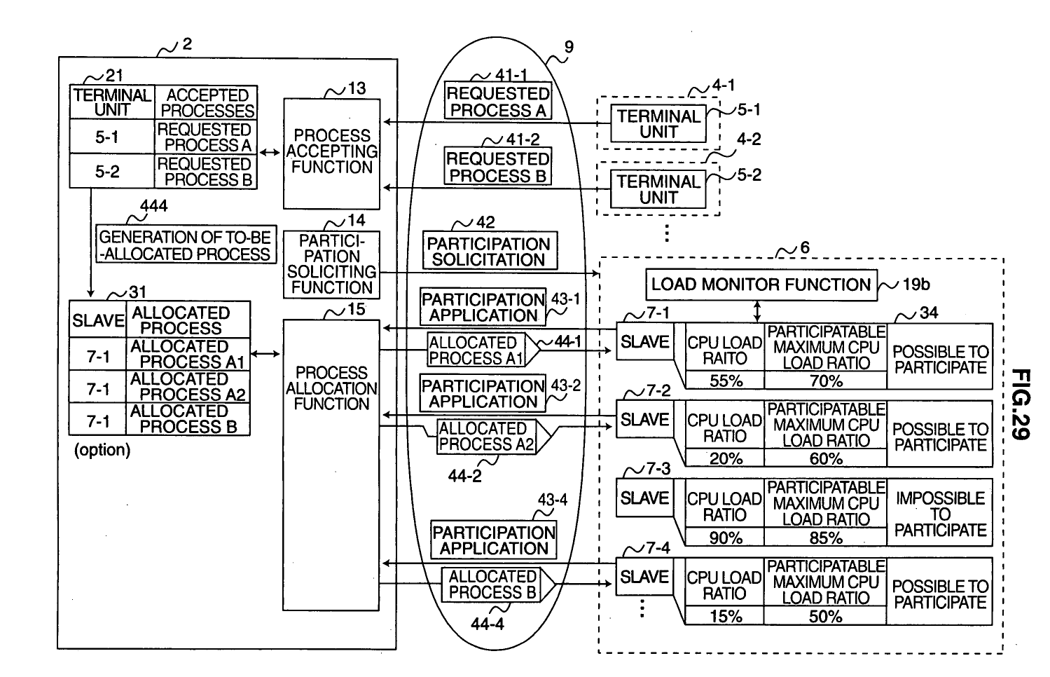

FIG. 29 is a diagram schematically showing the processing in relation to the process accepting function 13, the participation soliciting function 14, the process allocation function 15, the participation application function 11, the load monitor function 19b, etc.

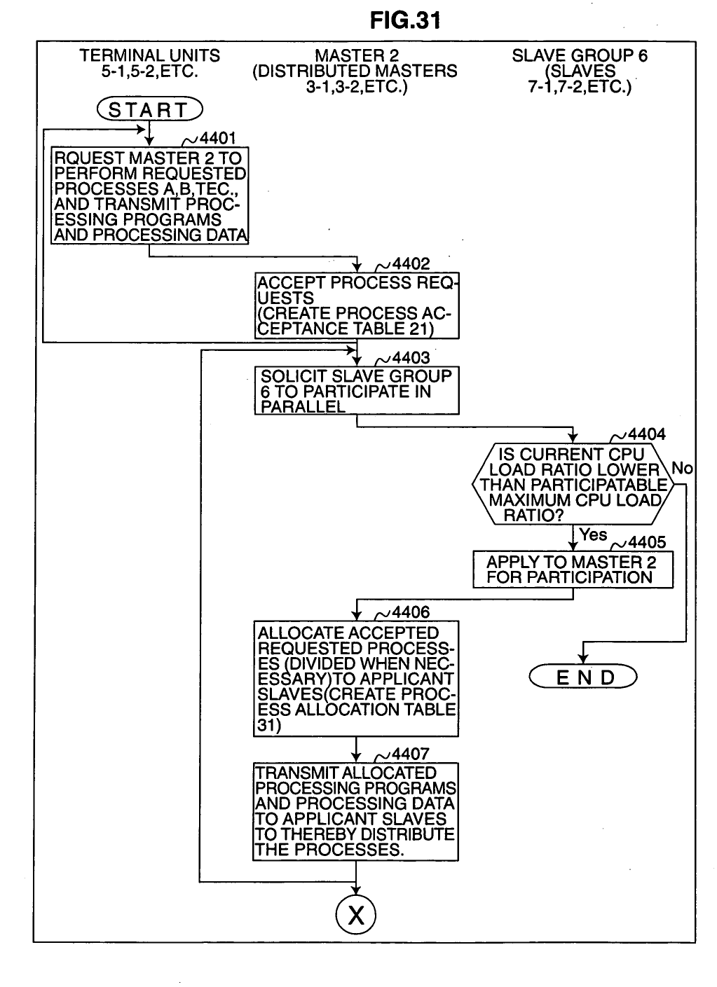

FIG. 31 is a flowchart showing the steps of the processing in relation to the process accepting function 13, the participation soliciting function 14, the process allocation function 15, the participation application function 11, the load monitor function 19b, etc.

In FIG. 31, the processes in steps 4401 to 4403 are the same as those in steps 401 to 403 of FIG. 4.

The slave 7 (or its external memory) may store a processing program and processing data in relation to the process executing function 12, along with the participation application function 11, the load monitor function 19, etc. In this case, the terminal units 5-1, 5-2, etc. merely request the master 2 to process requested processes A, B, etc. without transmitting the processing program and processing data. Alternatively, the slave 7 (or its external memory) may store portions of a processing program and processing data in relation to the process executing function 12, along with the participation application function 11, the load monitor function 19, etc. In this case, the terminal units 5-1, 5-2, etc. transmit the remaining portions of the processing program and processing data to the master 2 when the terminal units 5-1, 5-2, etc. request the master 2 to process requested processes A, B, etc.

Each of the slaves 7-1, 7-2, etc. determines, on the basis of its load, operating state, etc., whether sufficient resources remain to participate in the parallel processing (step 4404). Each of the slaves 7-1, 7-2, etc. monitors, at all times, or at a predetermined timing, the load (CPU load ratio or the like) of the slave itself, and determines, on the basis of the load, whether the slave can participate in the parallel processing. When the slave 7 can participate in the parallel processing (Yes in step 4404), the slave 7 responds to the master 2 so as to apply for the participation (step 4405).

As shown in FIG. 29, each of the slaves 7-1, 7-2, etc. holds a load status table 34 in which a CPU load ratio, a participatable maximum CPU load ratio, possible or impossible to participate, etc. are recorded. The CPU load ratio indicates the CPU load ratio at the present point in time in the slave 7-1, 7-2, etc. The participatable maximum CPU load ratio indicates a limit of CPU load ratio under which the slave can participate in parallel processing.

In response to an inquiry from the master 2 regarding participation in parallel processing (step 42), each of the slaves 7-1, 7-2, etc. determines whether to apply for participation, with reference to the load state table 34.

Since the CPU load ratio of each of the slaves 7-1, 7-2, and 7-4 is not greater than the participatable maximum CPU load ratio (Yes in step 4404), these slaves apply for participation, in response to the inquiry from the master 2 regarding participation (steps 43-1, 43-2, 43-4).

Since the CPU load ratio of the slave 7-3 is greater than the participatable maximum CPU load ratio (No in step 4404), this slave does not apply for participation, in response to the inquiry from the master 2 regarding participation.

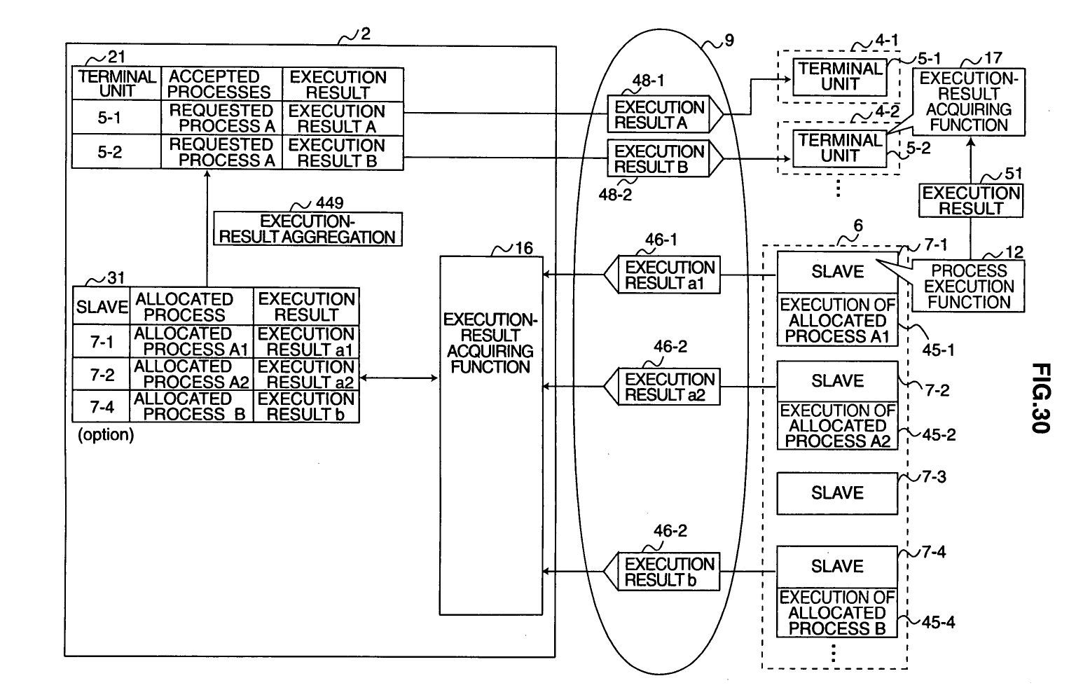

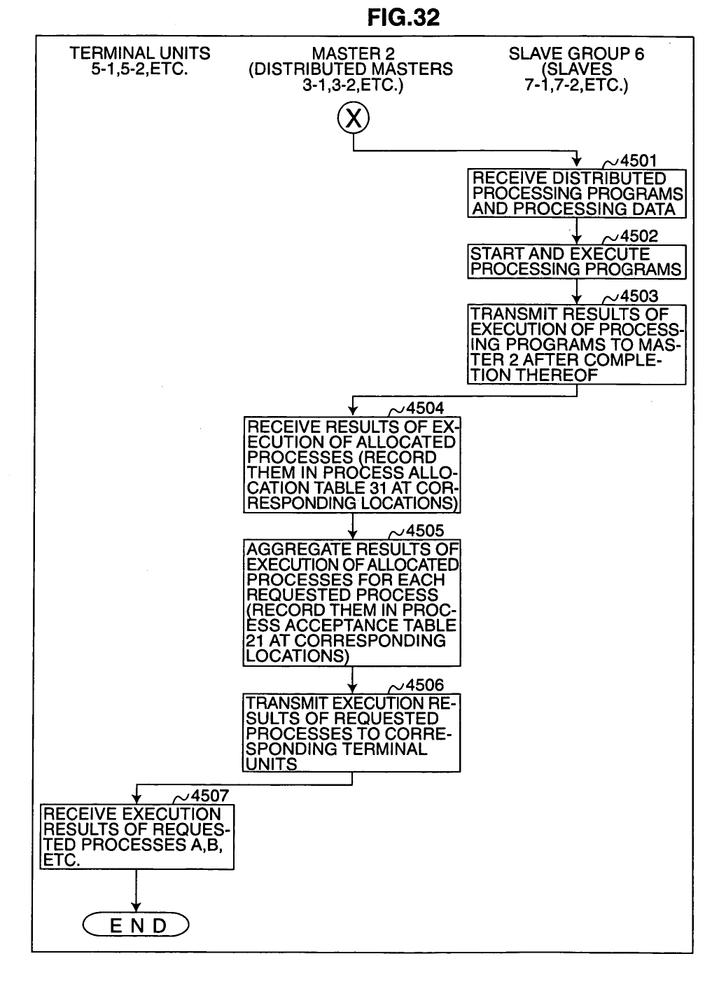

FIG. 30 is a diagram schematically showing the processing in relation to the process executing function 12, the execution-result acquiring function 16, the execution-result acquiring function 17, etc. FIG. 32 is a flowchart showing the steps of the processing in relation to the process executing function 12, the execution-result acquiring function 16, the execution-result acquiring function 17, etc. Since the processing of FIG. 32 is similar to that of FIG. 5, its description is omitted.

As described above, according to the seventh embodiment of the present invention, in response to a request for processing (requested process) from the terminal unit 5 of each requester 4, the master 2 solicits, by means of broadcast communication, the entire slave group 6 to participate in parallel processing.

Each slave 7 monitors the load (e.g., CPU load ratio) of itself. When the slave is solicited to participation in parallel processing, the slave 7 responds to the master 2 so as to apply for the participation if the load is not greater than the predetermined load.

The master 2 allocates the process to the slaves 7 having applied for participation and transmits the allocated processes. The slaves 7 execute allocated processes received from the master 2. After completion of execution of the processes, the slaves 7 send the execution results to the master 2 or the terminal unit 5 of the requester 4. The master 2 or the terminal unit 5 receives the execution results.

As described above, when necessary the master 2 (server) solicits participation in parallel processing, and each slave 7 (processing terminal unit) participates in the parallel processing in accordance with its load, operating state, and the like. Therefore, the master 2 does not need to manage the load, operating states, and the like of the slaves 7, and can realize efficient, high-speed parallel processing by allocating the processes to the slaves 7 having applied for participation. Accordingly, the slaves 7 can participate in parallel processing in the middle of the parallel processing.

Moreover, the slave 7 (processing terminal unit) participates in the parallel processing in accordance with its load, such as CPU load ratio. Therefore, even a single unit of the slave 7 (processing terminal unit) can concurrently execute a plurality of processes allocated by a single or a plurality of masters (multi-task).

Notably, the above-described participatable maximum CPU load ratio may be set to be constant for all the slaves 7 or may be determined for each individual slave 7 in accordance with the processing capacity thereof.

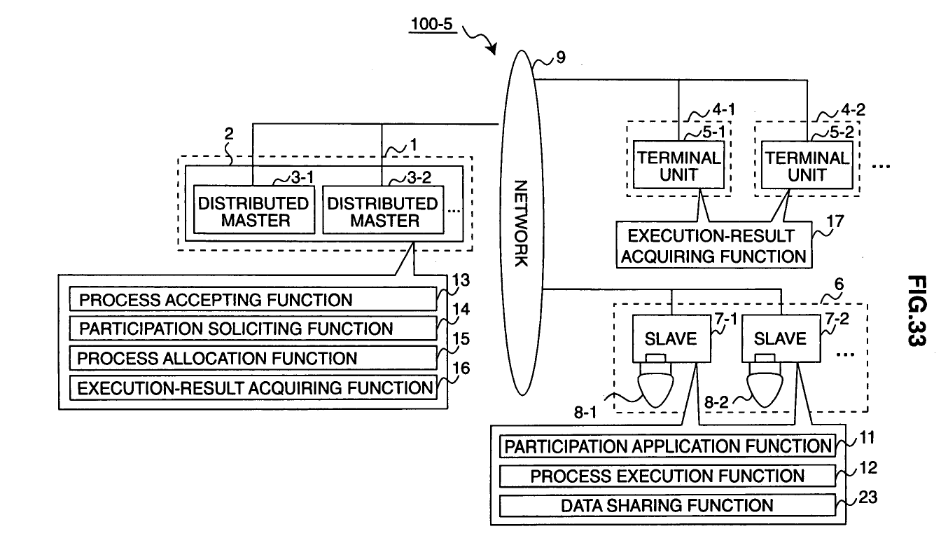

Next, an eighth embodiment of the present invention will be described. FIG. 33 is a diagram schematically showing the configuration of a parallel processing system 100-5 according to the eighth embodiment of the present invention.

In the present embodiment, each of the slaves 7-1, 7-2, etc. (or external memories) includes a participation application function 11, a process executing function 12, and a data sharing function 23, etc.

The data sharing function 23 enables the slaves 7 to exchange shared data therebetween by means of broadcast communication.

Next, the processing steps of the parallel processing system 100-5 will be described.

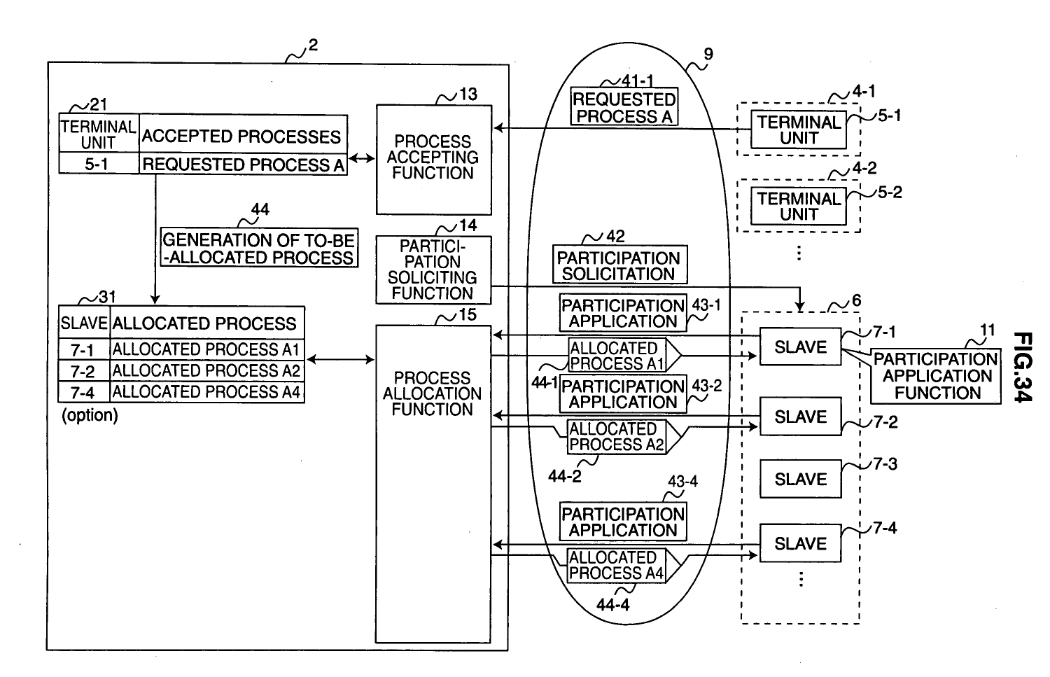

FIG. 34 is a diagram schematically showing the processing in relation to the process accepting function 13, the participation soliciting function 14, the process allocation function 15, the participation application function 11, etc.

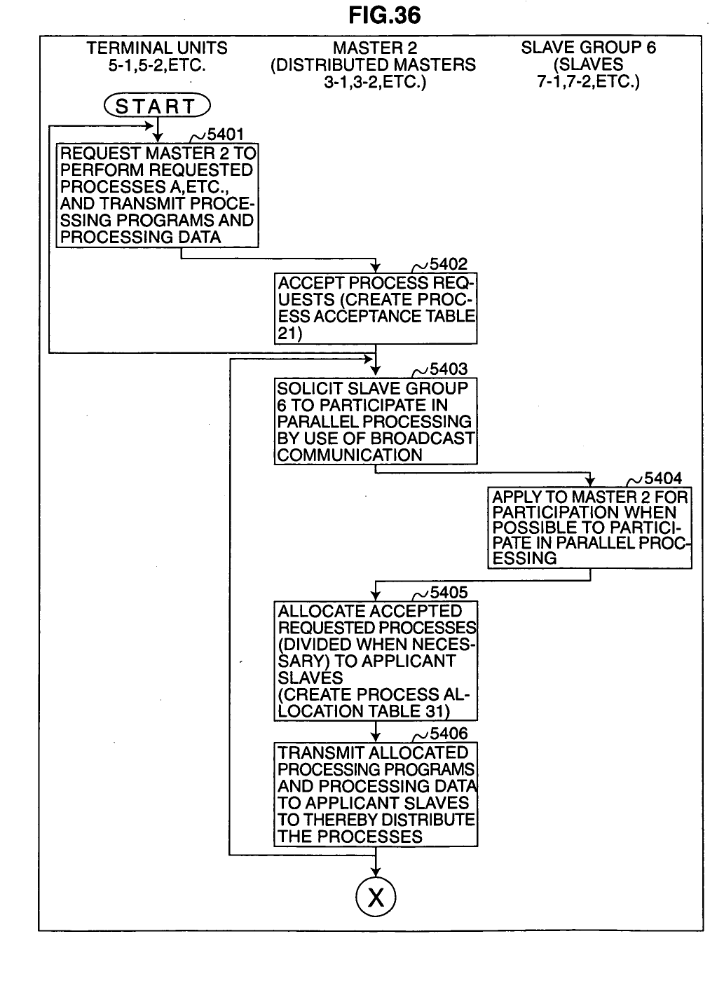

FIG. 36 is a flowchart showing the steps of the processing in relation to the process accepting function 13, the participation soliciting function 14, the process allocation function 15, the participation application function 11, etc.

Since the processing of FIG. 36 is similar to that of FIG. 4, its description is omitted.

The slave 7 (or its external memory) may store a processing program and processing data in relation to the process executing function 12, along with the participation application function 11, the data sharing function 23. In this case, the terminal units 5-1, 5-2, etc. merely request the master 2 to process requested processes A, B, etc. without transmitting the processing program and processing data. Alternatively, the slave 7 (or its external memory) may store portions of a processing program and processing data in relation to the process executing function 12, along with the participation application function 11, the data sharing function 23, etc. In this case, the terminal units 5-1, 5-2, etc. transmit the remaining portions of the processing program and processing data to the master 2 when the terminal units 5-1, 5-2, etc. request the master 2 to process requested processes A, etc.

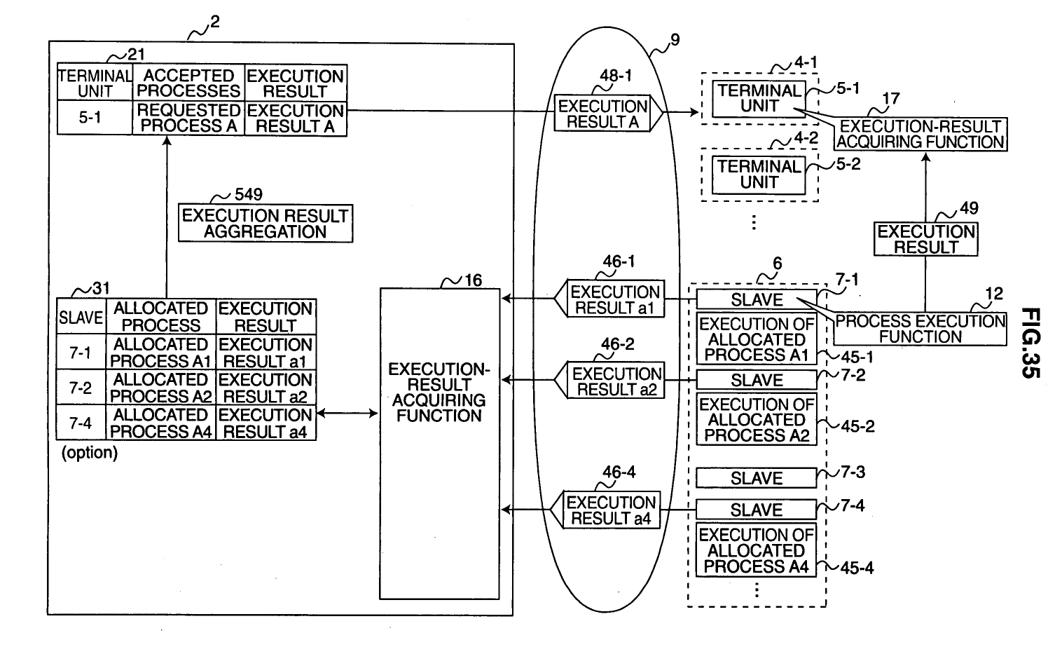

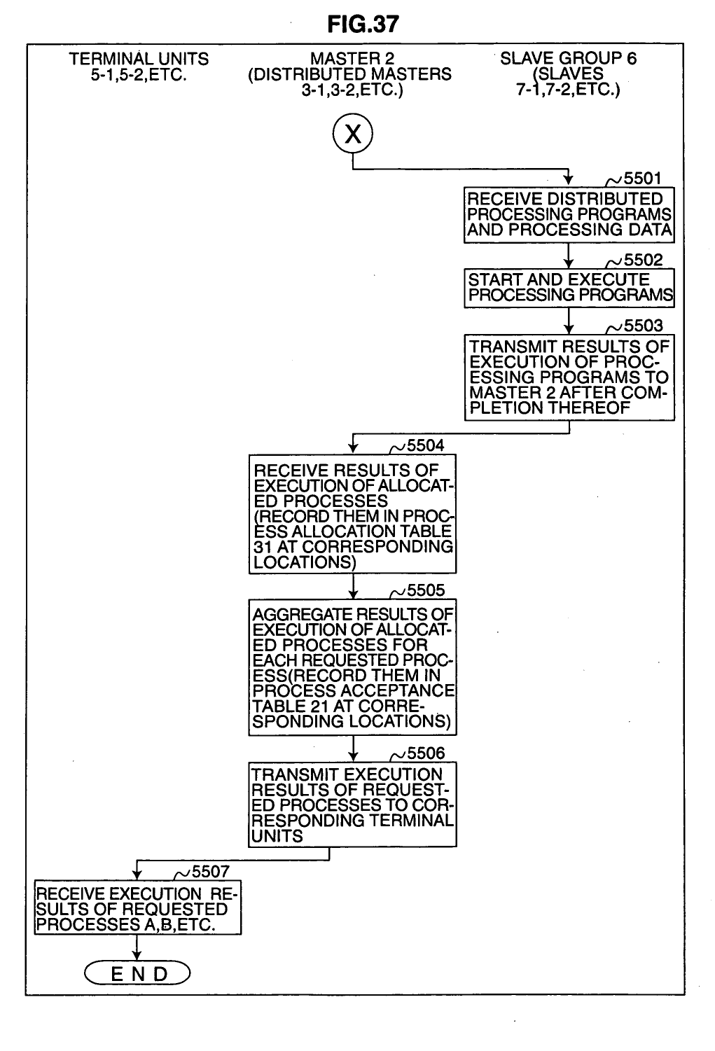

FIG. 35 is a diagram schematically showing the processing in relation to the process executing function 12, the execution-result acquiring function 16, the execution-result acquiring function 17, etc. FIG. 37 is a flowchart showing the steps of the processing in relation to the process executing function 12, the execution-result acquiring function 16, the execution-result acquiring function 17, etc. Since the processing of FIG. 37 is similar to that of FIG. 5, its description is omitted.

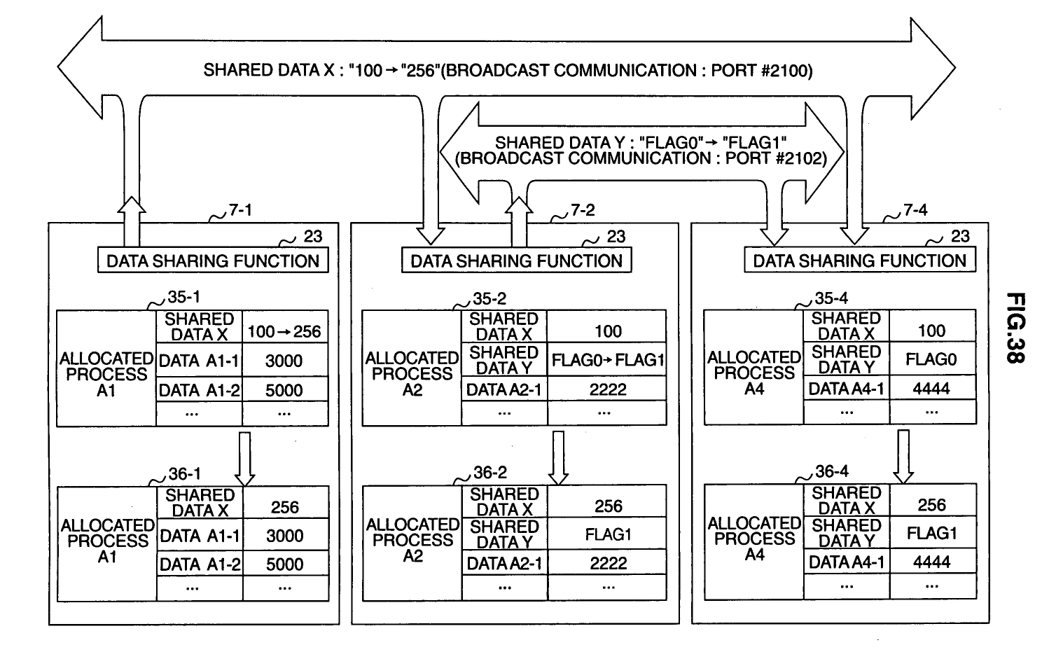

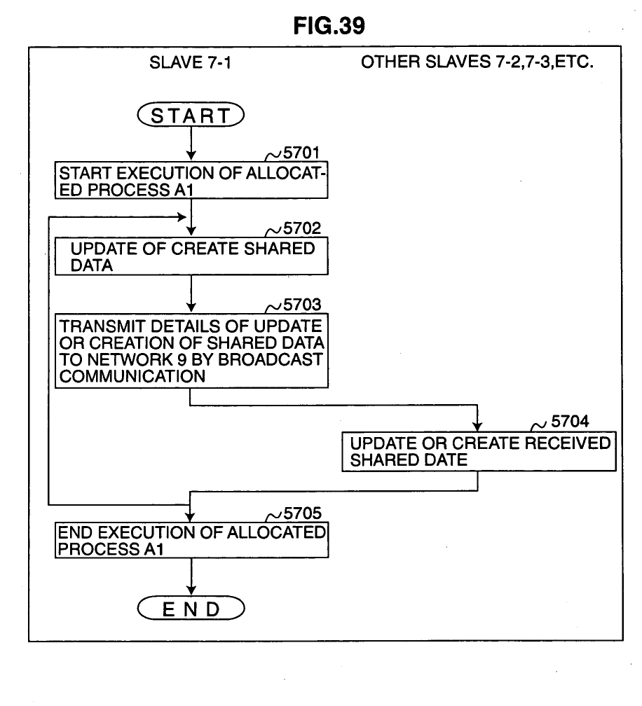

Next, processing in relation to the process executing function 12, the data sharing function 23, etc. of the slaves 7-1, 7-2, etc. will be described with reference to FIGS. 38 and 39.

FIG. 38 is a diagram schematically showing the processing in relation to the process executing function 12, the data sharing function 23, etc.

FIG. 39 is a flowchart showing the steps of the processing in relation to the process executing function 12, the data sharing function 23, etc.

The slave 7-1 starts a received processing program so as to execute the allocated process (step 5701). Similarly, the slaves 7-2 and 7-4 start received processing programs so as to execute the allocated processes.

In the example shown in FIG. 35, the slaves 7-1, 7-2, and 7-4 start processing programs A1, A2, and A4, respectively, to thereby execute the allocated processes A1, A2, and A4 (steps 47-1, 47-2, and 47-4).

The slave 7-1 updates or creates shared data during execution of the allocated process A1 (step 5702). The shared data may be processing data or computation results of the processing program.

In the example shown in FIG. 38, during execution of the allocated process A1, the slave 7-1 updates the shared data X in a memory table 35-1, which stores processing data, computation results of the processing program, etc., from “100” to “256,” whereby the shared data X in the updated memory table 36-1 becomes “256.”

The slave 7-1 sends out the details of update or creation of the shared data, etc. to the network 9 by means of broadcast communication (step 5703).

In the example shown in FIG. 38, when the slave 7-1 transmits the shared data X to the other slaves 7-2, etc., the slave 7-1 adds a previously-set destination port number 2100 to the shared data X (“100”→“256”), and then sends out the shared data X to the network 9 by means of broadcast communication.

The other slaves 7-2, etc. updates or creates the received, shared data (step 5704).

In the example shown in FIG. 38, a port #2100 is set in each of the slaves 7-2, 7-3, and 7-4. Therefore, the slaves 7-2 and 7-4, which are executing processes, receive the shared data X (“100”→“256”) (destination port number: 2100), and update the shared data X “100” in their memory tables 35-2 and 35-4, whereby the shared data X in their updated memory tables 36-2 and 36-4 become “256.”

When the slave 7-1 changes the value of the shared data during execution of the allocated process A1, the slave 7-1 performs the processes in steps 5702 and 5703 if necessary.

Moreover, the slave 7-1 can execute the process of updating or creating the shared data received from the other slaves 7-2, 7-3, etc., which process corresponds to that in step 5704 performed in the other slaves 7-2, 7-3, etc., independently of and in parallel with the execution of the allocated process A1 and the processes in steps 5702 and 5703.

In the example shown in FIG. 38, the slave 7-2 receives the shared data X and updates its memory table 35-2 during the execution of the allocated process A2. In parallel with this process, the slave 7-2 changes shared data Y from “FLAG0” to “FLAG1” on the basis of, for example, a calculation result produced during the execution of the allocated process A2. In such a case, the slave 7-2 sends out the shared data Y (“FLAG0”→“FLAG1”) by means of broadcast communication.

Notably, port numbers used in the broadcast communication are set in accordance with the effective range of shared data of the processing programs for parallel processing. Each slave 7 adds one of the port numbers to shared data, and sends out the shared data to the network 9 by means of broadcast communication. Thus, data exchange between the slaves 7 is enabled within the effective range of the shared data for parallel processing.

In the example shown in FIG. 38, the shared data X are data to be shared among all the processing programs for the parallel processing, and the port number 2100 is added to the shared data X for broadcast data communication among all the slaves 7. The shared data Y are data to be shared between the processing programs for the allocated process A2 and A4, and the port number 2102 is added to the shared data Y for broadcast data communication between the slaves 7-2 and 7-4.

As described above, according to the eighth embodiment, when each of the slaves 7-1, 7-2, etc. updates or crates shared data, such as processing data and calculation results of a processing program for parallel processing, the slave sends out the shared data to other slaves 7 by means of broadcast communication. Further, each of the slaves 7 updates or crates shared data received from other slaves 7. This operation enables sharing of data among the slaves 7. Furthermore, use of broadcast communication enables data transmission to be performed through a single communication operation, whereby high speed parallel processing can be realized.

Next, a ninth embodiment of the present invention will be described.

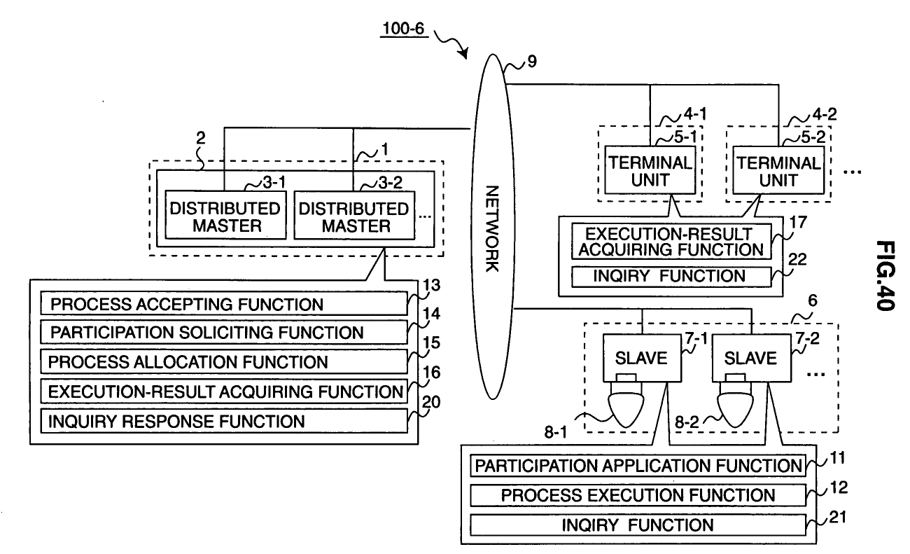

FIG. 40 is a diagram schematically showing the configuration of a parallel processing system 100-6 according to the ninth embodiment of the present invention.

The master 2 has a process accepting function 13, a participation soliciting function 14, a process allocation function 15, an execution-result acquiring function 16, an inquiry response function 20, etc.

The inquiry response function 20 responds to an inquiry which is issued from a terminal unit 5 or slave 7 in relation to processing status, calculation result, or the like.

Each of the terminal units 5-1, 5-2, etc. has an execution-result acquiring function 17 for requesting, via the network 9, the master 2 to execute a process, and for receiving and acquiring the results of execution of the process from the slave group 6, an inquiry function 22 for inquiring, for example, the status of a process requested to the master 2, and other functions.

Each of the slaves 7-1, 7-2, etc. (or external memories) has a participation application function 11, a process executing function 12, an inquiry function 21, etc.

When a slave (processing terminal unit) requires calculation results, data, etc. in other processing terminal units, for example, during execution of an allocated process, the inquiry function 21 inquires of the master 2 about the necessary calculation results, data, etc.

Next, the processing steps of the parallel processing system 100-6 will be described.

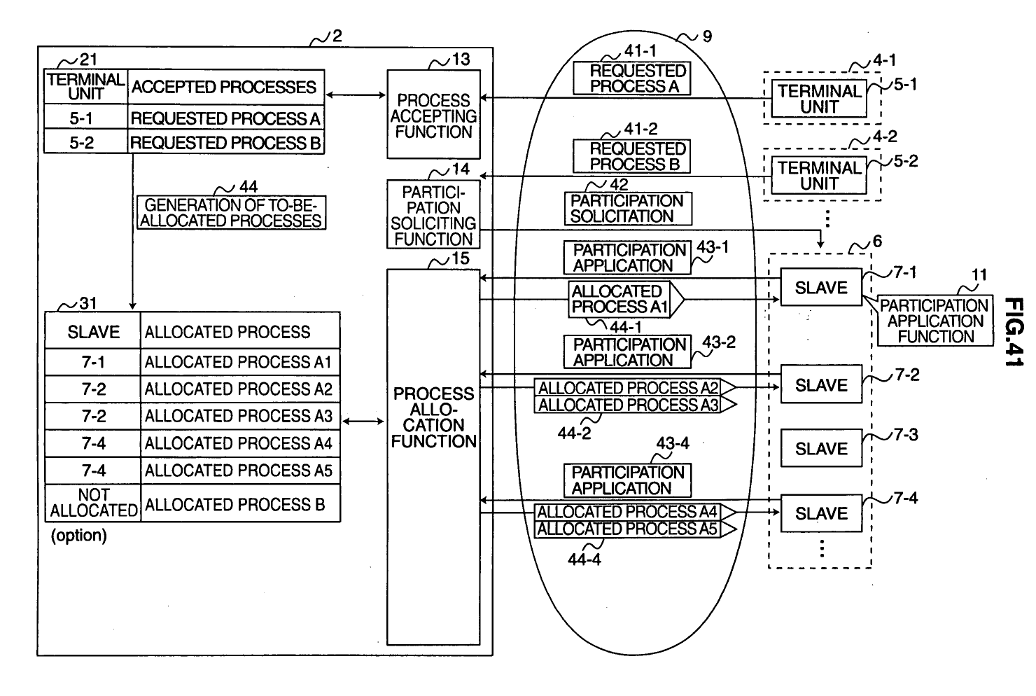

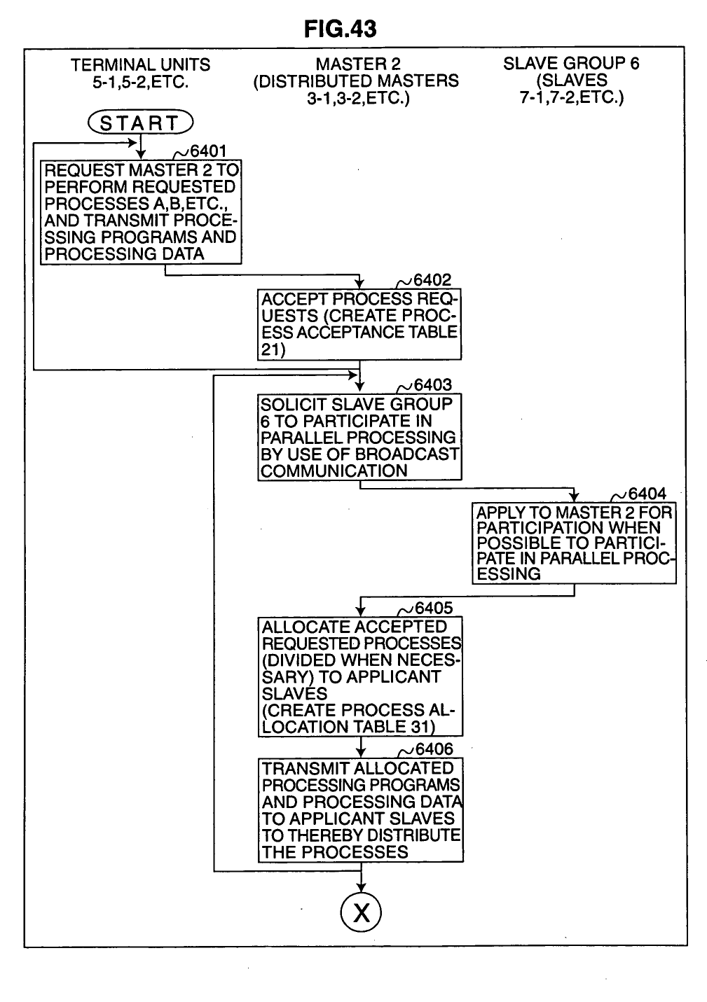

FIG. 41 is a diagram schematically showing the processing in relation to the process accepting function 13, the participation soliciting function 14, the process allocation function 15, the participation application function 11, etc. FIG. 43 is a flowchart showing the steps of the processing in relation to the process accepting function 13, the participation soliciting function 14, the process allocation function 15, the participation application function 11, etc. Since the processing of FIG. 43 is similar to that of FIG. 4, its description is omitted.

The slave 7 (or its external memory) may store a processing program and processing data in relation to the process executing function 12, along with the participation application function 11, the inquiry function 21, etc. In this case, the terminal units 5-1, 5-2, etc. merely request the master 2 to process requested processes A, B, etc. without transmitting the processing program and processing data. Alternatively, the slave 7 (or its external memory) may store portions of a processing program and processing data in relation to the process executing function 12, along with the participation application function 11, the inquiry function 21, etc. In this case, the terminal units 5-1, 5-2, etc. transmit the remaining portions of the processing program and processing data to the master 2 when the terminal units 5-1, 5-2, etc. request the master 2 to process requested processes A, B, etc.

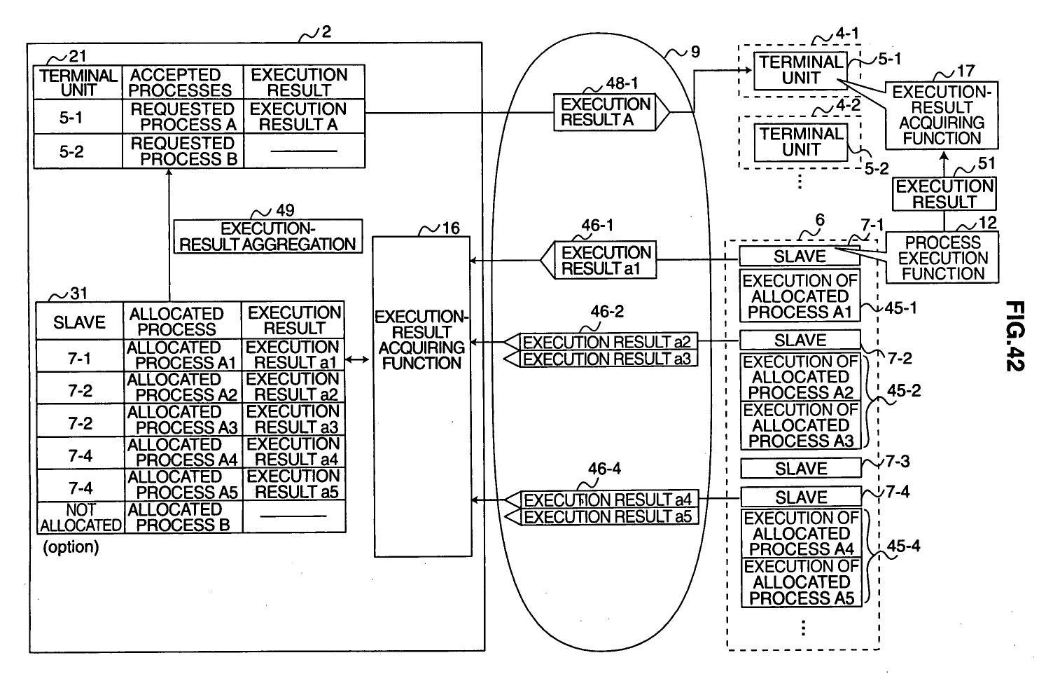

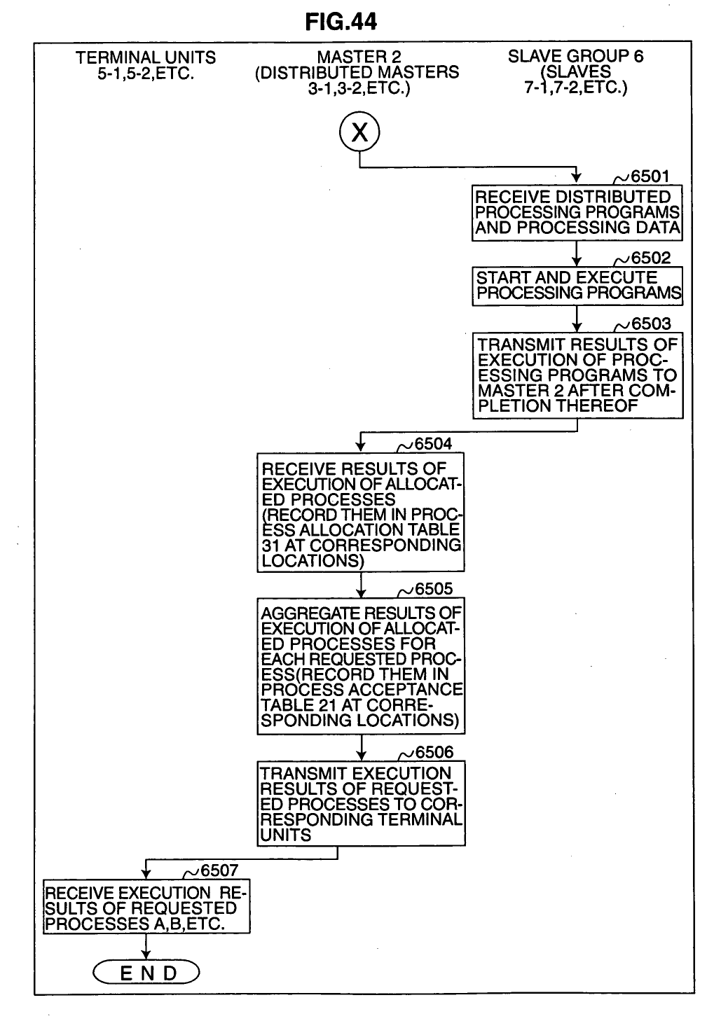

FIG. 42 is a diagram schematically showing the processing in relation to the process executing function 12, the execution-result acquiring function 16, the execution-result acquiring function 17, etc. FIG. 44 is a flowchart showing the steps of the processing in relation to the process executing function 12, the execution-result acquiring function 16, the execution-result acquiring function 17, etc. Since the processing of FIG. 44 is similar to that of FIG. 5, its description is omitted.

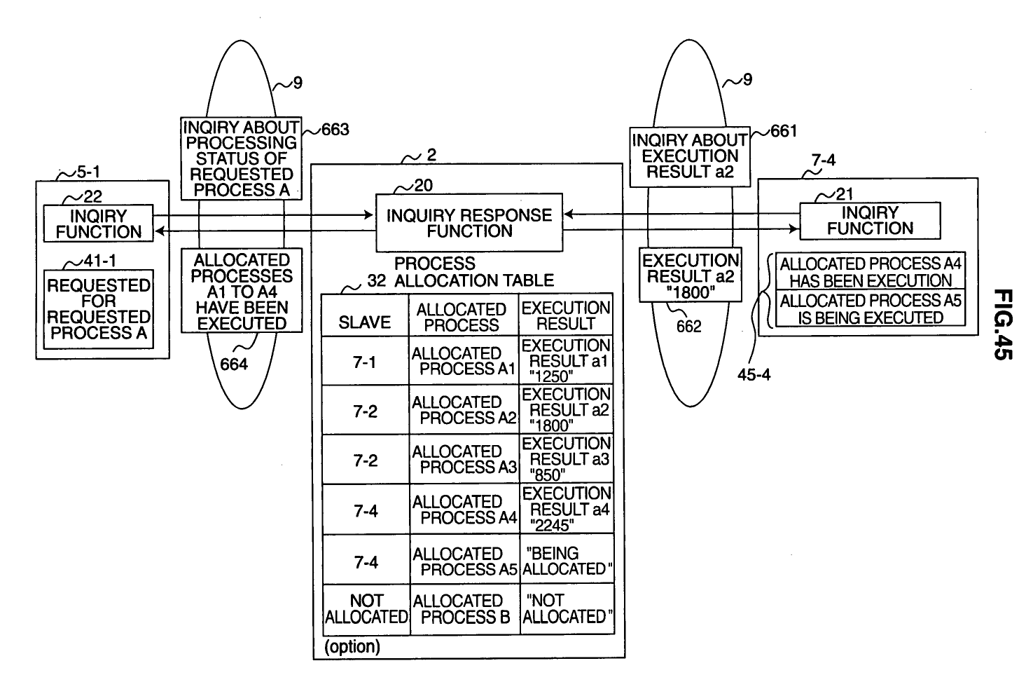

Next, processing in relation to the inquiry response function 20 of the master 2, the inquiry function 21 of the slaves 7-1, 7-2, etc., and the inquiry function 22 of the terminal units 5-1, 5-2, etc. will be described with reference to FIGS. 45 to 47.

FIG. 45 is a diagram schematically showing the processing for the inquiry response function 20, the inquiry function 21, the inquiry function 22, etc.

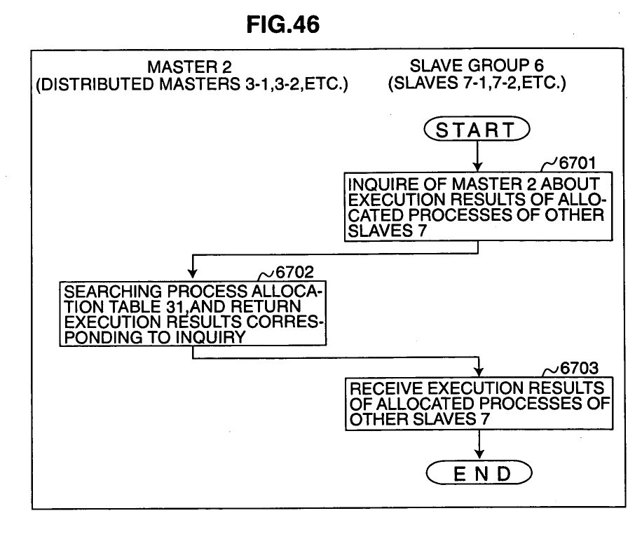

FIG. 46 is a flowchart showing the steps of the processing for the inquiry response function 20, the inquiry function 21, etc.

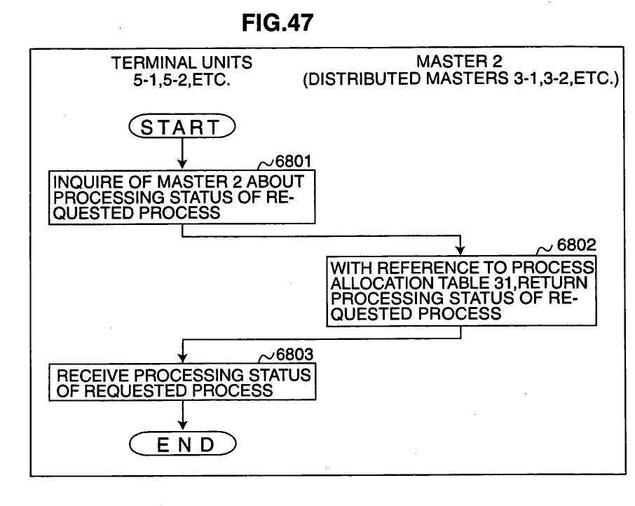

FIG. 47 is a flowchart showing the steps of the processing for the inquiry response function 20, the inquiry function 22, etc.

Each of the slaves 7 may require, during execution of a process allocated thereto, execution results, calculation results, data, etc. in relation to processes allocated to other slaves 7 (hereinafter referred to as “necessary information”). In such a case, the slave 7 inquires of the master 2 about the necessary information (step 6701).

The master 2 extracts necessary information corresponding to the inquiry by referring to and searching the process allocation table 31, and sends the extracted necessary information back to the slave 7 having made the inquiry (step 6702).

The slave 7 having made the inquiry obtains the necessary information, and continues the allocated process by use of the necessary information (step 6703).

Notably, the inquiry (step 6701) and the response to the inquiry (step 6702) can be performed by means of broadcast communication.

In the example shown in FIG. 45, the slave 7-4 requires, during execution of a process A5 allocated thereto (step 45-4), the execution result a2 of a process A2 executed by the slave 7-2. In such a case, the slave 7-4 inquires of the master 2 about the execution result a2 (step 661). The master 2 extracts the execution result a2 “1800” by referring to and searching the process allocation table 32, and sends the execution result a2 to the slave 7-4 (step 662).

One of the terminal units 5 inquires of the master 2 about the processing status of a process that the terminal has requested (step 6801).

The master 2 returns the processing status of the requested process corresponding to the inquiry, with reference to the process allocation table 32 (step 6802) The terminal unit 5 having made the inquiry obtains the processing status of the requested process (step 6803).

In the example shown in FIG. 45, the terminal 5-1, which has requested the master 2 to perform the requested process A (step 41-1), inquires of the master 2 about the processing status of the requested process A when necessary (step 663). The master 2 extracts information regarding the requested process A by referring to and searching the process allocation table 32, and transmits to the terminal 5-1 a processing status (e.g., “allocated processes A1 to A4 completed, and allocated process A5 currently executed”) (step 664).

Through the above-described steps, the master 2 responds to inquires from the slaves 7 and terminal units 5. That is, when one of the slaves 7 inquires the master 2 about an execution result, calculation result, data, etc. (necessary information) in other slaves 7, the master 2 returns the execution result, calculation result, data, etc. (necessary information) corresponding to the inquiry, with reference to the process allocation table 31. When one of the terminal units 5 inquires the master 2 about the processing status or the like of a requested process, the master 2 returns to the terminal unit the processing status or the like of the requested process corresponding to the inquiry, with reference to the process allocation table 31.

As described above, since each slave 7 can obtain execution results, calculation results, data, etc. in other slaves 7 via the master 2, each slave 7 can refer to process execution results, etc. in other slaves 7, even when these slaves are not processing terminal units dedicated for parallel processing in the same system, but are processing terminal units which belong to different systems and are participating in the parallel processing.

Moreover, since each terminal unit 5 can obtain the processing status, etc. of a requested process via the master 2, each terminal unit 5 can grasp the progress of a requested process, and stop the process depending on the processing status.

Notably, the master 2 may perform calculation processing, data processing, or the like in accordance with the contents of an inquiry. Specifically, the master 2 may be modified in such a manner that in response to an inquiry from an terminal unit 5 or slave 7, instead of directly returning information or the like held in the process allocation table 32 of the master 2, the master 2 performs on the information a predetermined calculation processing, data processing, or the like in accordance with the contents of the inquiry, and returns the result thereof.

For example, when an terminal unit 5 or slave 7 inquires of the master 2 about the average, sum, maximum value, etc. of execution results a1 to a4, the master 2 calculates the average, sum, maximum value, etc. of execution results a1 to a4, and returns thus calculated average and sum to the terminal unit 5 or slave 7.

Since communications in relation to inquiries and inquiry responses among the master 2, the slaves 7, and the terminal units 5 can be performed by means of broadcast communication, the inquiry response function 20 of the maser 2 may be provided outside the master 2 or in the distributed masters 3-1, 3-2, etc. in the distributed manner.

In the parallel processing systems of the above-described embodiments, in relation to communications among the master, the slaves, the terminal units, etc., exchange of communication data and information (participation solicitation, participation application, process allocation, transmission of execution results, acquisition of execution results, inquiries, inquiry responses, etc.) is effected by use of broadcast communication.

Although preferred embodiments of the parallel processing system, etc. of the present invention have been described with reference to the accompanying drawings, the present invention is not limited to the embodiments. Various modifications and corrections will be evident to those skilled in the art without departing from the technical idea disclosed herein, and these modifications and corrections should be construed to fall in the scope of the present invention.

### INDUSTRIAL APPLICABILITY

As described above, the parallel processing system of the present invention can be applied to computer systems and the like in which a huge amount of data are processed by use of a plurality of processing terminal units in a distributed manner.

1. A parallel processing system which comprises a plurality of processing terminal units, a plurality of requester-side terminal units, and at least one server, all of which are connected together via a network and in which a process requested by a requester-side terminal unit is performed through parallel processing, the system being characterized in that
the server comprises:
process accepting means for receiving the requested process from the requester-side terminal unit,
participation soliciting means for soliciting the processing terminal units to participate in the parallel processing,
process allocation means for generating to-be-allocated processes from the requested process, optionally through dividing the requested process, and for allocating and transmitting the to-be-allocated processes to processing terminal units having applied for participation in response to the solicitation, and
requested-process-execution-result transmission means for aggregating results of execution of the allocated processes transmitted from the processing terminal units to obtain an execution result of the requested process and for transmitting the execution result of the requested process to the requester-side terminal unit; and
each processing terminal unit comprises:
participation application means, operable when the solicitation for participation in the parallel processing is transmitted from the sever, for responding to apply for the participation when, on the basis of its own operating state, the processing terminal unit is judged able to participate in the parallel processing,
allocated-process executing means for executing the corresponding allocated process transmitted from the server, and
allocated-process-execution-result transmission means for transmitting a result of execution of the allocated process to the server.

2. A parallel processing system which comprises a plurality of processing terminal units and at least one server, all of which are connected together via a network and in which a requested process input to the server is performed through parallel processing, the system being characterized in that
the server comprises:
participation soliciting means for soliciting the processing terminal units to participate in the parallel processing,
process allocation means for generating to-be-allocated processes from the requested process, optionally through dividing the requested process, and for allocating and transmitting the to-be-allocated processes to processing terminal units having applied for participation in response to the solicitation, and
requested-process-execution-result aggregation means for aggregating results of execution of the allocated processes transmitted from the processing terminal units to obtain an execution result of the requested process; and
each processing terminal unit comprises:
participation application means, operable when the solicitation for participation in the parallel processing is transmitted from the sever, for responding to apply for the participation when, on the basis of its own operating state, the processing terminal unit is judged able to participate in the parallel processing,
allocated-process executing means for executing the corresponding allocated process transmitted from the server, and
allocated-process-execution-result transmission means for transmitting a result of execution of the allocated process to the server.

3. A parallel processing system according to claim 1 or 2, wherein the participation soliciting means or the participation application means performs the solicitation for participation or the application for participation by means of broadcast communication.

4. A parallel processing system according to any one of claims 1 to 3, wherein the server includes a plurality of sub-servers which form a hierarchical structure, and the plurality of processing terminal units are connected to the sub-servers.

5. A server which is connected to a plurality of processing terminal units and a plurality of requester-side terminal units via a network and which performs a process requested by a requester-side terminal unit through parallel processing, the server being characterized by comprising:
process accepting means for receiving the requested process from the requester-side terminal unit,
participation soliciting means for soliciting the processing terminal units to participate in the parallel processing,
process allocation means for generating to-be-allocated processes from the requested process, optionally through dividing the requested process, and for allocating and transmitting the to-be-allocated processes to processing terminal units having applied for participation in response to the solicitation, and
requested-process-execution-result transmission means for aggregating results of execution of the allocated processes transmitted from the processing terminal units to obtain an execution result of the requested process and for transmitting the execution result of the requested process to the requester-side terminal unit.

6. A server which is connected to a plurality of processing terminal units via a network and which performs an input, requested process parallel processing, the server being characterized by comprising:
participation soliciting means for soliciting the processing terminal units to participate in the parallel processing,
process allocation means for generating to-be-allocated processes from the requested process, optionally through dividing the requested process, and for allocating and transmitting the to-be-allocated processes to processing terminal units having applied for participation in response to the solicitation, and
requested-process-execution-result aggregation means for aggregating results of execution of the allocated processes transmitted from the processing terminal units to obtain an execution result of the requested process.

7. A server according to claim 5 or 6, wherein the participation soliciting means performs the solicitation for participation by means of broadcast communication.

8. A server according to any one of claims 5 to 7, further comprising instruction conversion means for converting instruction codes of the allocated process to instruction codes executable on the processing terminal unit.

9. A server according to any one of claims 5 to 8, wherein the server includes a plurality of sub-servers which form a hierarchical structure, and the plurality of processing terminal units are connected to the sub-servers.

10. A processing terminal unit which is connected to at least one server via a network and which is used in a parallel processing system for performing a requested process input to the server through parallel processing, the processing terminal unit being characterized by comprising:
participation application means, operable when the solicitation for participation in the parallel processing is transmitted from the sever, for responding to apply for the participation when, on the basis of its own operating state, the processing terminal unit is judged able to participate in the parallel processing,
allocated-process executing means for executing the corresponding allocated process transmitted from the server, and
allocated-process-execution-result transmission means for transmitting a result of execution of the allocated process to the server.

11. A processing terminal unit according to claim 10, wherein the participation application means performs the application for participation by means of broadcast communication.

12. A processing terminal unit according to claim 10 or 11, further comprising instruction conversion means for converting instruction codes of the allocated process to instruction codes executable on the processing terminal unit.

13. A processing terminal unit according to claim 10 or 11, further comprising an external memory for storing information and means necessary for the parallel processing.

14. A processing terminal unit according to any one of claims 10 to 13, wherein the processing terminal unit is an information apparatus including a computer, a portable information terminal, a cellular phone, or a digital consumer electronic device.

15. A parallel processing method performed in a parallel processing system which comprises a plurality of processing terminal units, a plurality of requester-side terminal units, and at least one server, all of which are connected together via a network and in which a process requested by a requester-side terminal unit is performed through parallel processing, the method being characterized in that
the server comprises:
a process accepting step of receiving the requested process from the requester-side terminal unit,
a participation soliciting step of soliciting the processing terminal units to participate in the parallel processing,
a process allocation step of generating to-be-allocated processes from the requested process, optionally through dividing the requested process, and allocating and transmitting the to-be-allocated processes to processing terminal units having applied for participation in response to the solicitation, and
a requested-process-execution-result transmission step of aggregating results of execution of the allocated processes transmitted from the processing terminal units to obtain an execution result of the requested process, and transmitting the execution result of the requested process to the requester-side terminal unit; and
each processing terminal unit comprises:
a participation application step of replying to the solicitation from the server in relation to participation in the parallel processing, so as to apply for the participation when, on the basis of its own operating state, the processing terminal unit is judged able to participate in the parallel processing,
an allocated-process executing step of executing the corresponding allocated process transmitted from the server, and
an allocated-process-execution-result transmission step of transmitting a result of execution of the allocated process to the server.

16. A parallel processing method performed in a parallel processing system which comprises a plurality of processing terminal units and at least one server, all of which are connected together via a network and in which a requested process input to the server is performed through parallel processing, the method being characterized in that
the server comprises:
a participation soliciting step of soliciting the processing terminal units to participate in the parallel processing,
a process allocation step of generating to-be-allocated processes from the requested process, optionally through dividing the requested process, and allocating and transmitting the to-be-allocated processes to processing terminal units having applied for participation in response to the solicitation, and
a requested-process-execution-result aggregation step of aggregating results of execution of the allocated processes transmitted from the processing terminal units to obtain an execution result of the requested process; and
each processing terminal unit comprises:
a participation application step of replying to the solicitation from the server in relation to participation in the parallel processing, so as to apply for the participation when, on the basis of its own operating state, the processing terminal unit is judged able to participate in the parallel processing,
an allocated-process executing step of executing the corresponding allocated process transmitted from the server, and
an allocated-process-execution-result transmission step of transmitting a result of execution of the allocated process to the server.

17. A parallel processing method according to claim 15 or 16, wherein the participation soliciting step or the participation application step performs the solicitation for participation or the application for participation by means of broadcast communication.

18. A parallel processing system according to any one of claims 1 to 4, wherein communication processes via the network are performed by use of broadcast communication.

19. A server according to any one of claims 5 to 9, wherein communication processes via the network are performed by use of broadcast communication.

20. A processing terminal unit according to any one of claims 10 to 14, wherein communication processes via the network are performed by use of broadcast communication.

21. A parallel processing method according to any one of claims 15 to 17, wherein communication processes via the network are performed by use of broadcast communication.

22. A program which causes a computer to function as the server described in any one of claims 5 to 9 and 19.

23. A recording medium on which is recorded a program which causes a computer to function as the server described in any one of claims 5 to 9 and 19.

24. A program which causes a computer to function as the processing terminal unit described in any one of claims 10 to 14 and 20.

25. A recording medium on which is recorded a program which causes a computer to function as the processing terminal unit described in any one of claims 10 to 14 and 20.

26. A parallel processing system which comprises a plurality of processing terminal units and at least one server, all of which are connected together via a network and in which a requested process input to the server is performed through parallel processing, the system being characterized in that
the server comprises:
process allocation means for generating to-be-allocated processes from the requested process, optionally through dividing the requested process, for allocating and transmitting the to-be-allocated processes to the processing terminal units, and for causing the processing terminal units to execute the processes, and
re-allocation means, operable when any one of the processing terminal units does not return a result of execution of the corresponding allocated process within a predetermined time limit, for allocating and transmitting the allocated process to a different processing terminal unit, and for causing the different processing terminal unit to execute the process; and
each processing terminal unit comprises:
allocated-process executing means for executing the corresponding allocated process transmitted from the server, and
allocated-process-execution-result transmission means for transmitting a result of execution of the allocated process to the server.

27. A parallel processing system according to claim 26, wherein the server further comprises time limit setting means for setting the time limit according to the processing capacity of each processing terminal unit.

28. A parallel processing system according to claim 27, wherein the server further comprises:
holding means for holding a process history of each processing terminal unit, and
processing capacity calculation means for calculating the processing capacity of each processing terminal unit on the basis of the corresponding process history.

29. A server which is connected to a plurality of processing terminal units via a network and which performs an input requested process through parallel processing, the server being characterized by comprising:
process allocation means for generating to-be-allocated processes from the requested process, optionally through dividing the requested process, for allocating and transmitting the to-be-allocated processes to the processing terminal units, and for causing the processing terminal units to execute the processes, and
re-allocation means, operable when any one of the processing terminal units does not return a result of execution of the corresponding allocated process within a predetermined time limit, for allocating and transmitting the allocated process to a different processing terminal unit, and for causing the different processing terminal unit to execute the process.

30. A program which causes a computer to function as the server described in claim 29.

31. A parallel processing system which comprises a plurality of processing terminal units and at least one server, all of which are connected together via a network and in which a requested process input to the server is performed through parallel processing, the system being characterized in that
the server comprises:
process allocation means for generating to-be-allocated processes from the requested process, optionally through dividing the requested process, for allocating and transmitting the to-be-allocated processes to the processing terminal units, and for causing the processing terminal units to execute the processes, and
grain-size control means for controlling a process grain size on the basis of the processing capacity of each processing terminal unit, the process grain size representing a quantity of process allocated to each processing terminal unit at a time; and
each processing terminal unit comprises:
allocated-process executing means for executing the corresponding allocated process transmitted from the server, and
allocated-process-execution-result transmission means for transmitting a result of execution of the allocated process to the server.

32. A parallel processing system according to claim 31, wherein the server further comprises:
holding means for holding a process history of each processing terminal unit, and
processing capacity calculation means for calculating the processing capacity of each processing terminal unit on the basis of the corresponding process history.

33. A parallel processing system according to claim 31 or 32, wherein the server further comprises first process control means for monitoring communication load of the network, and for forcedly increasing the process grain size when the communication load is higher than a predetermined level.

34. A parallel processing system according to any one of claims 31 to 33, further comprising second process control means for monitoring communication load of the network, and for temporarily stopping the allocation of processes to the processing terminal units when the communication load is higher than a predetermined level, until the communication load decreases to the predetermined level.

35. A server which is connected to a plurality of processing terminal units via a network and which performs an input requested process through parallel processing, the server being characterized by comprising:
process allocation means for generating to-be-allocated processes from the requested process, optionally through dividing the requested process, for allocating and transmitting the to-be-allocated processes to the processing terminal units, and for causing the processing terminal units to execute the processes, and
grain-size control means for controlling a process grain size on the basis of the processing capacity of each processing terminal unit, the process grain size representing a quantity of process allocated to each processing terminal unit at a time.

36. A program which causes a computer to function as the server described in claim 35.

37. A parallel processing system which comprises a plurality of processing terminal units and at least one server, all of which are connected together via a network and in which a requested process input to the server is performed through parallel processing, the system being characterized in that
the server comprises:
process allocation means for generating to-be-allocated processes from the requested process, optionally through dividing the requested process, for allocating and transmitting the to-be-allocated processes to the processing terminal units on the basis of priority orders of the to-be-allocated processes in such a manner that a to-be-allocated process having a higher priority level is preferentially transmitted to a processing terminal unit having an earlier predicted end time regarding the to-be-allocated process, and for causing the processing terminal units to execute the processes; and
each processing terminal unit comprises:
allocated-process executing means for executing the corresponding allocated process transmitted from the server, and
allocated-process-execution-result transmission means for transmitting a result of execution of the allocated process to the server.

38. A parallel processing system according to claim 37, wherein the server further comprises:
process time setting means for setting a process time of the to-be-allocated process on the basis of the processing capacity of each processing terminal unit, and
predicted-end-time calculation means for calculating the predicted end time of the to-be-allocated process from the sum of the process time and the remaining process time of a process currently executed.

39. A parallel processing system according to claim 38, wherein the server further comprises:
holding means for holding a process history of each processing terminal unit, and
processing capacity calculation means for calculating the processing capacity of each processing terminal unit on the basis of the corresponding process history.

40. A parallel processing system according to any one of claims 37 to 39, wherein the server uses broadcast communication to solicit the processing terminal units to participate in parallel processing and to allocate, transmit the to-be-allocated processes to the processing terminal units having applied for participation in response to the solicitation, and cause the processing terminal units to execute the processes.

41. A parallel processing system according to claim 37, wherein the priority order is one of a plurality of levels of priority, and is set for each allocated process.

42. A server which is connected to a plurality of processing terminal units via a network and which performs an input requested process through parallel processing, the server being characterized by comprising:
process allocation means for generating to-be-allocated processes from the requested process, optionally through dividing the requested process, for allocating and transmitting the to-be-allocated processes to the processing terminal units on the basis of priority orders of the to-be-allocated processes in such a manner that a to-be-allocated process having a higher priority level is preferentially transmitted to a processing terminal unit having an earlier predicted end time regarding the to-be-allocated process, and for causing the processing terminal units to execute the processes.

43. A program which causes a computer to function as the server described in claim 42.

44. A parallel processing system which comprises a plurality of processing terminal units and at least one server, all of which are connected together via a network and in which a requested process input to the server is performed through parallel processing, the system being characterized in that
the server comprises:
participation soliciting means for soliciting the processing terminal units to participate in the parallel processing, and
process allocation means for generating to-be-allocated processes from the requested process, optionally through dividing the requested process, for allocating and transmitting the to-be-allocated processes to processing terminal units having applied for participation in response to the solicitation, and for causing the processing terminal units to execute the allocated processes; and
each processing terminal unit comprises:
determination means for monitoring its own load and for determining on the basis of the load whether the processing terminal unit can participate in the parallel processing,
allocated-process execution means for executing the allocated process transmitted from the server and for transmitting a result of execution of the allocated process to the server,
participation application means for replying the participation solicitation transmitted from the server in order to participate in the parallel processing when the processing terminal unit can participate the parallel processing.

45. A parallel processing system according to claim 44, wherein the load is a CPU load ratio, and the determination means determines that the processing terminal unit can participate the parallel processing when the CPU load ratio is not greater than a predetermined level.

46. A processing terminal unit connected to at least one server via a network and used in a parallel processing system which performs a requested process input to the server through parallel processing, the processing terminal unit being characterized by comprising:
determination means for monitoring its own load and for determining on the basis of the load whether the processing terminal unit can participate in the parallel processing, and
allocated-process execution means for executing the allocated process transmitted from the server and for transmitting a result of execution of the allocated process to the server.

47. A program which causes a computer to function as the processing terminal unit described in claim 46.

48. A parallel processing system which comprises a plurality of processing terminal units and at least one server, all of which are connected together via a network and in which a requested process input to the server is performed through parallel processing, the system being characterized in that
the server comprises:
process allocation means for generating to-be-allocated processes from the requested process, optionally through dividing the requested process, for allocating and transmitting the to-be-allocated processes to processing terminal units having applied for participation in response to the solicitation, and for causing the processing terminal units to execute the allocated processes; and
each processing terminal unit comprises:
allocated-process execution means for executing the allocated process transmitted from the server,
shared data transmission means for transmitting updated shared data to other processing terminal units by means of broadcast communication,
shared data reception means for updating the shared data received from the other processing terminal units by means of broadcast communication, and
allocated-process-execution-result transmission means for transmitting a result of execution of the allocated process to the server.

49. A processing terminal unit connected to at least one server via a network and used in a parallel processing system which performs a requested process input to the server through parallel processing, the processing terminal unit being characterized by comprising:
allocated-process execution means for executing the allocated process transmitted from the server,
shared data transmission means for transmitting updated shared data to other processing terminal units by means of broadcast communication,
shared data reception means for updating the shared data received from the other processing terminal units by means of broadcast communication, and
allocated-process-execution-result transmission means for transmitting a result of execution of the allocated process to the server.

50. A program which causes a computer to function as the processing terminal unit described in claim 49.

51. A parallel processing system which comprises a plurality of processing terminal units and at least one server, all of which are connected together via a network and in which a requested process input to the server is performed through parallel processing, the system being characterized in that
the server comprises:
process allocation means for generating to-be-allocated processes from the requested process, optionally through dividing the requested process, for allocating and transmitting the to-be-allocated processes to processing terminal units having applied for participation in response to the solicitation, and for causing the processing terminal units to execute the allocated processes,
holding means for holding a process table which stores the correspondence between the requested process and the allocated process and information regarding the requested process and the allocated process, and
inquiry response means, operable when the server receives an inquiry from a processing terminal unit regarding the allocated processes in other processing terminal units, for replying the inquiry with reference to the process table; and
each processing terminal unit comprises:
allocated-process execution means for executing the allocated process transmitted from the server and for transmitting a result of execution of the allocated process to the server, and
inquiry means for transmitting to the server an inquiry about the allocated processes in other processing terminal units.

52. A parallel processing system according to claim 51, wherein upon receipt of an inquiry regarding the allocated processes from one or a plurality of terminal units which transmit the requested process to the server via the network, the inquiry response means replies the inquiry with reference to the process table

53. A parallel processing system according to claim 41 or 52, wherein the inquiry response means extracts from the process table information corresponding to the inquiry, and returns the information.

54. A parallel processing system according to claim 53, wherein the inquiry response means performs on the extracted information a calculation process corresponding to the inquiry, and returns a result of the calculation process.

55. A parallel processing system according to claim 54, wherein the information corresponding to the inquiry is the processing status or the result of execution of the requested process or the allocated process.

56. A server which is connected to a plurality of processing terminal units via a network and which performs an input requested process through parallel processing, the server being characterized by comprising:
process allocation means for generating to-be-allocated processes from the requested process, optionally through dividing the requested process, for allocating and transmitting the to-be-allocated processes to processing terminal units having applied for participation in response to the solicitation, and for causing the processing terminal units to execute the allocated processes,
holding means for holding a process table which stores the correspondence between the requested process and the allocated process and information regarding the requested process and the allocated process, and
inquiry response means, operable when the server receives an inquiry from a processing terminal unit regarding the allocated processes in other processing terminal units, for replying the inquiry with reference to the process table.

57. A processing terminal unit connected to at least one server via a network, the server performing a requested process input to the server through parallel processing, the processing terminal unit being characterized by comprising:
allocated-process execution means for executing the allocated process transmitted from the server and for transmitting a result of execution of the allocated process to the server, and
inquiry means for inquiring the server about the allocated processes in other processing terminal units.

58. A program which causes a computer to function as the server described in claim 56.

59. A program which causes a computer to function as the processing terminal unit described in claim 57.
